(19) United States
(12) Patent Application Publication
(10) Pub. No.: US 2010/0050230 A1
(43) Pub. Date: Feb. 25, 2010

(54) Method of inspecting spreadsheet files managed within a spreadsheet risk reconnaissance network

(76) Inventors: Russell Aebig, Ladera Ranch, CA (US); Jolyan Oldershaw, Regina (CA)

Correspondence Address: Thomas J. Perkowski, Esq., PC;Soundview Plaza, 1266 East Main Street, Stamford, CT, 06902, US

(21) Appl. No.: 12/229,308

(22) Filed: Aug. 21, 2008

(51) Int. Cl. G06F 21/00

(52) U.S. Cl. 726/1

(57) ABSTRACT

A method of inspecting spreadsheet files managed within a spreadsheet risk reconnaissance network. The method involves a spreadsheet inspector logging-on to the network, and selecting a spreadsheet inspection from the list of spreadsheet inspections to be performed. In response to the selection, the network automatically generates an inspection worksheet for each policy component which is to be manually inspected by the inspector. The inspection worksheet includes all policy compliance components which require human judgment to assess the degree to which an item passes compliance, as well as general notes to allow for inspection items which are not related to the specific compliance items. Upon receiving the network-generated inspection worksheet, the spreadsheet inspector opening the spreadsheet file to be inspected, via a provided hyperlink, and applying human judgment in assessing whether or not the spreadsheet file successfully passes each set of criteria established in the spreadsheet policy. For each policy component being assessed, the spreadsheet inspector evaluating the spreadsheet file and providing a passing grade if the spreadsheet file meets the criteria established in the policy component, and a failing grade if the spreadsheet file does not meet the established criteria in the policy component. An overall assessment score of passing or failing is provided to each spreadsheet file under assessment, based on automated and/or manual assessments.

### BACKGROUND OF THE INVENTION

1. Field of Invention

The present invention relates generally to systems and methods of managing the risk of spreadsheet documents within organizations.

2. Brief Description of the State of Knowledge in the Art

### Enterprise Risk Management

In response to a need for definitive guidance on enterprise risk management, The Committee of Sponsoring Organizations of the Treadway Commission (COSO) initiated a project to develop a conceptually sound framework providing integrated principles, common terminology and practical implementation guidance supporting entities' programs to develop or benchmark their enterprise risk management processes. COSO has been accepted as the standard means of assessing and mitigating risk across the United States. It is also used as the benchmark in assessing compliance with regulatory acts such as Sarbanes-Oxley Act of 2002. The risks inherent in spreadsheet usage are applicable to each and every dimension of the standard COSO framework. Any acceptable spreadsheet risk management solution must address each of these layers of risk, across each of the dimensions.

### Risks Introduced by Spreadsheets

Organizations around the world have come to rely on spreadsheets as an indispensable tool to conduct business, make critical decisions, and drive their internal and external financial statements. Spreadsheets have become indispensable for numerous reasons, some of which have been outlined below. As also indicated, the very reason for being indispensable has negative side effects as well, as will be shown.
Spreadsheets are self-contained software systems where data, and business logic which acts upon this data (or data in other spreadsheets), are packaged in a single file. Over the last several years the ease of use, increased power, and ability to integrate spreadsheets into business processes has provided organizations the ability to develop very sophisticated models, financial statements, and situational analysis. Unfortunately, this power is not controlled as very few people who develop these sophisticated spreadsheets have been trained in doing so.
Spreadsheets are very flexible. It is possible to change the logic within a spreadsheet at will to meet a need and thereby change the resulting outcomes. Unfortunately, this is typically done without restriction or control of any sort.
Spreadsheets are easy to use and easy to program. This combination often leads to spreadsheets being programmed (and re-programmed) quite quickly. Frequently this ease of use provides a false sense of competence and spreadsheets are frequently programmed in a manner beyond the author's skills with predictably error prone results.
Spreadsheets are highly accessible. With virtually all personal computers, i.e. laptop, notebook, desktop computers, today having Microsoft Excel available to them any spreadsheet file which can be accessed on a file system is programmable and executable by people with access. This allows changes to be made by people in an uncontrolled and potentially unauthorized manner.
Spreadsheets are highly portable. As self-contained application software and data, they can easily be moved across directories or file systems, emailed or copied on portable media or otherwise shared amongst colleagues. This has a side effect of moving the spreadsheets from a secured environment to a potentially unsecured environment.

Given the above, it is not surprising that numerous studies have shown that over 90% of spreadsheets in regular use have at least one error. Dr. Panko at the University of Hawaii has developed a field of study on this problem (Spreadsheet Research (SSR) Website: http://panko.cba.hawaii.edu/ssr/).

In response to the recognized concern, many organizations have developed policy covering how spreadsheets are used, the type of data which can and cannot be entered (regulatory constraints), and, occasionally, the technical means of using spreadsheets (passwords, audit trails, etc.).

### Example Product Addressing Spreadsheet Risk

In recent times, enterprise-level spreadsheet risk and compliance management systems have been have been developed in efforts to address the above problems.

In particular, the XLRisk™ system by Cimcon Software, Inc. seeks to provide Sarbanes-Oxley compliance and control of an organization's spreadsheets and other end user computing (EUC) files. The XLRisk system, consisting of XL RISK Manager and XL RISK Agent, identifies all spreadsheets across the company and assigns a risk scorecard based on spreadsheet analysis and pre-Configured criteria, so that a uniform spreadsheet compliance framework can be used for remediation and controls. The system performs an automated inventory of all spreadsheets or other End User Computing (EUC) files in the company; analyzes spreadsheets based on number of formulas, external links, errors, warnings and similar criteria; determines the status of each spreadsheet (compliant or non-compliant, checked-in or out, or file status); performs an initial risk assessment of these spreadsheets by assigning a risk profile to each spreadsheet; generates documentation on the results of each scan; create reports and dashboards with risk profiles for all spreadsheets; identifies the most critical spreadsheets; and monitors spreadsheet compliance status using regularly scheduled scans.

### Inadequacies in Fundamental Premise of Risk Calculation

However, such prior art systems employ traditional risk management models that attempt to quantify, or score, the amount of risk carried by an event in a spreadsheet by multiplying the probability of an event happening with the consequences of that event. While this calculation yields a numeric value, it suffers from several problems.

In order to perform the risk calculation defined above, a value must be provided for both the probability of a risk event happening and the quantified consequences of the event. Both of these items are guesses. Providing an accurate quantified value for probability is difficult if not impossible. As a result, the default is to assign a high/medium/low value (or scale from 1 to n) and then assign a numeric value to the proxies. This is hardly precise, but does yield a value which can be used in calculations. Quantifying consequences is similarly difficult to measure, as it is difficult to first identify all consequences and secondly to assign numeric values to these consequences. Ambitious people will attempt to assess a value for these consequences, however imprecise. As with the probability value, a common mechanism is to default to the high/medium/low or subjective measures on a scale. This will translate to a value which can be used in calculations.

While both probability and quantified consequences are imprecise and somewhat subjective, the calculated risk value will have error built in. By multiplying these two numbers to obtain a risk value the error is multiplied. Depending on how the source values are derived, the degree of error may innocently climb to unacceptable levels. It is far too easy in situations such as these to end up with misleading results which would lead to misguided decisions.

There is also an implication that the values presented have been precisely measured. In the case of using proxies such as high/medium/low, or scale values, this is less the case as the resulting value is clearly not measured, but not so clearly recognized as a subjective value. In the case of assigned probability values and quantified consequences, the resulting calculated value clearly has the implication of a measurement when no such assumption should be made, due to the amount of error in place with this number.

Thus, there is still a great need in the art for new and improved ways of and means for monitoring spreadsheet documents within an organization, and detecting conditions that should present concern to risk officers and managers within the organization, and warrant inspection and further analysis, while avoiding the shortcomings and drawbacks of such prior art systems and methodologies.

### OBJECTS AND SUMMARY OF THE PRESENT INVENTION

Accordingly, a primary object of the present invention is to provide a spreadsheet risk reconnaissance network and methodology that is free of the shortcomings and drawbacks of prior art systems and methodologies.

Another object of the present invention is to provide a spreadsheet risk reconnaissance network capable of identifying, measuring, monitoring and managing risks found in electronic spreadsheet documents within an organization.

Another object of the present invention is to provide a spreadsheet risk reconnaissance network capable of grouping and presenting risks previously unidentifiable or in unusable form using existing methods.

Another object of the present invention is to provide a spreadsheet risk reconnaissance network capable of benchmarking spreadsheet risk across organizations to assist in the actions surrounding the management of such risks.

Another object of the present invention is to provide a spreadsheet risk reconnaissance network which collects and provides multiple levels of information related to spreadsheet risk—the risk inherent in the programming logic of the spreadsheet, the business attributes associated with each operational spreadsheet, and risk management in terms of inspections of key spreadsheets.

Another object of the present invention is to provide a spreadsheet risk reconnaissance (i.e. exploratory surveying) network comprising a plurality of spreadsheet file servers for a plurality of user organizations communicating with a central risk reconnaissance data center, capable of automatically detecting risk conditions in spreadsheet documents within an organization using principles of objective-relative risk analysis.

Another object of the present invention is to provide a spreadsheet risk reconnaissance network which provides an improved method of managing the risk inherent in spreadsheet usage, not only at each dimension defined in the standard COSO cube.

Another object of the present invention is to provide a spreadsheet risk reconnaissance network that addresses each of the strategic, operational, reporting, and compliance aspects an organization.

Another object of the present invention is to provide a spreadsheet risk reconnaissance network that scales seamlessly from the Entity-level to the Division, Business Unit, and Subsidiary levels of an organization.

Another object of the present invention is to provide a spreadsheet risk reconnaissance network that allows the organization to identify and select the spreadsheet related risk events for which they would like to establish policy.

Another object of the present invention is to provide a spreadsheet risk reconnaissance network capable of translating spreadsheet policy into business rules.

Another object of the present invention is to provide a spreadsheet risk reconnaissance network allowing a spreadsheet policy to be created from a comprehensive list of policy components.

Another object of the present invention is to provide a spreadsheet risk reconnaissance network capable of assessing compliance of individual spreadsheets to the organizations spreadsheet policy in an automated manner.

Another object of the present invention is to provide a spreadsheet risk reconnaissance network, wherein the results of manually conducted spreadsheet inspections are integrated with the results of automatically conducted spreadsheet compliance assessments.

Another object of the present invention is to provide such a spreadsheet risk reconnaissance network, wherein created policies are recorded in perpetuity for review by auditors, internally and externally.

Another object of the present invention is to provide a spreadsheet risk reconnaissance network that provides on-going monitoring, evaluation, and early warning as to events that have a high potential for error.

Another object of the present invention is to provide a spreadsheet risk reconnaissance network capable of continuously monitoring file systems for programmatic logic changes in spreadsheets.

Another object of the present invention is to provide a spreadsheet risk reconnaissance network capable of tracking metadata changes within each spreadsheet under management within the network.

Another object of the present invention is to provide such a spreadsheet risk reconnaissance network, wherein the research agent can distinguish between value changes and programmatic logic changes in the cells of spreadsheet documents.

Another object of the present invention is to provide a spreadsheet risk reconnaissance network capable of uniquely identifying the set of logic programmed into an individual spreadsheet document.

Another object of the present invention is to provide a spreadsheet risk reconnaissance network capable of tracking individual spreadsheets, spreadsheets derived from these spreadsheets, and copies these spreadsheets, across file systems, email transmission, and any other means of transferring spreadsheets.

Another object of the present invention is to provide such spreadsheet risk reconnaissance network capable of tracking future versions of a spreadsheet including file name changes of an initially created spreadsheet.

Another object of the present invention is to provide a spreadsheet risk reconnaissance network that objectively provides an assessment of the inherent risk of each spreadsheet file containing an error, and presents this assessment for each individual spreadsheet file as well as for the collective assembly of spreadsheets under management within the network.

Another object of the present invention is to provide a spreadsheet risk reconnaissance network that provides a portfolio view of the risk inherent in the spreadsheets across an organization.

Another object of the present invention is to provide a spreadsheet risk reconnaissance network, wherein business functionality attributes, provided by spreadsheet owners, are integrated with attributes derived in an automated fashion.

Another object of the present invention is to provide such a spreadsheet risk reconnaissance network, wherein different “risk patterns” for each type of spreadsheet can be defined.

Another object of the present invention is to provide a spreadsheet risk reconnaissance network capable of forecasting spreadsheet usage based on programmatic logic characteristics within the spreadsheet cells.

Another object of the present invention is to provide a spreadsheet risk reconnaissance network employing novel algorithms that quantify risk based on spreadsheet logic and spreadsheet type.

Another object of the present invention is to provide a spreadsheet risk reconnaissance network, wherein logical groupings (e.g. departments within a company) are defined, and individual spreadsheets are assigned or attributed to these groups.

Another object of the present invention is to provide a spreadsheet risk reconnaissance network capable of aggregating risk related information into logical groupings, and reports on detailed areas of risk/weakness are provided within each logical grouping.

Another object of the present invention is to provide a spreadsheet risk reconnaissance network, wherein comprehensive risk analysis of spreadsheet usage is performed by logical grouping, via reports and visual depictions.

Another object of the present invention is to provide such a spreadsheet risk reconnaissance network, wherein risk officers, who have been assigned to particular documents within the organization, have access to operational GUIs and reports, and can manually classify analyzed spreadsheets.

Another object of the present invention is to provide a spreadsheet risk reconnaissance network capable of processing historic metadata to provide trend analysis.

Another object of the present invention is to provide a spreadsheet risk reconnaissance network, wherein spreadsheet risk monitoring reports and analytics are made accessible in either an Application Software Provider (ASP) Configuration as well as a client server Configuration.

Another object of the present invention is to provide such a spreadsheet risk reconnaissance network, wherein the central risk reconnaissance data center analyzes the metadata associated with each spreadsheet document to automatically (i) identify Spreadsheet Purpose (i.e. Type) from the collected metadata, and (ii) calculate the Relative Likelihood of Error (RLE) and the Relative Likelihood of Concern (RLC) associated with each and every particular spreadsheet document file under management by the system.

Another object of the present invention is to provide such a spreadsheet risk reconnaissance network, wherein software-based research agents (i.e. software programs) are installed on each file server in the network and operate transparent to users on the network to (i) continuously monitor file systems for programmatic logic changes in spreadsheet documents, (ii) automatically collect metadata from spreadsheets and (iii) transmit this metadata (in the form of an XML format) to the central risk reconnaissance data center for storage and analysis.

Another object of the present invention is to provide a spreadsheet risk reconnaissance network, wherein a database management system is used to store spreadsheet metadata.

Another object of the present invention is to provide a spreadsheet risk reconnaissance network that can be easily integrated with document management systems.

Another object of the present invention is to provide a spreadsheet risk reconnaissance network spreadsheet risk reconnaissance network for automatically detecting risk conditions in spreadsheet documents within an organization using principles of objective-relative risk analysis.

Another object of the present invention is to provide a spreadsheet risk reconnaissance network method of classifying spreadsheet files managed within a spreadsheet risk reconnaissance network.

Another object of the present invention is to provide a method of inspecting spreadsheet files managed within a spreadsheet risk reconnaissance network.

Another object of the present invention is to provide a spreadsheet risk reconnaissance network for automatically detecting risk conditions in spreadsheet files within an organization.

Another object of the present invention is to provide a method of computing spreadsheet risk within a spreadsheet risk reconnaissance network employing a research agent installed on one or more spreadsheet file servers

Another object of the present invention is to provide a method of implementing an organization's policy on spreadsheet documents monitored using a spreadsheet risk reconnaissance network.

Another object of the present invention is to provide a method of generating metadata from spreadsheet files stored on one or more spreadsheet servers registered within a spreadsheet risk reconnaissance network.

Another object of the present invention is to provide a method of determining whether changes have occurred in the programmatic business logic of a spreadsheet file stored on a spreadsheet server.

Another object of the present invention is to provide a method of continuously monitoring potential risk conditions within a spreadsheet file stored on a spreadsheet server registered within a spreadsheet risk reconnaissance network.

These and other objects of the present invention will become apparent hereinafter and in the Claims to Invention.

### BRIEF DESCRIPTION OF THE DRAWINGS

In order to more fully understand the Objects of the Present Invention, the following Detailed Description of the Illustrative Embodiments should be read in conjunction with the accompanying figure Drawings in which:

FIG. 1 is a schematic representation of the topology of the spreadsheet risk reconnaissance network of the present invention, showing the spreadsheet file servers of a plurality of user organizations communicating with a central risk reconnaissance data center, wherein software-based research agents (i.e. software programs) according to the present invention are installed on one or more file servers in the network and operate transparent to users on the network to (i) automatically collect metadata from spreadsheets and (ii) transmit this metadata to the central risk reconnaissance data center for storage and analysis, and wherein the central risk reconnaissance data center analyzes the metadata associated with each spreadsheet document to automatically (i) identify spreadsheet purpose (type) from the collected metadata, and (ii) calculate the relative likelihood of error (RLE) and the relative likelihood of concern (RLC) associated with each and every particular spreadsheet document file under management by the system, and wherein risk officers, who have been assigned to particular document within the organization, and have access to operational GUIs and reports, can (i) manually classify analyzed spreadsheet documents, (ii) add additional attributes of value thereto and (iii) notify risk inspectors, with expertise in the logic and structure of assigned spreadsheet documents, to access and inspect the same for further investigation of potential problems that may be embodied within a particular spreadsheet document, or set of documents;

FIG. 2 is a schematic representation of the network architecture of the spreadsheet risk reconnaissance network of the present invention, showing the access to spreadsheet risk management information by user from a plurality of organizations, as well as the deployment of the software-based research agent of the present invention running on spreadsheet file servers in a plurality of user organizations and communicating with the central risk reconnaissance data center of the network, supporting communication (e.g. internet based protocols), application and database servers operably connected to the infrastructure of the Internet;

FIG. 3A is a graphical representation of an exemplary graphical user interface (GUI) screen displayed from the communication servers of the spreadsheet risk reconnaissance network of the present invention, when a system user accesses services from the Administration Service Suite supporting the administration of Organization details to identify the file servers which are being monitored research agents;

FIG. 3B is a graphical representation of an exemplary GUI screen displayed from the communication servers of the spreadsheet risk reconnaissance network of the present invention, when a system user accesses services from the Administration Service Suite to manage User Accounts;

FIG. 3C is a graphical representation of an exemplary GUI screen displayed from the communication servers of the spreadsheet risk reconnaissance network of the present invention, when a system user accesses services from the Administration Service Suite to modify User Accounts;

FIG. 3D is a graphical representation of an exemplary GUI screen displayed from the communication servers of the spreadsheet risk reconnaissance network of the present invention, when a system user accesses services from the Administration Service Suite to administer deployed Research Agents;

FIG. 4A shows graphical representations of exemplary GUI screens displayed from the communication servers of the spreadsheet risk reconnaissance network of the present invention, when a system user accesses services from Configure Departments to Configure Departments with the Organization;

FIG. 4B shows graphical representations of exemplary GUI screens displayed from the communication servers of the spreadsheet risk reconnaissance network of the present invention, when a system user accesses services from Configure Folders to Configure Folders which contain active spreadsheets in use by a Department of the Organization;

FIG. 4C shows graphical representations of exemplary GUI screens displayed from the communication servers of the spreadsheet risk reconnaissance network of the present invention, when a system user accesses services from Configure Policy to create or review a created Policy within the Organization;

FIG. 4D shows graphical representations of exemplary GUI screens displayed from the communication servers of the spreadsheet risk reconnaissance network of the present invention, when a system user accesses services from Configure Policy to generate a PDF version of a selected Policy within the Organization;

FIG. 4E shows graphical representations of exemplary GUI screens displayed from the communication servers of the spreadsheet risk reconnaissance network of the present invention, when a system user accesses services to create a Policy within the Organization;

FIG. 5A shows graphical representations of exemplary GUI screens displayed from the communication servers of the spreadsheet risk reconnaissance network of the present invention, when a system user accesses services from the Classify Attributes Suite to select a Spreadsheet to classify attributes thereof, within the Organization;

FIG. 5B shows graphical representations of exemplary GUI screens displayed from the communication servers of the spreadsheet risk reconnaissance network of the present invention, when a system user accesses services from the Classify Attributes to review a Spreadsheet, within the Organization;

FIG. 5C shows graphical representations of exemplary GUI screens displayed from the communication servers of the spreadsheet risk reconnaissance network of the present invention, when a system user accesses services from the Classify Spreadsheet to review the Metadata Dashboard for a particular Spreadsheet file;

FIG. 5D shows graphical representations of exemplary GUI screens displayed from the communication servers of the spreadsheet risk reconnaissance network of the present invention, when a system user accesses services from the Classify Spreadsheet Suite to review the Workbook Metadata for a particular Spreadsheet document within the Organization;

FIG. 5E shows graphical representations of exemplary GUI screens displayed from the communication servers of the spreadsheet risk reconnaissance network of the present invention, when a system user accesses services from the Classify Spreadsheet Suite to review the Formula Analysis for a particular Spreadsheet file within the Organization;

FIG. 6A is a graphical representation of an exemplary GUI screen displayed from the communication servers of the spreadsheet risk reconnaissance network of the present invention, when a system user accesses services from the Inspect Service Suite to select and assign a Spreadsheet file within the Organization, for inspection;

FIG. 6B is a graphical representation of an exemplary GUI screen displayed from the communication servers of the spreadsheet risk reconnaissance network of the present invention, when a system user accesses services from the Inspect Service Suite to access the Policy Component Working Paper with respect to performing an inspection of and compiling inspection notes related to a selected Spreadsheet file;

FIG. 7 is a graphical representation of an exemplary GUI screen displayed from the communication servers of the spreadsheet risk reconnaissance network of the present invention, wherein a system user accesses services from the Access Suite to access and review Reports and Dashboards associated with particular Spreadsheet files maintained within the Organization;

FIG. 8 is a schematic representation of the primary Database Tables provided in the relational database management system (RDBMS) supporting the enterprise-level services within the spreadsheet risk reconnaissance network of the present invention including, for example, Users, Organization, Department, Policy, Policy Group, Policy Rule, Worksheet Data, Unique Formula, File, File Version, File Server, Research Agent, Directory Configuration and Risk Server;

FIG. 8A is a schematic representation of the primary fields in the Users Table employed in the relational database shown in FIG. 8;

FIG. 8B is a schematic representation of the primary fields in the Organization Table employed in the relational database shown in FIG. 8;

FIG. 8C is a schematic representation of the primary fields in the Department Table employed in the relational database shown in FIG. 8;

FIG. 8D is a schematic representation of the primary fields in the Policy Table employed in the relational database shown in FIG. 8;

FIG. 8E is a schematic representation of the primary fields in the Policy Group Table employed in the relational database shown in FIG. 8;

FIG. 8F is a schematic representation of the primary fields in the Policy Rule Table employed in the relational database shown in FIG. 8;

FIG. 8G is a schematic representation of the primary fields in the Worksheet Data table employed in the relational database shown in FIG. 8;

FIG. 8H is a schematic representation of the primary fields in the Unique Formula table employed in the relational database shown in FIG. 8;

FIG. 8I is a schematic representation of the primary fields in the File Version table employed in the relational database shown in FIG. 8;

FIG. 8J is a schematic representation of the primary fields in the File Server table employed in the relational database shown in FIG. 8;

FIG. 8K is a schematic representation of the primary fields in the Research Agent table employed in the relational database shown in FIG. 8;

FIG. 8L is a schematic representation of the primary fields in the Directory Configuration table employed in the relational database shown in FIG. 8;

FIG. 8M is a schematic representation of the primary fields in the Risk Server table employed in the relational database shown in FIG. 8;

FIG. 8N is a schematic representation of the primary fields in the File Table employed in the relational database shown in FIG. 8;

FIG. 8O is a schematic representation of the primary fields in the File Type Table employed in the relational database shown in FIG. 8;

FIG. 8P is a schematic representation of the primary fields in the File Inspection Table employed in the relational database shown in FIG. 8;

FIG. 9 is an entity-relational diagram (ERD) for the spreadsheet risk reconnaissance network of the present invention, showing relationships between entities (i.e. objects) represented within the RDBMS of FIG. 8;

FIG. 9A is the entity-relational diagram of FIG. 9, highlighting the primary objects (i.e. entities) used to implement the Collect Metadata service transparently supported by the Research Agents deployed on the spreadsheet risk reconnaissance network of the present invention;

FIG. 9B1 is an entity-relational diagram of FIG. 9, highlighting the primary objects (i.e. entities) used to implement the Administer Research Agents service supported on the spreadsheet risk reconnaissance network of the present invention;

FIG. 9B2 is an entity-relational diagram of FIG. 9, highlighting the primary objects (i.e. entities) used to implement the Administer Organization and Users services supported on the spreadsheet risk reconnaissance network of the present invention;

FIG. 9C is an entity-relational diagram of FIG. 9, highlighting the primary objects (i.e. entities) used to implement the Configure Department, Folder and Policy services supported on the spreadsheet risk reconnaissance network of the present invention;

FIG. 9D is an entity-relational diagram of FIG. 9, highlighting the primary objects (i.e. entities) used to implement the Classify (Spreadsheet File) services supported on the spreadsheet risk reconnaissance network of the present invention;

FIG. 9E is an entity-relational diagram of FIG. 9, highlighting the primary objects (i.e. entities) used to implement the Inspect (Spreadsheet File) services supported on the spreadsheet risk reconnaissance network of the present invention;

FIG. 9F is an entity-relational diagram of FIG. 9, highlighting the primary objects (i.e. entities) used when producing Risk-Oriented Reports relating to Spreadsheet Files and Policies supported on the spreadsheet risk reconnaissance network of the present invention;

FIG. 10A is schematic representation illustrating the sequence of various operations within the spreadsheet risk reconnaissance network of the present invention, including Installation, Initial Setup, and Network Operations within the organizations;

FIG. 10B is high-level flow chart describing the primary steps carried out during the Installation and Configuration Phase of operation on the spreadsheet risk reconnaissance network of the present invention, including (i) the installation of deployed Research Agents on file servers registered on the network, and (ii) Configuration of organizational departments, users and permissions, directories used by departments and spreadsheet policies, within the application server at the Central Reconnaissance Data Center of the spreadsheet risk reconnaissance network of the present invention;

FIG. 11 is high-level flow chart describing the Automated Spreadsheet Metadata Collection Process performed by the Research Agents on registered file servers within the network, and automated the spreadsheet identification and Relative Likelihood of Error (RLE) and Relative Likelihood of Concern (RLC) calculations performed by the Risk Calculation and Notification Engine within the Central Reconnaissance Data Center, for spreadsheet documents being monitored within the spreadsheet risk reconnaissance network of the present invention;

FIG. 12 is a flow chart describing the steps performed transparently by each Research Agent deployed on a file server on the spreadsheet risk reconnaissance network of the present invention;

FIG. 12A is a schematic representation describing the file format of an exemplary XML document generated by each Research Agent, and transmitted to the communication and application servers of the Central Reconnaissance Data Center;

FIG. 12B is a schematic representation of a spreadsheet file, and how it is processed in order to detect business logic change on the spreadsheet reconnaissance network of the present invention;

FIG. 12C is a schematic representation of a spreadsheet file, and how it is processed in order to uniquely identify the purpose or role of a spreadsheet on the spreadsheet reconnaissance network of the present invention;

FIGS. 13A1 through 13A4, taken together, show a flow chart describing the primary steps carried out on each Research Agent during the automated spreadsheet metadata collection and transmission process supported by Research Agents deployed on file servers on the spreadsheet risk reconnaissance network of the present invention;

FIGS. 13B1 and 13B2 is a schematic representation of an illustrative function parsing example, wherein the function is IF(1={1,2;3,0;−1,TRUE}, “yes”, “no”) and is parsed into 7 arguments, 10 function pieces, 9 operands, 2 operators and 4 levels.

FIG. 14 shows a high-level flow chart describing the primary steps carried out in the Risk Calculation and Notification Engine within the Central Reconnaissance Data Center, during the automated process for calculating RLE and RLC for spreadsheet documents in file servers on the spreadsheet risk reconnaissance network of the present invention;

FIG. 15 is high-level flow chart describing the primary steps carried out in the Risk Calculation and Notification Engine during the automated identification of Spreadsheet Purpose (Type) for spreadsheet documents being monitored within the spreadsheet risk reconnaissance network of the present invention;

FIGS. 16A through 16E, taken together, show a table describing the types of Spreadsheet Purpose supported by the illustrative embodiment of the spreadsheet risk reconnaissance network of the present invention;

FIG. 17A is a flow chart describing the primary steps carried out when the Risk Calculation and Notification Engine within the Central Reconnaissance Data Center, calculates the Relative Likelihood of Error (RLE) for spreadsheet documents being monitored by Research Agents deployed on file servers within the spreadsheet risk reconnaissance network of the present invention;

FIG. 17B1 is a flow chart describing the primary steps carried out by the Risk Calculation and Notification Engine within the Central Reconnaissance Data Center, when calculating the estimated error acquired in the linkage to another active spreadsheet [Ea], which is one component of the RLE;

FIG. 17B2 is a flow chart describing the primary steps carried out by the Risk Calculation and Notification Engine within the Central Reconnaissance Data Center, when calculating the estimated error inherited from copying from another spreadsheet [Eᵢ], which is one component of the RLE;

FIG. 17C1 is a flow chart describing the primary steps carried out by the Risk Calculation and Notification Engine within the Central Reconnaissance Data Center, when calculating the estimated error introduced during design or development of the spreadsheet [E_{dd}], which is one component of the RLE;

FIG. 17C2 is a flow chart describing the primary steps carried out by the Risk Calculation and Notification Engine within the Central Reconnaissance Data Center, when calculating the estimated error introduced during spreadsheet usage [Eᵤ], which is one component of the RLE;

FIG. 17D is a flow chart describing the primary steps carried out by the Risk Calculation and Notification Engine within the Central Reconnaissance Data Center, when augmenting the RLE with detected logic changes since the last spreadsheet inspection process carried out on the network of the present invention;

FIG. 18 is a high-level flow chart describing the primary steps carried out when the Risk Calculation and Notification Engine within the Central Reconnaissance Data Center, calculates the Relative Likelihood of Concern (RLC) for spreadsheet documents being monitored by Research Agents deployed on file servers within the spreadsheet risk reconnaissance network of the present invention;

FIG. 19 is a high-level flow chart describing the primary steps carried out when a risk officer uses Spreadsheet Classification services supported on the spreadsheet risk reconnaissance network of the present invention;

FIG. 20 is a high-level flow chart describing the primary steps carried out when a spreadsheet inspector uses Spreadsheet Inspection services supported on the spreadsheet risk reconnaissance network of the present invention;

FIG. 21 is a high-level flow chart describing the primary steps carried out when a spreadsheet inspector reviews Spreadsheet Policy using services supported by the spreadsheet risk reconnaissance network of the present invention; and

FIG. 22 is an exemplary table of factors, determined by the Spreadsheet Purpose of a given spreadsheet file, to be applied to the fundamental variables of Number of Formula, Number of Unique Formula, Number of Accessible Formula, and Complexity of Formulas, associated with the spreadsheet file, and used in connection with the E_{dd} and Eᵤ components of the RLE calculation.

### DETAILED DESCRIPTION OF THE ILLUSTRATIVE EMBODIMENTS OF THE PRESENT INVENTION

Referring to the figures in the accompanying Drawings, the various illustrative embodiments of the illumination and imaging apparatus and methodologies of the present invention will be described in greater detail, wherein like elements will be indicated using like reference numerals.

The spreadsheet risk reconnaissance network (i.e. system) of the present invention is an enterprise-level system that automatically inventories spreadsheet files across multiple file serving networks, analyzes such spreadsheet files into different types of spreadsheet categories according to spreadsheet purpose, and calculates unique measures of relative risk assessment, based on objective criteria and principles, which helps risk managers assess the risk profile and status of their organization's spreadsheet environment.

The system of the present invention employs novel algorithms that are transparently used to (i) analyze spreadsheet files into spreadsheet categories, (ii) determine spreadsheet purpose, and (iii) calculate novel measures of relative spreadsheet risk. The system employs specialized apparatus for (i) automatically gathering and processing large amounts of meta-data collected from spreadsheet files residing on file servers registered with the network, and (ii) automatically classifying such spreadsheet files into spreadsheet categories by analyzing the collected metadata.

The system of the present invention implements a governance model and then further extends its data collection operations. Organizations can implement policy rules, which are used by spreadsheet inspectors. The spreadsheet analyzer fine-tunes spreadsheet assessment using this additional information. The assessments grow more accurate as the set of collected data becomes larger.

### Overview on the Spreadsheet Risk Definition Model of the Present Invention

Spreadsheet files and their applications are different than most traditional software applications that do not allow users to modify the logic underlying such documents. Consequently, spreadsheet applications allow the introduction of errors at two different phases of the life cycle of a spreadsheet document, namely: during the design and development of the spreadsheet document, and during the active usage of the spreadsheet document.

In general, the present invention defines spreadsheet-associated risk as the possibility of an adverse event happening with respect to any particular spreadsheet document. According to the Spreadsheet Risk Definition Model of the present invention, there are five (5) kinds of errors which are factored into the determination (i.e. calculation) of spreadsheet risk: (1) Errors introduced in the design and development of the spreadsheet; (2) Errors introduced while the spreadsheet is being used in production; (3) Errors inherited by use of another spreadsheet; (4) Errors acquired in the use of data and logic referenced in another spreadsheet; and (5) Errors introduced through the entering of incorrect data values in a spreadsheet file (i.e. document).

### Factor 1: Errors Introduced in the Design and Development of the Spreadsheet

The possibility of error being introduced in a spreadsheet is driven largely by the total number of formula, the number of unique, and complexity of the formula involved. For example, a spreadsheet which models a business and has hundreds of unique and highly complex formula will carry more chance of error that a spreadsheet which primarily sums long columns of numbers for journal entries.

Factor 2: Errors Introduced while the Spreadsheet is being Used in Production

Due to the ease of use, and ease of modification of spreadsheets, introducing error while the spreadsheet is in production is easy. The likelihood of this error is estimated with the number of accessible (unlocked) formula, the amount of change which has taken place in the spreadsheet, and the complexity of the formula involved in the spreadsheet. Spreadsheets which have undergone logic changes after being tested and placed in production will naturally carry more risk than spreadsheets that have not been placed in production.

Factor 3: Error Inherited by Use of Another Spreadsheet If spreadsheet A is copied to spreadsheet B, then B will inherit the risk scores of spreadsheet A. The lineage of the spreadsheet will provide a baseline risk score associated with spreadsheet A.

### Factor 4: Error Acquired in the Use of Data and Logic Referenced in Another Spreadsheet

Frequently spreadsheets are designed to reach out to other spreadsheets or data sources to use or re-use the data or logic from the other spreadsheet. In this case, each external set of logic that is referenced is an extension of the spreadsheet under review and the risk scores of these spreadsheets must contribute to the risk score of the spreadsheet under review.

### Factor 5: Error Introduced Through Entering Incorrect Data Values

When using a spreadsheet document (i.e. file), it is common for errors to be introduced into the spreadsheet document by way of entering incorrect data values in the spreadsheet file.

### Application of Factors to Spreadsheet Usage and Review

In addition to this compositional makeup of risk associated with any spreadsheet document, the present invention also recognizes that a spreadsheet's purpose, or how it is used within a business process, impacts the likelihood of an error occurring in a spreadsheet, as well as where a spreadsheet is most susceptible to risk. For example, a spreadsheet which is used to model a business will necessarily be designed and used differently than one which is used to receive data from a corporate ERP system, and again different from one used to present graphs and reports. Such considerations are factored into the method and system of the present invention.

In traditional software development, a significant test phase exists by which the programmed business rules are thoroughly tested to identify and remove errors. While no such test phase typically exists in the development of spreadsheet documents/models, a scaled down test or inspection of the spreadsheet to validate the accuracy of the spreadsheet can be done. As will be described in greater detail hereafter, an object of the present invention is to enable the validation of spreadsheet accuracy so as to reduce the likelihood of an error existing within the spreadsheet document.

### Foundational Concepts Underlying the Method of Calculating Spreadsheet Risk According to the Principles of the Present Invention

In accordance with the principles of the present invention, the method and apparatus of the present invention for calculating the likelihood or potential for an error occurring within a spreadsheet document employs the following concepts: Spreadsheet Complexity, Spreadsheet Lineage, Spreadsheet Purpose, and Spreadsheet Impact. These concepts will now be described individually in detail below, and thereafter in conjunction with the network, system and method of the present invention.

### Spreadsheet Complexity

The complexity of a spreadsheet file (i.e. document) is largely an aggregation of the complexity of the logic which has been programmed into each of the cells of the spreadsheet. Each formula can be broken down into the measurable components of (i) Formula Complexity (FC), (ii) Formula Token Count (FTC), and (iii) Formula Depth (FD). These components will be discussed in greater detail below.

Formula Complexity (FC) refers to categories such as commonly used functions such as =SUM, =AVERAGE, =MIN, =MAX, and more structured categories of functions such as Financial, Math & Trig, Statistical, Engineering, Lookup & Reference, Database, Date and Time, Text, and Informational functions. For example, commonly used functions of =SUM, =AVERAGE, =MIN, =MAX would be assigned a low (1) complexity factor due to their simple nature and common usage. Financial, Math and Trig, and Statistical functions may be assigned a complexity factor of medium (3) due to less frequent usage and more complex parameter set. Other categories, e.g. Engineering, Math and Trig, and Database function, would be assigned a complexity factor of high (5) due to their usage and parameter set.

Formula Token Count (FTC) refers to the number of functions, RC notation, logical operators, and numeric values. This count of tokens indicates the length of expressions within a formula.

Formula Depth (FD) refers to number of levels of nesting is present in a formula. These items collectively represent the level of complexity of a formula within a spreadsheet cell.

By collecting the measures of relative functional complexity, formula token counts and formula depth, as defined hereinabove, the present invention teaches a novel way of obtaining a score for spreadsheet complexity by obtaining a weighted average of these measures, and by then multiplying the weighted average by the number of unique formulas. Notably, repeated formulas which are formulated by dragging and dropping to adjacent cells do not contribute to additional complexity within the spreadsheet.

### Spreadsheet Purpose/Role

Spreadsheets play many roles inside of operational processes. For example, spreadsheets are used for applying simple (or complex) calculations on a set of numbers; they can be used to perform data analysis of a large set of data; they can be used to model future events; they can be used for reporting of information; and they can be used as conduits/interfaces between sophisticated computer systems (e.g. ERP, CRM) and financial statements.

In the illustrative embodiment of the present invention, the following illustrative spreadsheet roles have been defined below (with details set forth in Appendix A):

Sₚ₍₁₎ Conduit/Interface spreadsheet. These are spreadsheets generated by or load data into a third party package—typically used as a resulting data dump from a query on a ERP/CRM system or application database.

Sₚ₍₂₎ Basic calculations. These spreadsheets perform common calculations. These are “run of the mill” spreadsheets without complex logic or formulas which are potentially problematic. Examples of this may include tracking lists, or simple totaling of rows and/or columns.

Sₚ₍₃₎ Complex calculations. These are spreadsheets which contain conditional logic (=IF), compound functions (=AND, =OR), lookup functions (=HLOOKUP, =VLOOKUP) or functions which are potentially problematic and prone to error. Examples of this may include budget development/analysis, or amortization schedules.

Sₚ₍₄₎ Data Analysis. These are spreadsheets which intensively analyze data in aggregate to cull out the “big picture” information. Examples of this would include the analysis of expenses across a company broken down by geography, job title, and business unit.

Sₚ₍₅₎ Programmatic Model. These spreadsheets contain programming logic to perform actions beyond what is available in Microsoft Excel functions. This may make use of Visual Basic for Applications (VBA) to perform these functions or call out to external services to perform these services.

Sₚ₍₆₎ Reporting. Spreadsheets which are primarily used to communicate analysis results. This may take the form of a workbook or worksheet and will consist of graphs, charts, and/or reports.

In other illustrative embodiments, however, it is understood that other roles may be involved, within the scope and spirit of the present invention. Notwithstanding, each of these roles, spreadsheets are used in a different manner and therefore will have different opportunities and impacts for errors. For example, spreadsheets which are basically conduits for information transfer between systems will have a very short life span, and minimal business logic employed. The probability for error in this spreadsheet with this role is minimal. A more sophisticated modeling program will typically contain a large number of complicated formula and possibly visual basic (VB) programming. In this case the potential for errors to be introduced at design and development time is high. If the model is used on an on-going basis, the potential for error introduced during usage is likewise high. Between these extremes, each role category will have its own risk related characteristics.

### Spreadsheet Lineage and Inherited Risk

Given that spreadsheets are highly portable, and that people will often build upon the work performed by others, it is logical that as spreadsheets are copied, moved, emailed and otherwise shared among people, the errors contained in those spreadsheets are transferred to the person inheriting the spreadsheet. In view of these observed facts, the method and system of the illustrative embodiment of the present invention employs four different categories of Spreadsheet Lineage (i.e. New File, New Version Of The Same File, A Duplicate Copy Of A Known File, And Derivative Of A Known File).

Sₗ₍₁₎ New files are ones which spreadsheet risk reconnaissance network has not encountered to date.

Sₗ₍₂₎ Duplicate files are ones in the spreadsheet risk reconnaissance network has encountered prior, under a different filename but with the same file contents.

Sₗ₍₃₎ New file versions are ones which spreadsheet risk reconnaissance network has encountered prior, has cell values modified, but retains the same file programmatic logic.

Sₗ₍₄₎ File derivatives are files which spreadsheet risk reconnaissance network has encountered prior, but has had the logic within the spreadsheet modified.

Each time the logic within a spreadsheet is changed, this potential for error increases.

Through the use of the spreadsheet file's USI, the network of the present invention is able to automatically track the origin of the spreadsheet, assuming it is not an original file. This process is performed in the following manner.

During examination a spreadsheet, the USI assigned to the spreadsheet is examined. If the spreadsheet file does not have a USI assigned to it, then it is considered to be a “New File”. If the file does have a USI, but has had a change in its business logic (See section above, Determining Change in Business Logic) it is considered to be a “New File Version.” For example, a spreadsheet-based “capital” model for a New York based company was shared with its London office and then modified. In accordance with the principles of the present invention, the source file from which the spreadsheet is derived will be identified by the USI stored in the spreadsheets header. In this manner, the system can continue to link the spreadsheets back to the original spreadsheets, which have been copied and recopied for new uses.

If the network comes across a spreadsheet which has the same USI with a new filename, then it will consider this a “File Derivative” (e.g., a spreadsheet-based Amortization schedule for September has been updated for October). If the network automatically detects this same condition (i.e. a spreadsheet file with the same USI), but has the same filename in a different folder, then the network consider this to be a “Duplicate File.” For example, a Duplicate File would be a spreadsheet which has been emailed to a friend and stored in a different folder, without modification.

### Spreadsheet Impact

One way of estimating the impact of an error to a spreadsheet is to examine the magnitude of the numbers in the spreadsheet. If all things were equal, this would provide a quantifiable value with which to work. Given that every company is unique, a better way to assess the impact is to look at subjective attributes of Criticality (e.g. critical, key, important, or low impact) and confidentiality (the spreadsheet contains confidential information or it does not).

Sᵢ₍₁₎ Critical spreadsheets are ones in which material error could compromise a public entity and cause a breach of the law and/or individual or collective fiduciary duty. The resulting impact may place those responsible at risk of criminal and/or civil legal proceedings with related disciplinary action.

Sᵢ₍₂₎ Key spreadsheets are ones which could cause significant business impact in terms of incorrectly stated assets, liabilities, costs, revenues, profits, taxation, etc. The impact of errors within these spreadsheets would be adverse public attention and a risk of civil proceedings for negligence or breach of duty and/or disciplinary action.

Sᵢ₍₃₎ Important spreadsheets are ones in which material error could cause significant impact on the individual in terms of job performance or career progression without directly, greatly, immediately, or irreversibly affecting business of the organization.

Sᵢ₍₄₎ Low Impact spreadsheets are ones in which material error would not have any significant impact to the organization or individuals involved.

If a spreadsheet is deemed to be critical, key, or contains confidential information, then errors would potentially have a high impact. While this produces a relative assessment rather than a quantified assessment, it is potentially of greater value as it is specific to a situation.

### Method of Calculating Risk Inherent in a Spreadsheet Document According to Illustrative Embodiment of the Present Invention

In accordance with the principles of the present invention, calculating spreadsheet risk involves three levels of operation:

(1) Identifying Spreadsheet Purpose;

(2) Calculating the “Likelihood Of Spreadsheet Error;” and

(3) Calculating “Spreadsheet Concern.”

In the illustrative embodiment, the latter two of these operations are implemented by calculating “relative risk” scores which are used to differentiate individual spreadsheets across the population of spreadsheets in the organization. Specifically, the Likelihood Of Spreadsheet Error, which represents the likelihood of error within a spreadsheet, is realized by a Relative Likelihood of Error (RLE) Score. In contrast, Spreadsheet Concern, which represents the relative impact of an error would have on the organization, is realized by a Relative Likelihood of Concern (RLC) score. As each of these scores are relative values, the scores are representative of an organizations specific situation and impart meaning (i.e. make sense or having meaning) within the context of the organization's population of spreadsheets.

### Calculating the Relative Likelihood of Error (RLE)

In the illustrative embodiment, calculating the Relative Likelihood of Error, RLE, is performed in four (4) layers.

The Layer 1 (Baseline Calculation) provides a baseline calculation which accounts for the components of where risk may arise in a spreadsheet.

The Layer 2 (Accounting for Spreadsheet Purpose) will account for the Spreadsheet Purpose and refine the RLE based on the areas, where risk will reside within the specific usage of spreadsheets which fit the characteristics of the category of Spreadsheet Purpose.

The Layer 3 (Discounting for Inspection for Errors/Validation of Accuracy) will build upon the first two layers (i.e. Layers 1 and 2) in accounting for spreadsheet inspections and validation of spreadsheet accuracy.

Finally, Layer 4 (Accounting for Logic Changes Post Inspection) will account for the logic changes which have taken place since the inspection occurred.

Each of these layers of RLE calculation will be described in greater detail below.

### Layer 1—Baseline Calculation

The Relative Likelihood of Error score represents the likelihood that the spreadsheet contains an error. This is a relative score and as provides a distinguishing characteristics highlighting for the organization those spreadsheets which are more likely to contain errors. This score is composed of four components corresponding to the four areas where error may be introduced into the spreadsheet document.

Relative Likelihood Error Score RLE=f(E_{dd}, Eᵤ, Eᵢ, Eₐ)

E_{dd}=error introduced during design or development,

Eᵤ=error introduced during usage,

Eᵢ=error inherited from the copying of a spreadsheet

Eₗ=error acquired in the linkage to another spreadsheet

These components are decomposed as follows:

E_{dd}=f(N_{f}, Nᵤ, F_{c})
N_{f}=number of formula in the spreadsheet
Nᵤ=number of unique formula in the spreadsheet
F_{c}=formula complexity measure for spreadsheet

Eᵤ=f(Nₐ, F_{c})
Nₐ=number of accessible formula in the spreadsheet
F_{c}=formula complexity measure for spreadsheet

Eᵢ=RLE from source file (0 if this is a new file)

Eₗ=summed RLE's from all external files referenced in the spreadsheet

F_{c}=Formula complexity=f(Fₙ(Fₜ, Fn_{c}, F_{d}))

Fₙ=unique formula count,

Fₜ=formula token count,

Fn_{c}=function complexity,

F_{d}=formula depth

### Layer 2—Accounting for Spreadsheet Purpose

A second layer to the calculation of the RLE is the Spreadsheet Purpose. Based on the identified category of Spreadsheet Purpose, different elements of the formula will carry greater or lesser risk.

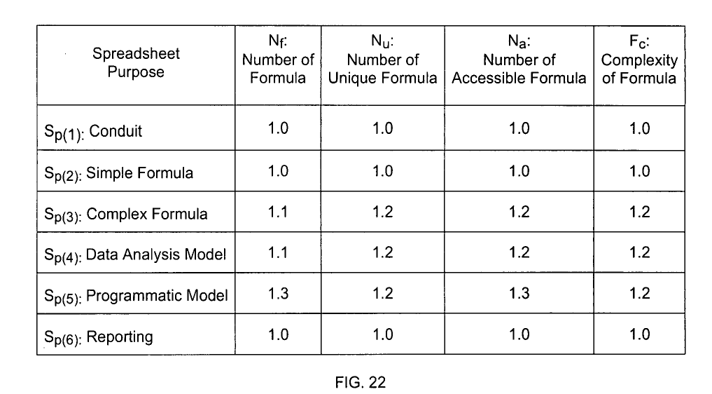

This overlay will apply a factor to the fundamental variables of Number of Formula, Number of Unique Formula, Number of Accessible Formula, and Complexity of Formulas. This factor will be unique for each fundamental variable determined by Spreadsheet Purpose. For example, the factors applied to the E_{dd} and Eᵤ components of the RLE calculation could be driven from a table set forth in FIG. 22.

These components are decomposed as follows:

E_{dd}=f((N_{f}*(Sₚ₍ₓ₎, N_{f})), (Nᵤ*(Sₚ₍ₓ₎, Nᵤ₎), (F_{c}*(Sₚ₍ₓ₎, F_{c})))
N_{f}=number of formula in the spreadsheet
(Sₚ₍ₓ₎, N_{f})=the factor at coordinates Sₚ₍ₓ₎ and N_{f}
Nᵤ=number of unique formula in the spreadsheet
F_{c}=formula complexity measure for spreadsheet

Eᵤ=f((Nₐ*(Sₚ₍ₓ₎, Nₐ₎), (F_{c}*(Sₚ₍ₓ₎, F_{c})))
Nₐ=number of accessible formula in the spreadsheet
(Sₚ₍ₓ₎, Nₐ)=the factor at coordinates Sₚ₍ₓ₎ and Nₐ
F_{c}=formula complexity measure for spreadsheet

### Layer 3—Discounting for Inspection for Errors/Validation of Accuracy

A third layer to the calculation of the RLE is the date of the last successful inspection. Once a successful inspection occurs, the likelihood of an error is greatly reduced. This will not affect the portion of the formula related to linkages to other active spreadsheets. For example, a spreadsheet has been inspected and certified as being free of errors and accurately produces the desired result. This “intervention” will greatly reduce the overall likelihood of an error being in the spreadsheet file, however will not affect the risk of all linked spreadsheets. Similarly if linked spreadsheets are inspected and validated their RLE scores will be reduced and all spreadsheets which link to these sheets will have their scores reduced as well.

Relative Error Likelihood Score=RLE=f(I_{d}, (E_{dd}, Eᵤ, Eᵢ), Eₗ)

I_{d}=Successful Inspection Date

E_{dd}=error introduced during design or development (as modified in Layer 2),

Eᵤ=error introduced during usage (as modified in Layer 2),

Eᵢ=error inherited from the copying of a spreadsheet (as modified in Layer 2),

Eₗ=error acquired in the linkage to another spreadsheet

### Layer 4—Accounting for Logic Changes Post Inspection

A fourth layer to the RLE calculation is to add in the risk of error which may be introduced by changes made to the logic after the successful inspection. As each change is made to the spreadsheet logic, additional risk is introduced. This incremental risk is accounted for with this layer.

RLE=RLE+f(I_{d}, Cₙ, Fₐ)

I_{d}=Date of successful inspection,

Cₙ=Count of reviews which have detected a logic change

Fₐ=Number of accessible formula

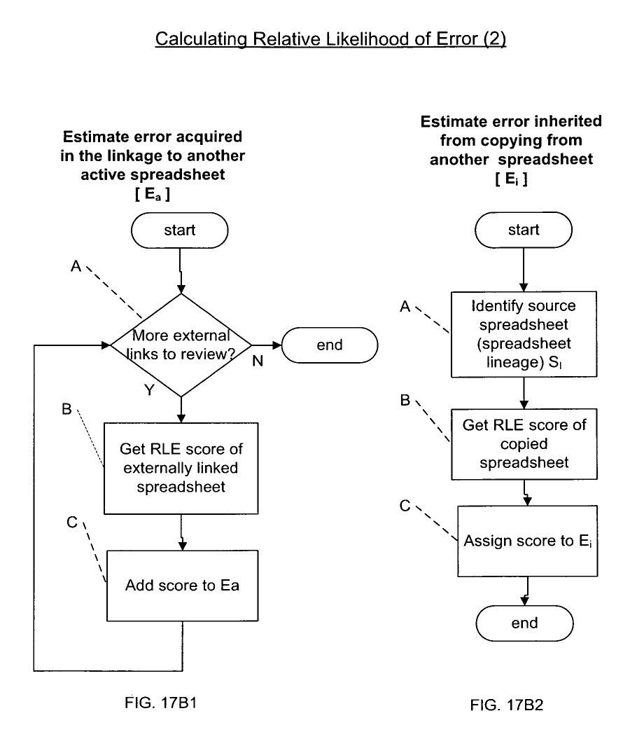

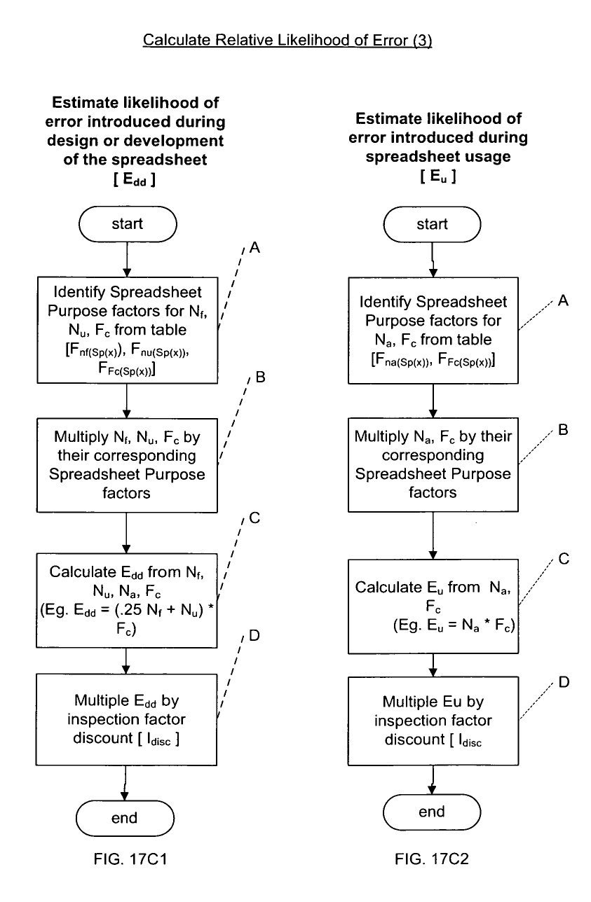

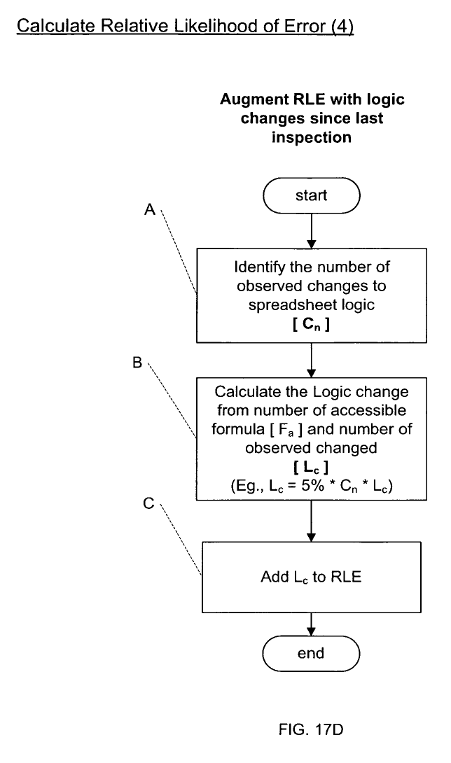

FIGS. 17A through 17D illustrate the steps carried out by the Application Server at the Central Base Station, so as to calculate the RLE for each spreadsheet under management within the network of the present invention. These steps will be described in greater detail hereinafter.

### Calculating the Relative Likelihood of Concern (RLC)

The Relative Likelihood of Concern (RLC) score represents the relative impact of an error in a spreadsheet. For example, a spreadsheet file which is deemed to be critical and carries a potential error within it carries much greater to the organization than a spreadsheet which is deemed to be of low impact.

In accordance with the principles of the present invention, RLC=RLE*Criticality Factor. Examples of the Criticality Factor are as follows: Spreadsheet Impact measure—Sᵢ₍₁₎ Critical—has a Criticality Factor of 4.0; Spreadsheet Impact measure—Sᵢ₍₂₎ Key—has a Criticality Factor of 2.5; Spreadsheet Impact measure—Sᵢ₍₃₎ Important—has a Criticality Factor of 1.5; and Spreadsheet Impact measure—Sᵢ₍₄₎ Low Impact—has a Criticality Factor of 0.75.

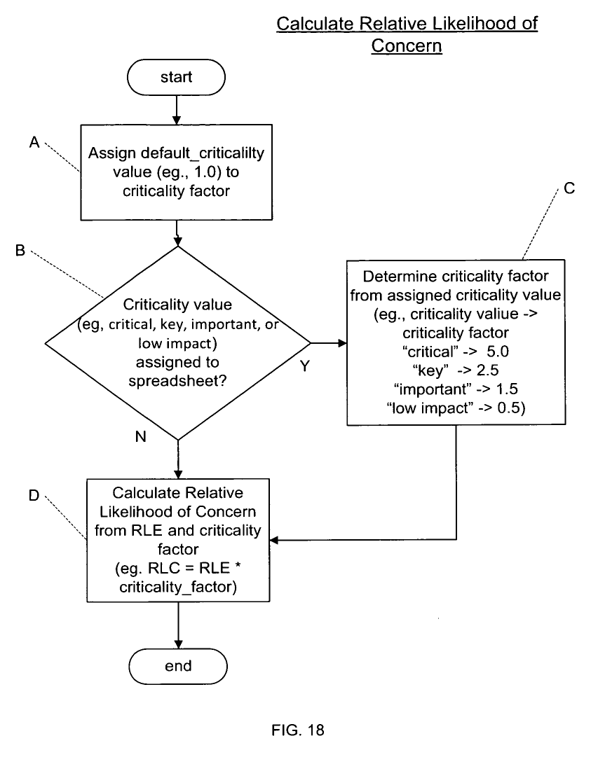

FIG. 18 illustrates a method of calculating RLC based in the value of RLE calculated by the Application Server at the Central Base Station. The method of FIG. 18 will be described in greater detail hereinafter.

### Tuning of Parameters Employed in the Risk Calculation Engine of the Present Invention

Integrated into the risk calculation engine of the present invention are a series of parameters (e.g. the Criticality Factors, and factors used to weigh or scale fundamental variables such as Number of Formula, Number of Unique Formula, Number of Accessible Formula, and Complexity of Formulas, employed in the RLE calculation). These parameters are adjusted at the time of setting up an Organization within the network of the present invention. By making slight adjustments to these parameters, the risk calculation engine of the present invention is tuned to generated risk level measures which are both meaningful and realistic, in accordance with the principles of the present invention.

An exemplary iterative process for tuning such algorithmic parameters is described as follows:

Step 1. Run the population of spreadsheets within an Organization through the risk calculation engine of the present invention to produce risk scores and a set of profiles e.g. (profile of full population, profile by spreadsheet purpose, profile by department).

Step 2. Analyze the profiles prod to search for irregularities in the distribution of risk scores across the profile.

Step 3. If no irregularities are detected across the profiles, then the parameters in the risk calculation algorithm are considered to be tuned, and no further refinement is performed.

Step 4. If irregularities are detected across the profiles, then an assessment is made as to which of the parameters noted above can and should be modified to bring the distribution of risk scores into an expected distribution pattern.

Step 5. Return to Step 1.

Advantages of Measuring Risk in an Objective-Relative Manner in Accordance with the Principles of the Present Invention

The present invention also seeks to establish clear criteria as to the specific elements of a spreadsheet formula which cause it to be prone to error (e.g. category of formula, formula complexity, number of parameters, and frequency of use). By employing such objective criteria, the present invention counts and measures the presence and frequency of these criteria within the spreadsheets providing the raw material for an unbiased objective determinant of risk within the spreadsheet.

Further, once the raw material is collected, the present invention analyzes the raw data to automatically assess the “purpose” behind each particular spreadsheet deployed within a given organization.

In accordance with the principles of the present invention, all spreadsheets having the same “purpose” are assessed relative to each other, to identify which spreadsheet, with the set of spreadsheets having the same purpose, has the greatest relative likelihood of error (RLE).

Finally, recognizing that spreadsheets have different purposes, with different levels of criticality, the present invention uses the concept spreadsheet Purpose and Criticality in combination with the concept of Relative Likelihood of Error (RLE), to calculate risk scores which present a Relative Likelihood of Concern (RLC).

### Objective Risk Values Relative to Peers

The present invention teaches the use of a more effective way to assess risk based on trusted objective data. Trust is obtained when the risk values reflect the perceptions of risk on the part of the decision maker. This will best happen when the scores are based on objective, measurable data of key risk criteria. To the extent this is possible, the risk scores both reflect unbiased objective values, and measurable therefore repeatable. Objective, measurable data will also be sensitive to change reflecting the trends that occur over time.

Given a population of risk items/events, and trusted values to represent the degree of risk associated with an event, it is possible to identify which events stand out from the others on a relative basis, based on rank ordering of risk values.

The objective model of the present invention identifies key measurable criteria which provides an unbiased view the level of risk carried by the item. By removing subjectivity and guesswork from the risk value, a significant improvement in reliability is achieved over traditional models, based on either incomplete or somewhat speculative data, attempting to assign probability and quantified consequences, or on subjective proxies that produce numeric equivalents that are prone to error.

Also, the objective model of the present invention makes no attempt to precisely calculate a risk value. Rather, the intent is to work with a population of items and find the ones that stand out relative their peers. In marked contrast with traditional models, the present invention teaches viewing risk in a relative manner, obtaining a quantified risk value, and then focusing on the resulting number, with decisions comparing the cost of preventative actions to be taken versus the potential financial impact of a risk event occurring.

Having provided an overview on determining spreadsheet risk according to the principles of the present invention, it is appropriate at this juncture to provide an overview description of the spreadsheet risk reconnaissance network of the present invention, and the various services supported thereon.

### Overview Description of the Spreadsheet Risk Reconnaissance Network of the Present Invention

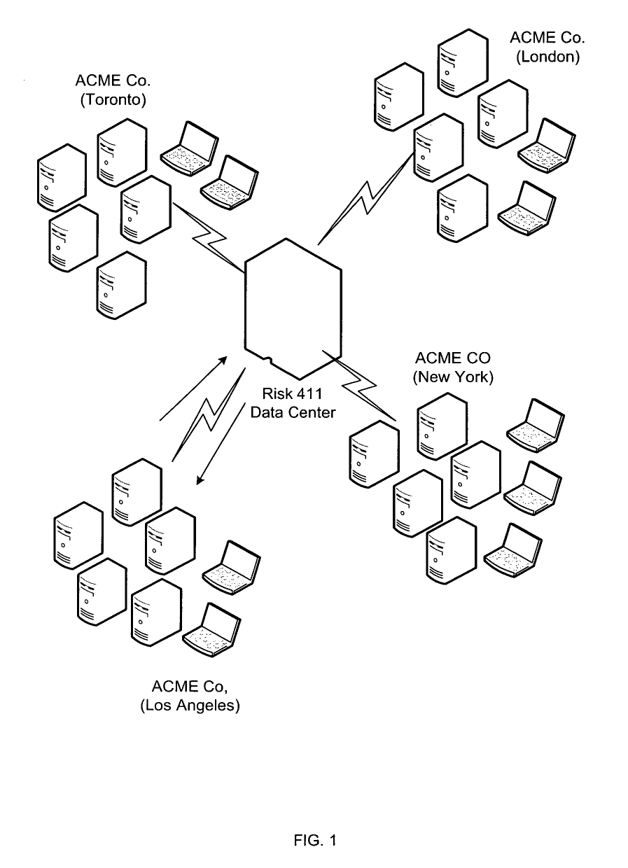

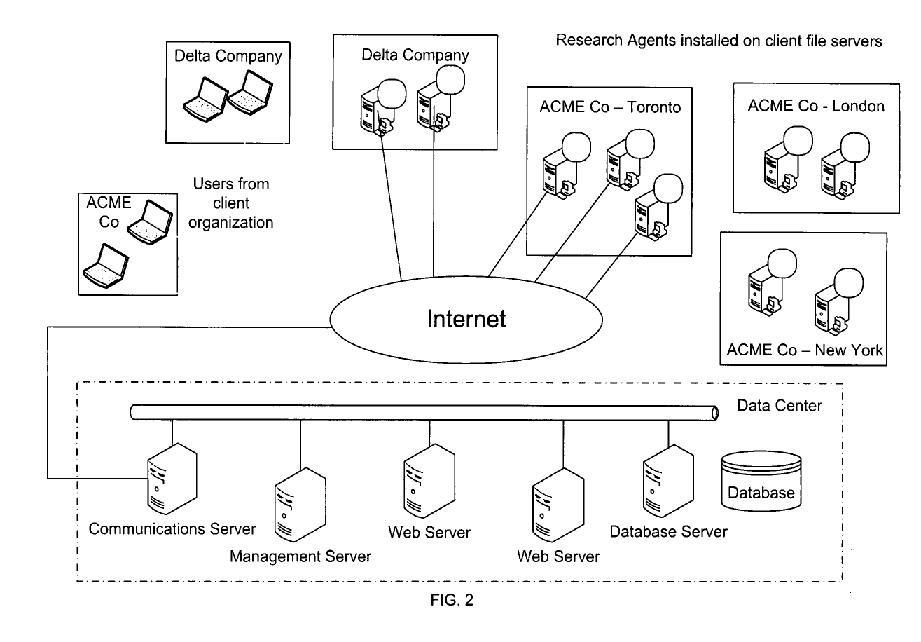

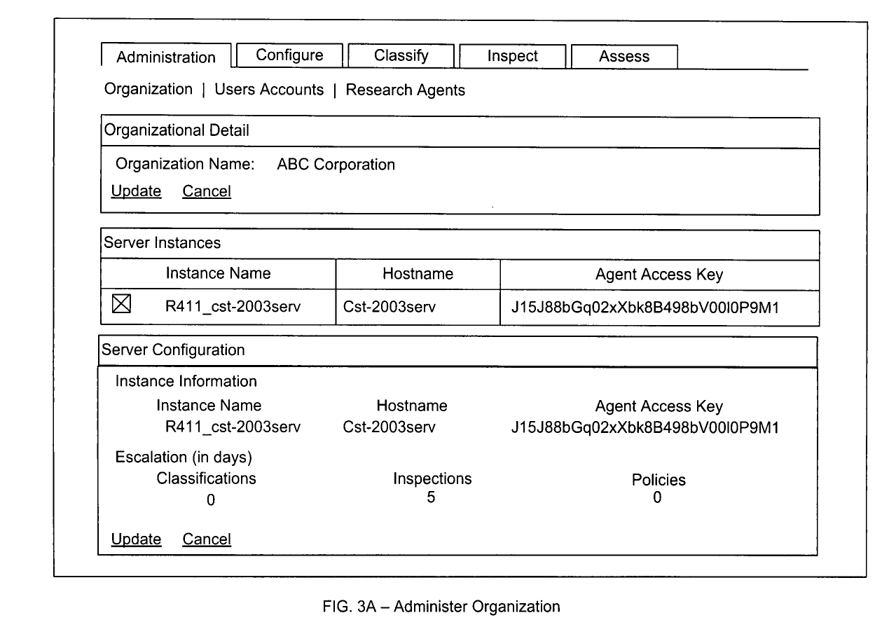

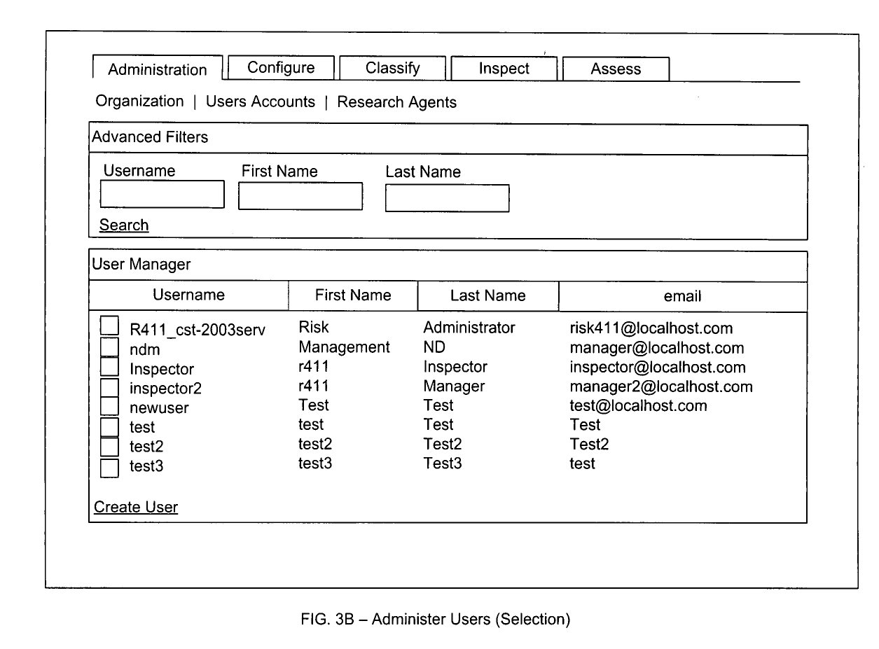

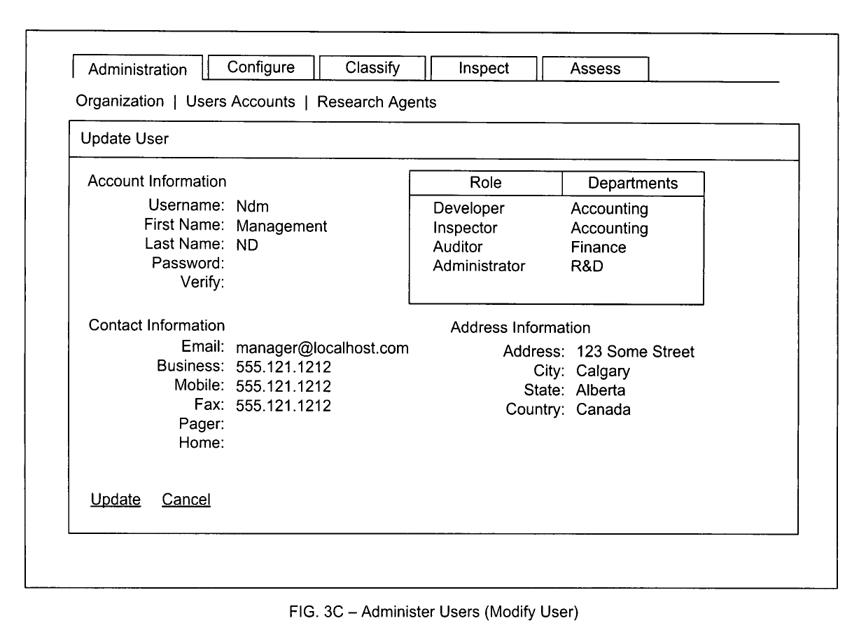

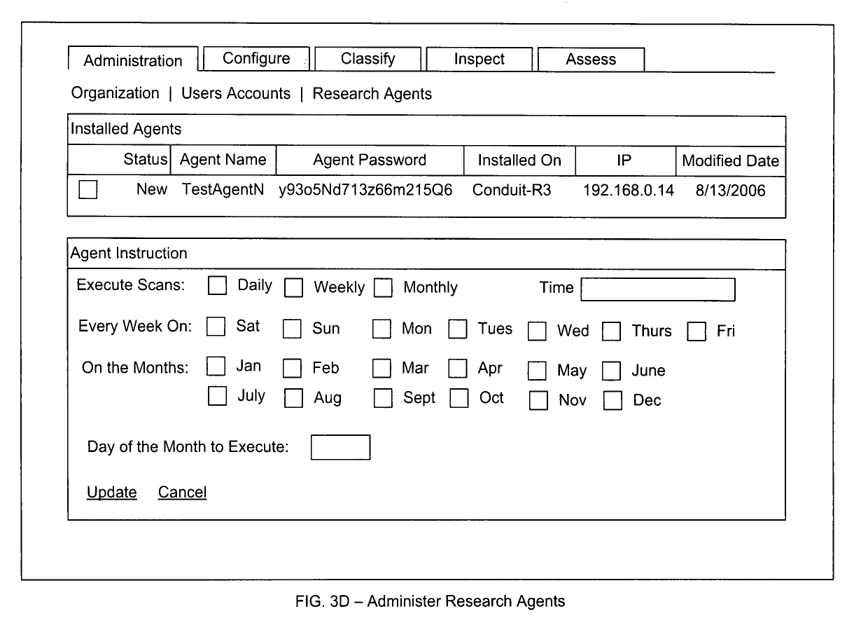

As shown in FIG. 1, the spreadsheet risk reconnaissance network of present invention comprised a means to collect and disseminate information for multiple geographic locations of an organization (potentially from around the world). As shown in additional detail in FIG. 2, the spreadsheet risk reconnaissance network of the present invention comprises a number of network components: a plurality of spreadsheet file servers for supporting a plurality of user organizations communicating with a central risk reconnaissance data center; wherein the central risk reconnaissance data center includes: a plurality of communication information servers for supporting communication services between the data center and numerous spreadsheet file servers and client machines; a plurality of web servers for serving the GUIs shown in FIGS. 3A through 7A, to client machines operably connected to the network of the present invention; one or more application servers, interfaced with the web servers, for deploying an object-oriented system engineered (OOSE) application implementing the risk reconnaissance system of the present invention, using OOSE principles; one or more database (RDBMS) servers, interfaced with the application servers, for implementing the object-entity (EO) model of the risk reconnaissance system of the present invention; and one or more management servers for managing the underlying network operations and security of the spreadsheet risk reconnaissance network of the present invention. As shown, all network components are interconnected by way of the TCP/IP fabric in a conventional manner.

Also illustrated in FIG. 2, a software-based research agent (i.e. software program) is installed on each file server registered on the network of the present invention. Each Research Agent operates transparently to users on the network so as to perform a number of mission-critical functions, namely: (i) automatically collecting metadata from spreadsheet documents (i.e. files) stored on file servers registered on the network; and (ii) transmitting this metadata to a central risk reconnaissance data center for storage and analysis in accordance with the principles of the present invention.

The primary function of the central risk reconnaissance data center is to perform a number of mission-critical operations, namely: (i) analyzing collected metadata associated with each spreadsheet documents; (ii) automatically identifying Spreadsheet Purpose (role) from the collected metadata; and (ii) calculating the Relative Likelihood Of Error (RLE) and the Relative Likelihood Of Concern (RLC), based on the calculated RLE, for each and every spreadsheet file under management by the system of the present invention, and allow retrieval of analyzed information to the key constituents of the client organization via reports and various forms of user interface.

In accordance with the present invention, risk officers, who have been assigned to particular spreadsheet document or group of documents within the organization, are provided access to operational GUIs and reports for a variety of purposes, including: (i) manually classifying analyzed spreadsheet documents; (ii) adding additional attributes of value thereto and (iii) notifying risk inspectors, with expertise in the logic and structure of assigned spreadsheet documents, to access and inspect the particular spreadsheet file or files for further investigation of potential problems that may be embodied there within. These services will be performed in an Application Service Provider model where the information will be entered via an Internet browser and stored within the risk reconnaissance data center.

### Specification of User Types Supported on the Spreadsheet Risk Reconnaissance Network of the Present Invention

The various types of “users” on the spreadsheet risk reconnaissance network will now be specified in detail as follows:
Research Agent: Research Agents are software modules installed on each computer (as an application or service) that contains active production spreadsheet files. These are computers are typically file servers which are possibly geographically dispersed, but may also include computers assigned to individuals.
Administrator: Administrators are the people who install Research Agents on the various servers within the organization, provide Organizational Configuration information to Risk Reconnaissance Network, and provide Configuration information to drive the Risk Reconnaissance Network actions.
Managers: Managers are individuals who are responsible for business processes within an organization, e.g. Accounting, Finance, and Legal. Within these business processes spreadsheets will typically exist and stored within specific folders on computers within the organization.
Inspector: Inspectors are defined as people with subject matter expertise who are able to provide a reliable assessment on the compliance with spreadsheet policy components, formula accuracy, and general validity and accuracy of the spreadsheet for use in an active production business process.
CRO: CRO represents a set of individuals accountable for the managing risk within the organization. Representative individuals include Chief Risk Officer, Internal Auditor, Senior Management, External Auditor, Board of Directors, and Audit Committees.

### Detailed Specification of Services Supported by the Spreadsheet Risk Reconnaissance Network of the Present Invention

Referring to FIGS. 3A through 7, the primary services supported by the spreadsheet Risk Reconnaissance Network of the present invention will now be described.

As part of the initial implementation of the Risk Reconnaissance Network, system administrators will identify and install a Research Agent on each registered computer system containing production spreadsheet files (i.e. documents) that are to be monitored on the network. These computer systems will typically be file servers and may be located across multiple geographies. Upon installation of each Research Agent, it will send a notification to the Risk Reconnaissance Application Server, indicating that it has been installed and ready for Configuration.

### Administration Services

In FIG. 3A, there is shown an exemplary graphical user interface (GUI) screen which is served to the Web browsers of Administrator Users, by the communication servers of the spreadsheet Risk Reconnaissance Network of the illustrative embodiment of the present invention, so as to enable administrators to manage the Administration of their Organization on the network. As shown, this GUI supports services that enable Administrator Users to do the following: (i) assign the Organization Name to the Risk Reconnaissance Network; (ii) review the specific server for review; (iii) select the instance details for each defined server; (iv) establish the parameters for escalation for a specific server (notification to responsible parties when defined actions are not taken within a provided number of events).

Once the Organization Administration web page is entered, the Administrator User for the organization will be presented with the Organization Detail as well as the server instances which have been identified. Several possible actions may be performed.

The first option presented is to modify the Organization Name. This will appear in system output reports, graphs, and tables.

The second option presented is to review the defined server instances and select one of these to see additional details. These details consist of information pertinent primarily to Risk Reconnaissance Network, namely the Risk Reconnaissance server instance name, the server host name as defined on the server operating system, and an internal agent access key.

The third option presented is to select one of the server instances. Performing this action will allow the Administrator User to see additional details established for this server. If this option is selected, the Application Server will present on the web page additional information defined for the selected spreadsheet.

The forth option presented upon selection of the server instance will provide the Administrator User with the parameters defined for escalation to the person designated for notification if specific actions are not taken within the designated period of time.

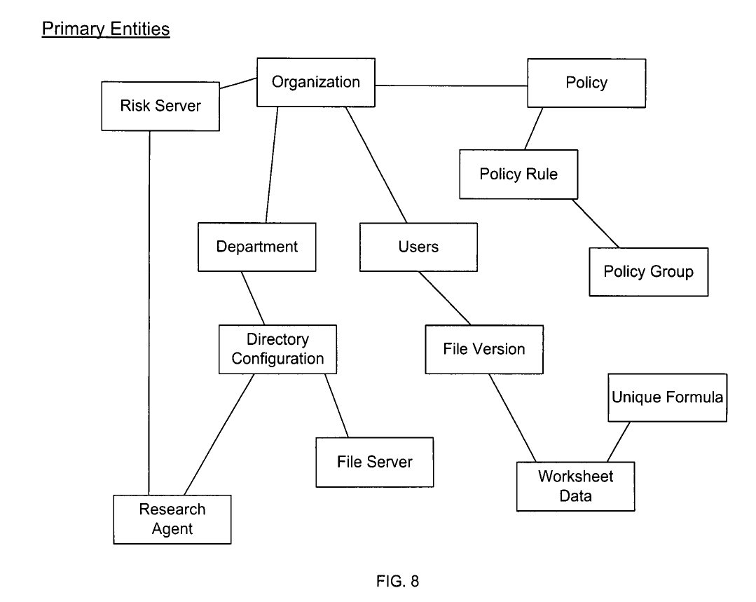

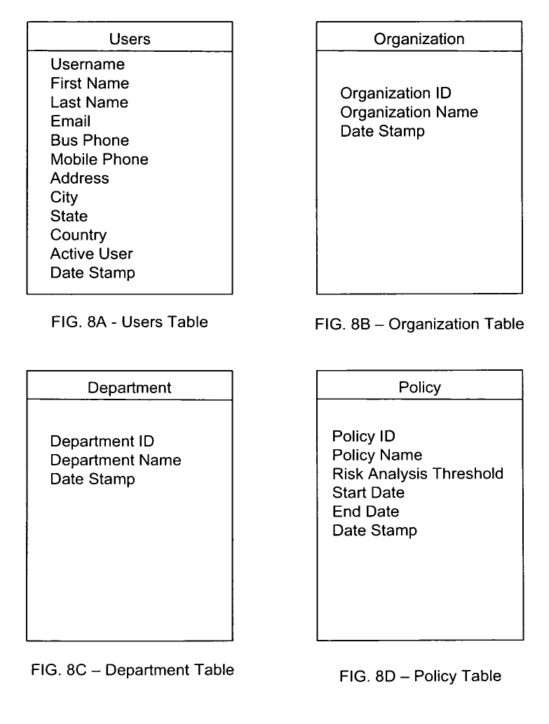

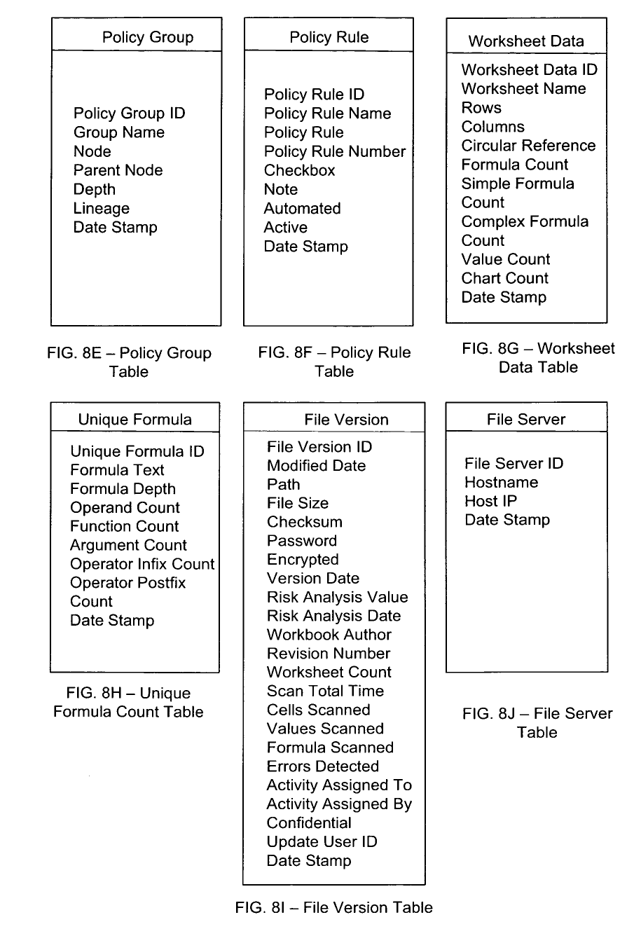

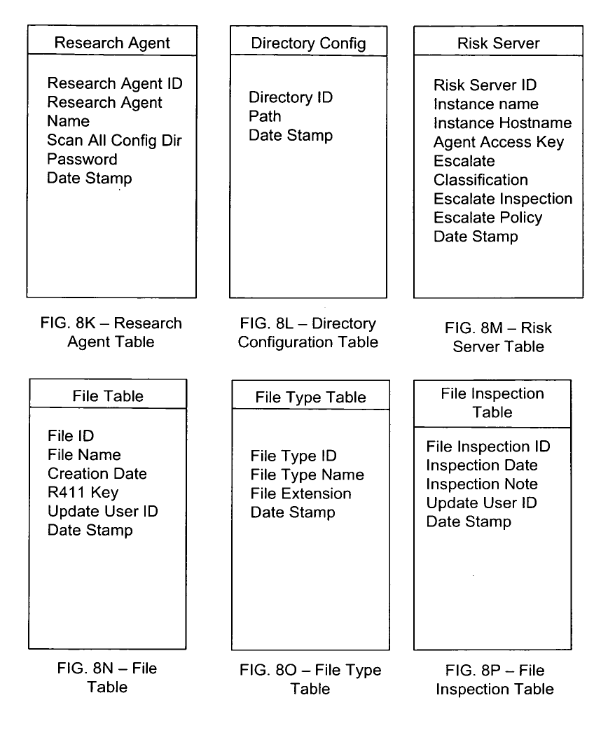

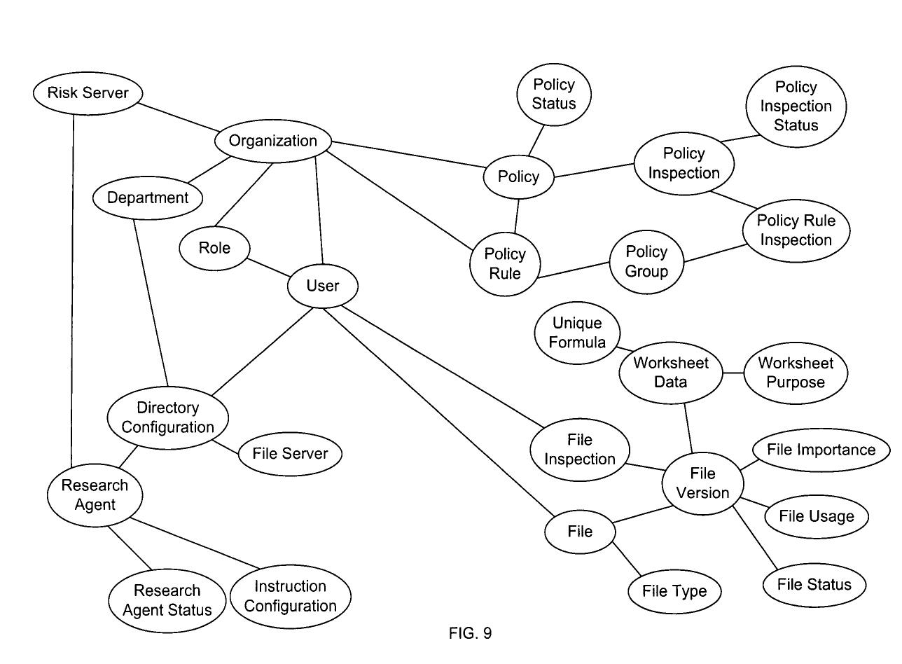

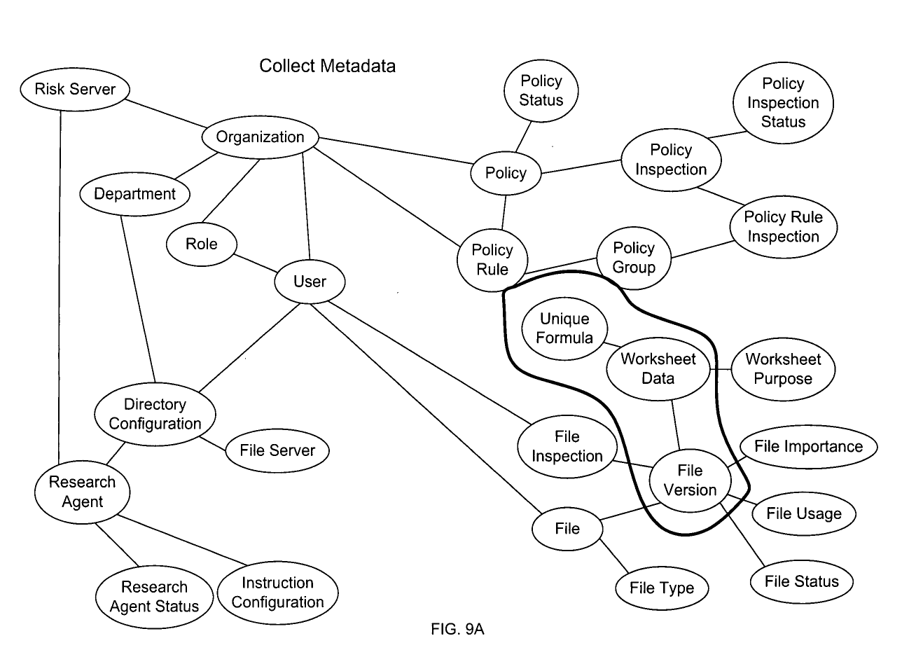

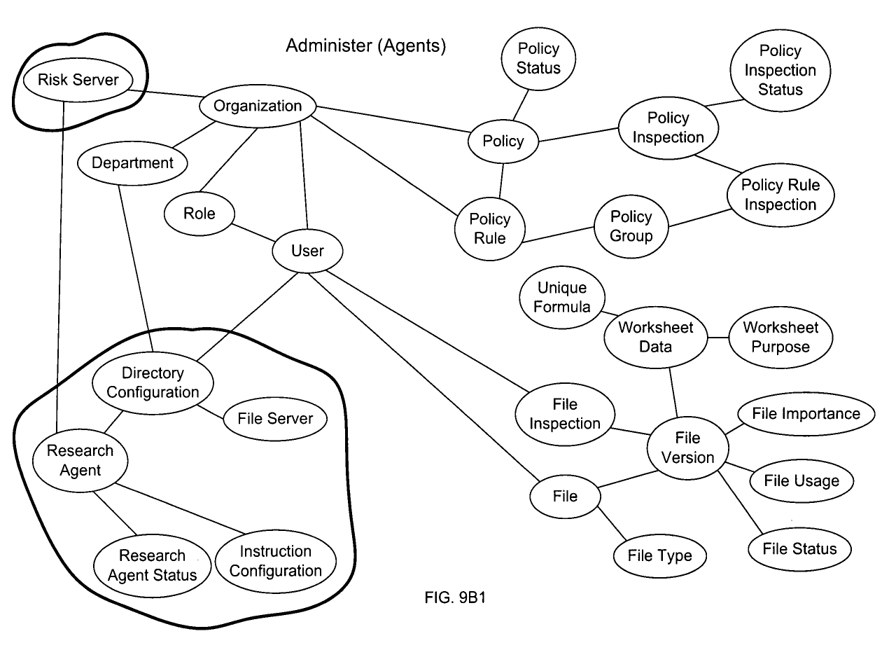

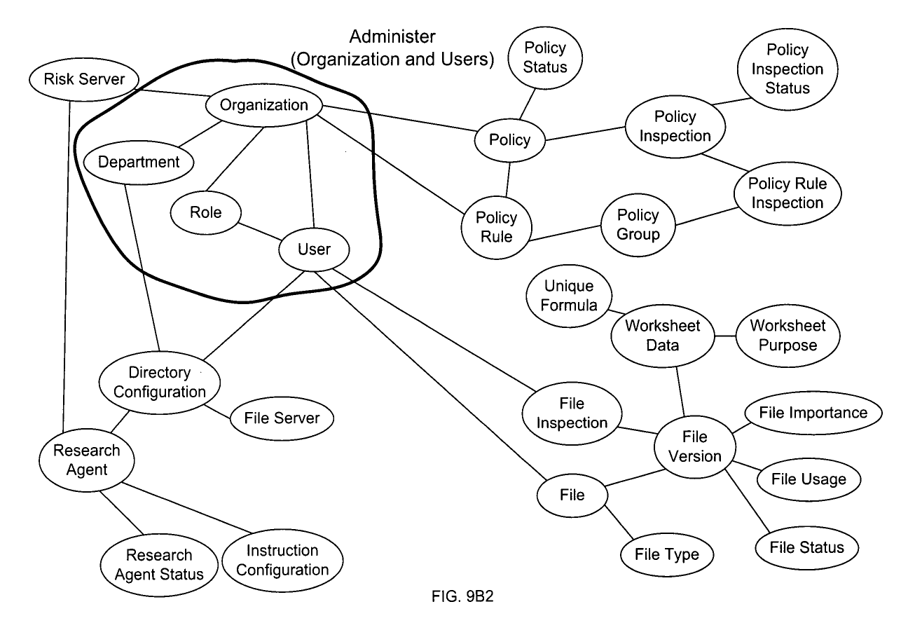

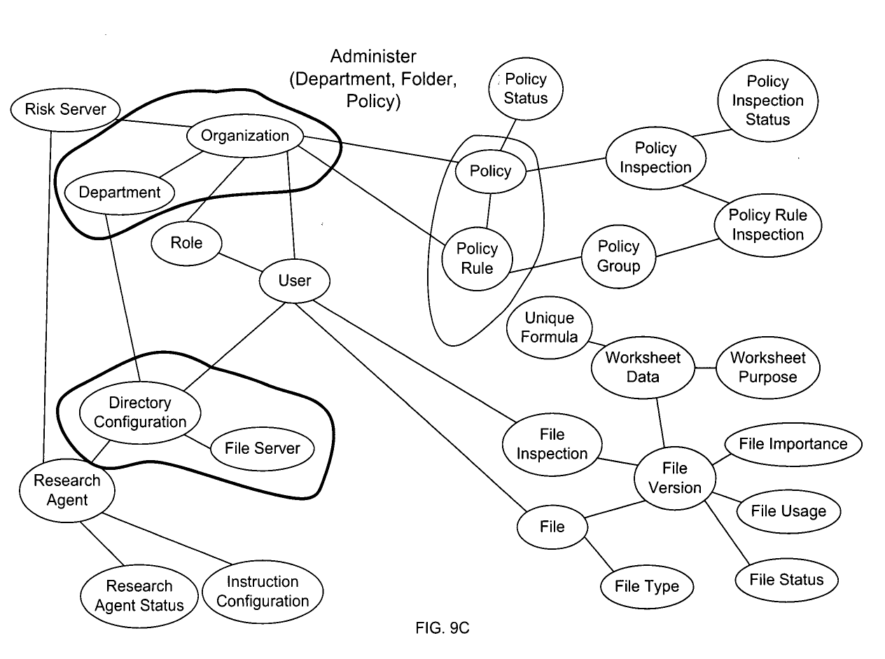

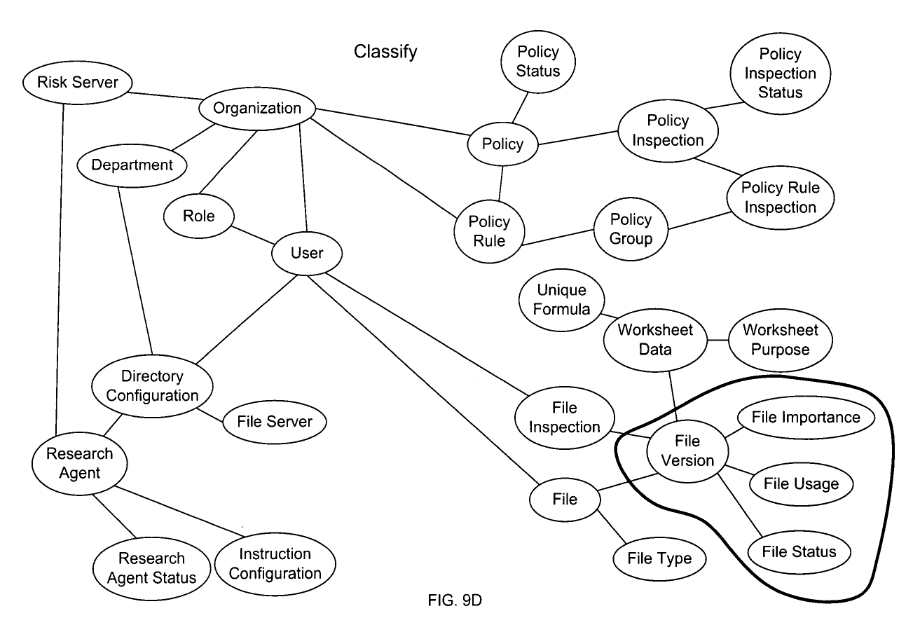

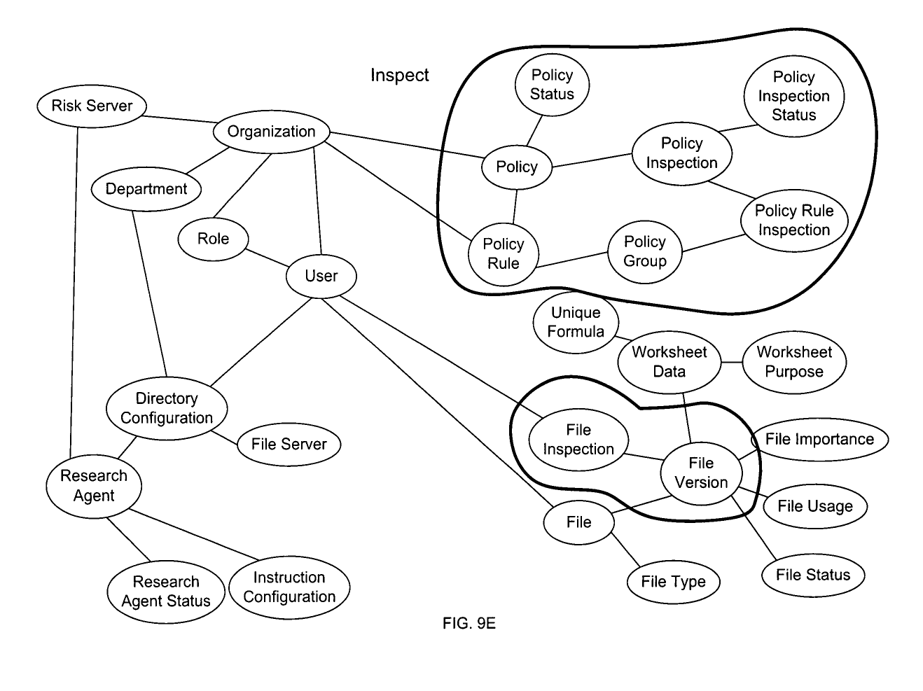

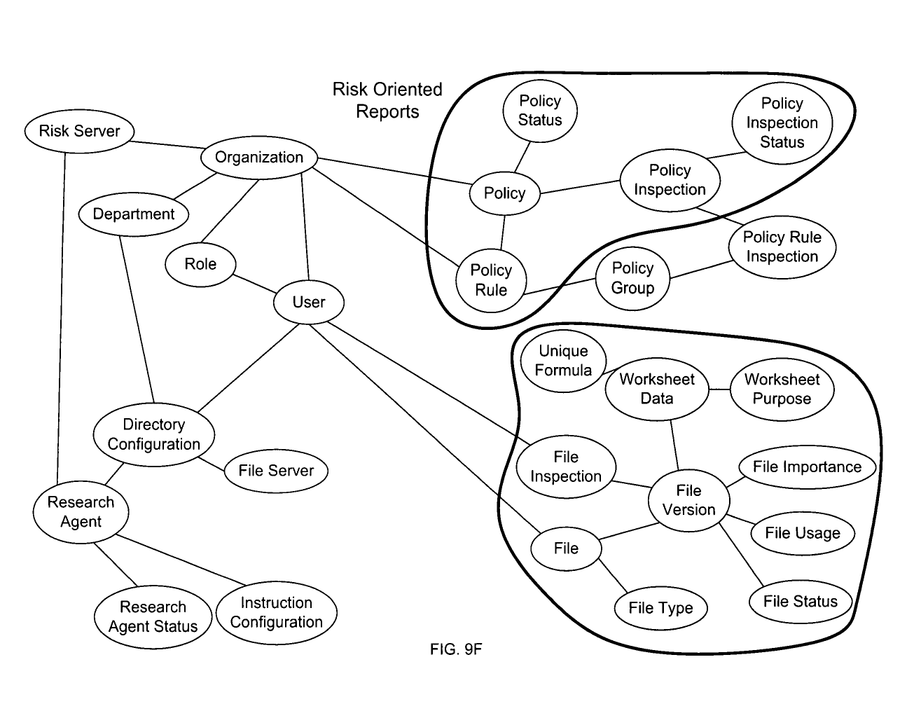

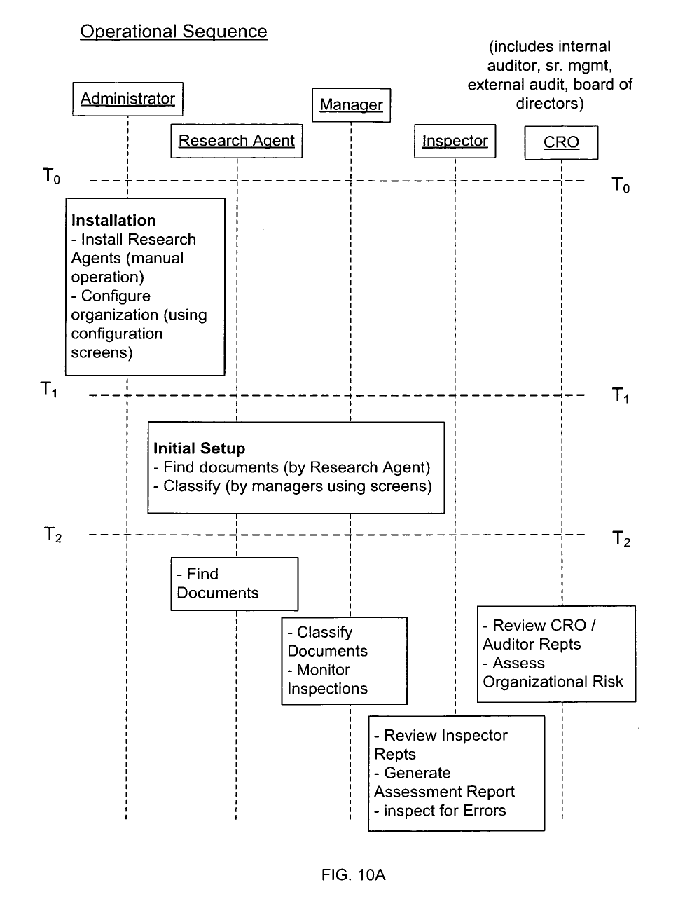

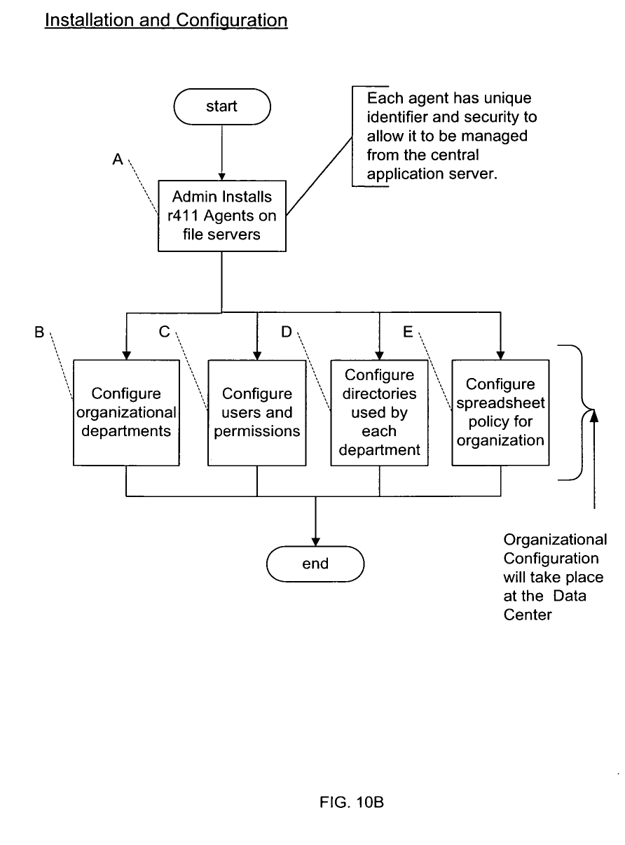

The services presented by the GUI represented in FIG. 3A are supported by a data structure depicted in FIG. 9B2. As shown, there are several entities that will record the organization and user information, specifically entities labeled Organization, Department, Role and User. Regarding the GUI represented in FIG. 3A, the entities of Organization are shown in FIG. 8B, and Department, shown in FIG. 8C.

In FIG. 3B, there is shown exemplary GUI screens that are served to the Web browsers of Administrator Users, by the communication servers of the spreadsheet Risk Reconnaissance Network of the present invention, so as to enable administrators to manage the Administration of User Accounts on the network. As shown, this GUI supports services that enable Administrator Users to do the following: (i) search for specific user; (ii) review the list of users who are authorized to access the Risk Reconnaissance Network; and (iii) select a specific user to access details for the selected user.

The first option to search for a specific user will allow the Administrator User to find an authorized user defined to the Risk Reconnaissance Network by the individuals name characteristics. It is entirely possible that a large organization may have hundreds of authorized users with access to the Risk Reconnaissance Network. This function will allow the Administrator User to quickly identify a specific user.

The second option is to review the list of core information associated with each authorized User presented on the GUI screen. This GUI will present the Administrator User with a scrollable list of all authorized users, along with basic information of username, first and last name, and email address for each. This list will be filtered down to those which match the criteria specified in the filter defined in (i) above.

The third option presented on the GUI screen shown in FIG. 3B is the selection of a specific User providing access to the details for this User. This will allow the Administrator User to modify the authorization and professional characteristics of each user of the risk reconnaissance network.

If a specific user has been selected, the Administrator User will be presented with another set of options shown by the exemplary GUI screens shown in FIG. 3C. As shown, this GUI supports services that enable the Administrator User to do the following: (i) update user account information; (ii) update the contact information for the specific user; (iii) update the physical address associated with selected user; and (iv) update the roles the user is authorized to perform with the risk reconnaissance network.

By selecting options (i), (ii), or (iii), the Administrator User can modify the professional characteristics of a specific authorized user. These characteristics are to be used in other parts of the Risk Reconnaissance Network during the Early Warning notification of identified events.

By selecting option (iv), the Administrator User can modify the specific authorizations assigned to the selected user, as well as the department(s) the authorized user is assigned to. This will allow the Administrator User to define multiple roles for a specific individual, as well as who is authorized to perform the functions related each of the business functions associated with the Risk Reconnaissance Network.

The services presented by the GUI represented in FIG. 3B and FIG. 3C are supported by a data structure depicted in FIG. 9B2. As with FIG. 3A, there are several entities which will record the organization and user information, specifically entities labeled Organization, Department, Role and User. Further detail is represented in FIG. 8A with additional detail of the Users entity.

In FIG. 3D, there is shown an exemplary GUI screen which is served to the Web browsers of Administrator Users, by the communication servers of the spreadsheet Risk Reconnaissance Network of the present invention, so as to enable administrators to manage the Administration of Research Agents on the network. As shown, this GUI supports services that enable Administrator Users to do the following: (i) Review the list of installed Research Agents; (ii) Select a Research Agent to review additional detail specific to a particular Research Agent; (iii) Define the periodicity of the Research Agents scan and review of the server; and (iv) Define the types of files which are candidates for monitoring (not shown).

The first option (i) will provide the Administrator User the list of Research Agents which have been deployed within the organization for the Risk Reconnaissance Network. This service provides the ability to identify which agents are installed within the organizations network, as well as where they are installed.

The second option (ii) will allow the Administrator User to select one Research Agent from the list of all Research Agents installed on the organizations network. This service will allow for a large number of Research Agents to be presented on the GUI screen at one time, and allow for a specific Research Agent to be identified and selected for further information to be reviewed and/or modified.

Upon selection of a specific Research Agent, the GUI screen shown in FIG. 3D will present the details specific to the selected Research Agent. At this time the Administrator User will be able to define the times and dates when the Research Agent will run in an automatically initiated manner on the server on which it has been installed. This will free the Administrator User from having to start the Research Agent in order to perform its function.

Option (iv) available to the Administrator User will allow for the Research Agent to look for specific types of files. For example it may be specified that the Research Agent review and monitor a specific version of spreadsheet file, e.g. Microsoft Excel 2003, or multiple versions of spreadsheets, e.g., Microsoft Excel 2003 and Microsoft Excel 2007. In the future this may be used to identify all digital assets within an organization, each of which would have its own specific file type.

The services presented by the GUI represented in FIG. 3D are supported by an underlying data structure depicted in FIG. 9B1 where entities of Research Agent, Research Agent Status, Directory Configuration, Instruction Configuration, and File Server are represented. Specific entities are represented in FIG. 8K where the Research Agent entity is depicted, FIG. 8L where the Directory Configuration entity is depicted, and in FIG. 8M where the Risk Server entity is depicted.

### Configuration Services

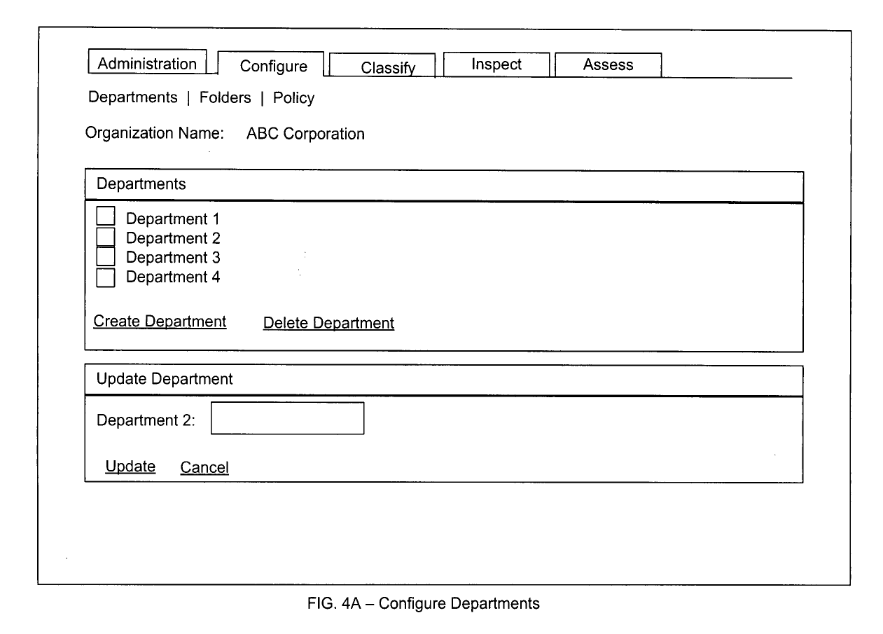

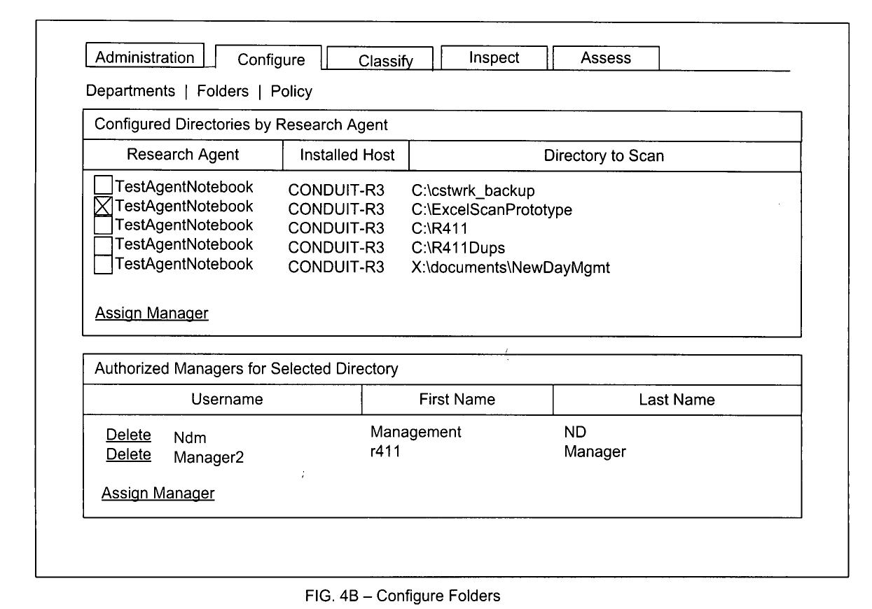

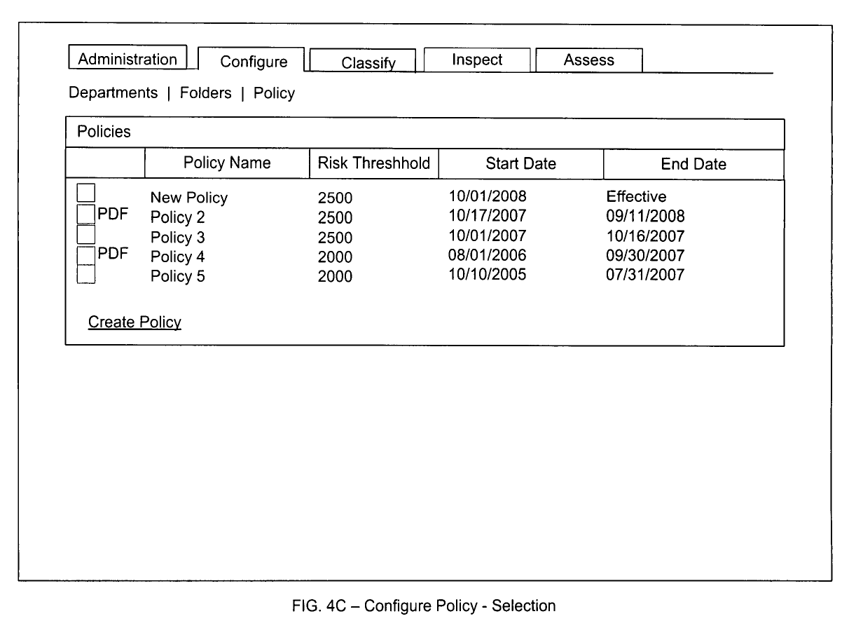

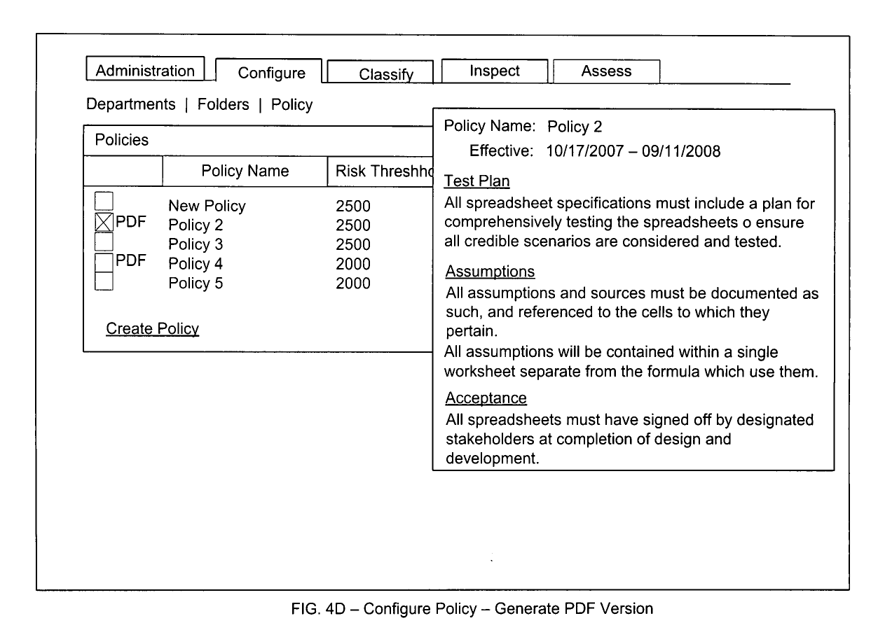

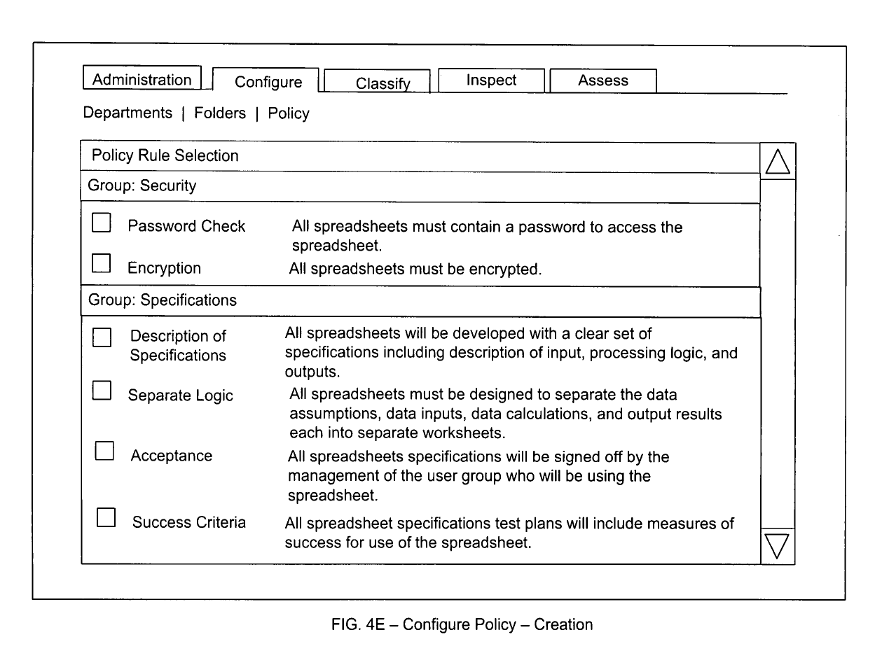

In FIGS. 4A through 4E, there are shown exemplary GUI screens which are served to the Web browsers of Administrator Users, by the communication servers of the spreadsheet Risk Reconnaissance Network of the present invention, so as to enable administrators to manage the Administration of Departments, Folders, and Policy Creation/Management, respectively, for User Accounts supported on the network. As shown, this GUI supports services that enable Administrator Users to do the following: (i) Configure departments within an organization; (ii) Configure folders within an organization which contain production spreadsheets; and (iii) Configure organization spreadsheet policies.

The exemplary GUI screen FIG. 4A represents the service (i) that will Configure the various departments which reside within the organization. This will allow the Risk Reconnaissance Network to define the business organization in terms of the departments that comprise the organization.

The exemplary GUI screen depicted in FIG. 4B represents the service (ii) which Configures folders within an organization. This service will allow for the Administrator User to define the folders on the servers within the organization that should be monitored for production spreadsheet activity. In addition, FIG. 4B represents the service which allows for a designated user to be named as the manager of the business process which makes use of a specific directory. These two services will collectively align the Configuration of the Risk Reconnaissance Network with the organization structure within the business organization.

The exemplary GUI screen depicted in FIG. 4C, FIG. 4D, and FIG. 4E represent the service (iii) Configure ring spreadsheet policies. In FIG. 4C, the organizations defined spreadsheets are identified and presented to the Administrator User. Based on this set of defined spreadsheets, policy effective dates are identified along with notification that the electronic compiled policy is or is not available for review in a non-modifiable format.

When a policy with a non-modifiable format is to be reviewed, the authorized user will press the PDF indicator, as shown in FIG. 4C, with the associated non-modifiable document presented to the authorized user as shown in FIG. 4D.

The exemplary GUI screen depicted in FIG. 4E represents the service of configuring a spreadsheet policy for the organization. The Administrator User will be presented with the ability to assign effective dates for the policy, as well as a number of spreadsheet policy components. Each policy component will represent a specific testable and measurable aspect of the spreadsheet policy, e.g., requiring passwords on spreadsheets, spreadsheets must be encrypted, and spreadsheets must be validated by a recognized domain expert. Each of these components will be testable by either an automated scan or noted to be tested by a manual inspection. Within each policy, the Administrator User will select the components which apply to the organization in defining their spreadsheet policy for the designated time period. In aggregate, the selected policy components will define the organization spreadsheet policy and establish the reference for policy compliance in a combination manual and automated fashion.

The services presented by the GUI represented in FIG. 4A FIG. 4B, FIG. 4C, FIG. 4D, and FIG. 4E are supported by an under lying data structure depicted in FIG. 9C where entities of Organization and Department; Policy and Policy Rule; and Directory Configuration and File Server are represented. Specific entities are represented in FIG. 8B where the Organization entity is depicted, FIG. 8C where the Department entity is depicted; FIG. 8D where the Policy entity is depicted; FIG. 8E where the Policy Group entity is depicted; FIG. 8F where the Policy Rule entity is depicted; and FIG. 8J where the File Server entity is depicted.

### Classification Services

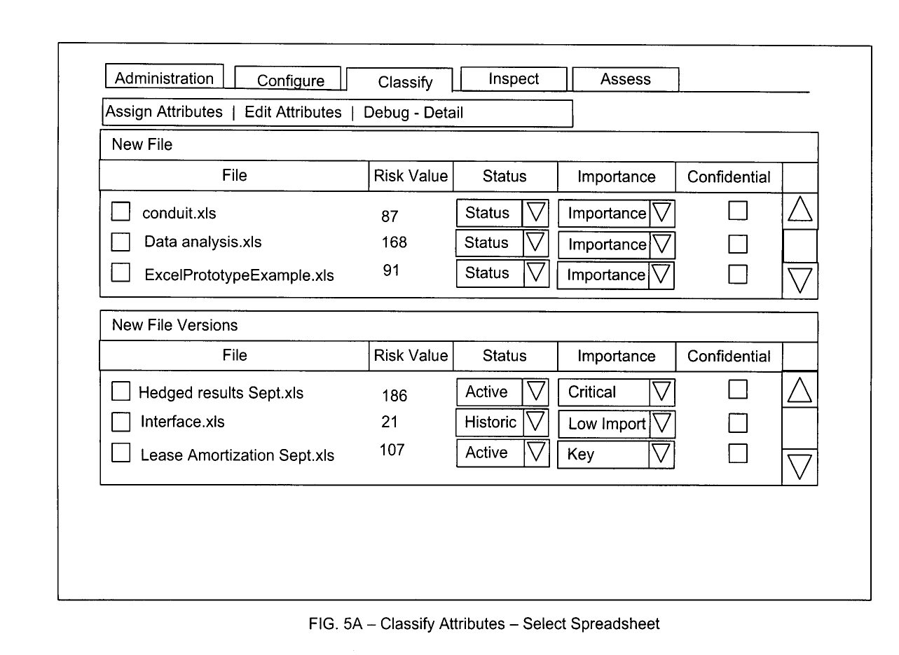

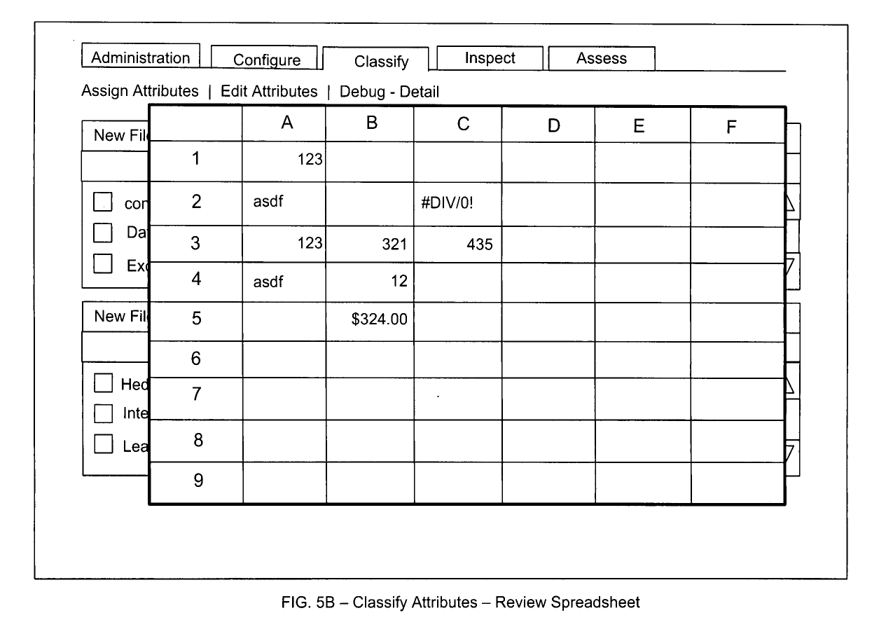

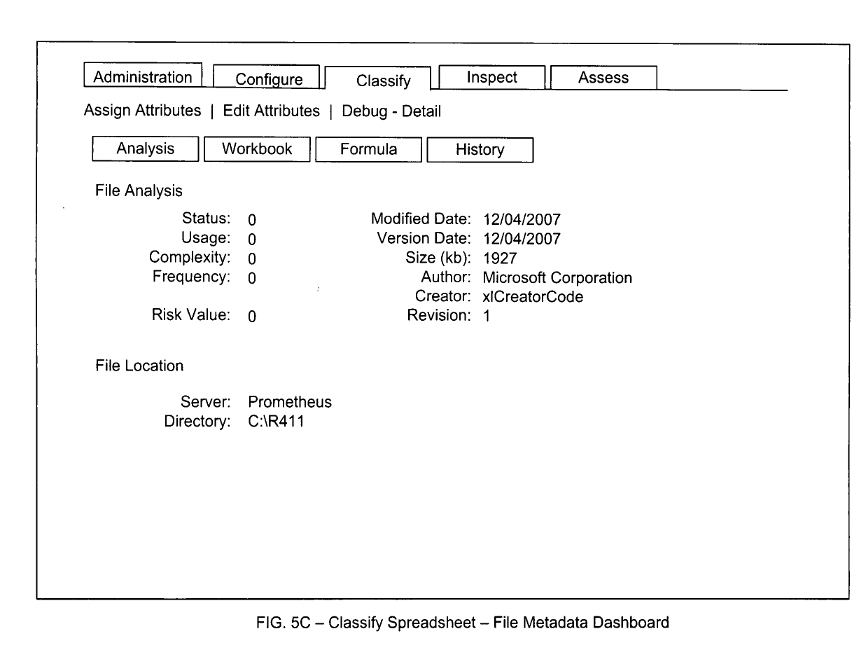

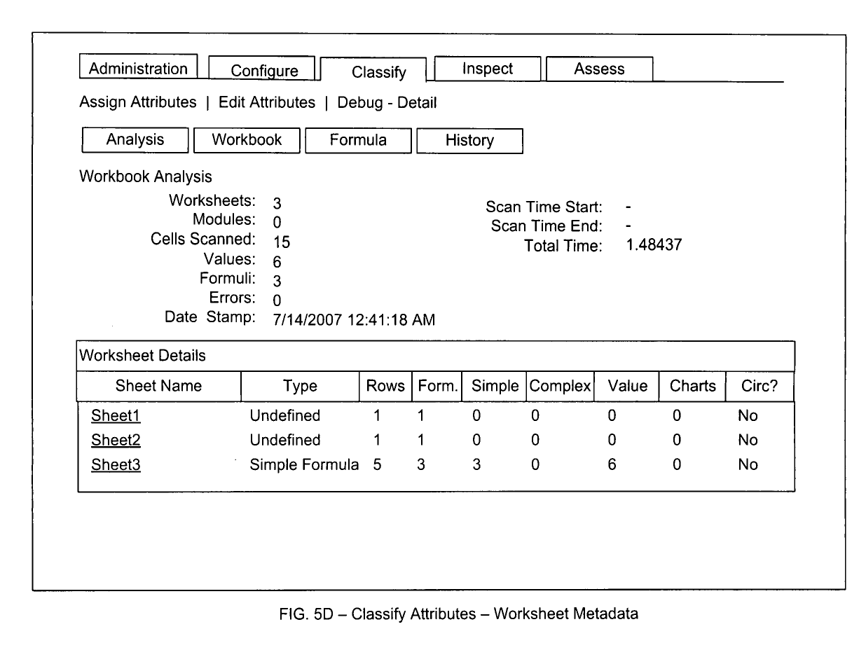

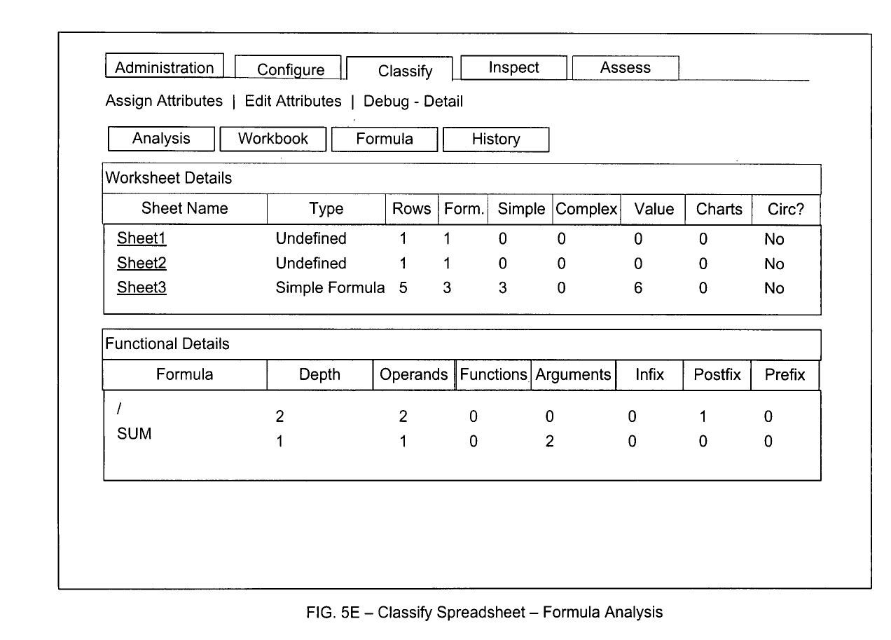

In FIGS. 5A through 5E, there are shown exemplary GUI screens that are served to the Web browsers of Administrator Users, by the communication servers of the spreadsheet Risk Reconnaissance Network of the present invention. The purpose of these GUIs is to enable Business Manager users to classify a Spreadsheet document supported on the network.

As shown, the GUI of FIG. 5A supports services that enable users to do the following: (i) review spreadsheet files which have had the business logic modified and are the responsibility of the Business Manager user; (ii) assign business attributes to each of the modified spreadsheets; (iii) select a modified spreadsheet to identify additional detail related to the spreadsheet metadata; (iv) select the modified spreadsheet for the Business Manager user to review; and (v) assign the spreadsheet to an Inspector user to examine the spreadsheet logic and certify its accuracy.

The spreadsheets presented in FIG. 5A are grouped into New Files, New File Versions, Duplicate Files, and File Derivatives. Within each of these groups the Business Manager user can select the number of spreadsheets viewable at one time.

The spreadsheets that appear in the New File group will be new to the Risk Reconnaissance Network platform. This is determined by whether the spreadsheet has had a Risk Reconnaissance identifier assigned to and carried by the spreadsheet file. If this identifier is not present on the spreadsheet, it will be the first time the spreadsheet file has been reviewed by the Risk Reconnaissance Network platform and considered new.

The following three groups (New File Versions, File Duplicates, and File Derivatives) represent spreadsheet files that have been seen by the Risk Reconnaissance Network at least one time in the past.

Spreadsheets that appear in the New File Version group will be those that have been scanned by the Risk Reconnaissance Network platform in the past and carry a Risk Reconnaissance Network platform identifier. This signifies that the spreadsheet has had its logic modified since the point in time that the spreadsheet was originally reviewed and has its identifier assigned.

Spreadsheets that appear in the Review Duplicate File group will contain a Risk Reconnaissance identifier and have the same file name as the original file, but be located in a different folder. This spreadsheet file category provides the Business Manager user with an indication of where redundancies exist and further investigation may need to take place. Because these files had originated as another file, they will inherit the risk associated with the previous file.

Spreadsheets that appear in the Review Derivative File group (not shown in FIG. 5A) will contain a Risk Reconnaissance identifier but have a different file name. This will indicate the spreadsheet has been copied to another location and then modified and renamed creating a derivative of the original file. This category of spreadsheet files indicate to the Business Manager user that these files had a point of origin other than the current folder, and these spreadsheet files will inherit the risk of the spreadsheet file they were derived from.

The review spreadsheet files service (i) identifies to the Business User which spreadsheet files which are in folders defined to be the domain of the Business User manager, that have had their programmatic logic modified. This provides value to the Business Manager user as they will be able to identify where the spreadsheet logic is changing within the part of the organization they are responsible for, and therefore be able to identify where the risk profile is changing.

The Business manager user will also have available the service to assign business attributes to the identified spreadsheet files (ii). Three attributes are available for assignment—specifically status, impact, and confidential.

The Status attribute refers to where in the life cycle of a spreadsheet the spreadsheet file is.

There are four possible values for this attribute.

(1) A Status attribute of Active means the spreadsheet file is currently active in the processing of live or production information in a business process.

(2) A Status attribute of Developmental means that the spreadsheet file is currently under development and once completed will be “promoted” into an active status in use in a business process.

(3) A Status attribute of Historic means that the spreadsheet is no longer processing active information in a business process.

(4) A status attribute of Exempt means that the spreadsheet file is not part of any business process and should not be considered a candidate for monitoring.

The Impact attribute refers to how the spreadsheet impacts the organization, or how important it is to the organization. There are four possible values for this attribute—critical, key, important, and low impact.

An impact attribute value of Critical means that a material error could compromise a government, a regulator, a financial market, or other significant public entity and cause a breach of the law and/or individual or collective fiduciary duty. Defects in the logic may place those responsible at significant risk of criminal and/or civil legal proceedings and/or disciplinary action.

An impact attribute value of Key means that a material error could cause significant business impact in terms of incorrectly stated assets, liabilities, costs, revenues, profits or taxation etc. Defects in logic may place those responsible at risk of adverse publicity and at risk of civil proceedings for negligence or breach of duty and/or internal disciplinary action.

An impact attribute value of Important means that material error could cause significant impact on the individual in terms of job performance and career progression without directly, greatly, immediately, or irreversibly affecting business or the organization.

An impact attribute value of Low (Impact) means that material error would not have any significant impact to the organization or individuals involved.

The Confidential attribute indicates that a spreadsheet file contains information that is confidential of sensitive in any way.

Service (iii) described in FIG. 5A to the service that allows a Business Manager to select a modified spreadsheet to identify additional detail related to the spreadsheet metadata. This will allow the Business Manager user to obtain the information they will require to make decisions. This is further discussed in describing FIG. 5C.

The Business Manager user will be able to select the modified spreadsheet for the Business Manager user to review (service iv). This selection will retrieve the spreadsheet file from the file server from where it was identified and present it to the Business Manager user allowing for the direct examination of the spreadsheet file by the Business Manager user. This is represented in the GUI FIG. 5B.

Finally, the fifth service (v) provided to the Business Manager user is to assign the spreadsheet to an Inspector for further analysis.

As shown, the GUI of FIG. 5C shows the preliminary metadata information which is presented to the Business Manager user when requested (see FIG. 5A, Service iii). This service presents the Business Manager user with the business attributes that have been assigned (if any), as well as dates of modification, the size of the spreadsheet file, and the revision of this spreadsheet file. The Business Manager user is also presented with the ability to retrieve additional metadata information as shown if FIG. 5D, and FIG. 5E.

As shown, the GUI of FIG. 5D shows the specific metadata information from each spreadsheet within the workbook. The metadata collected and presented for review include the number of rows and columns within the spreadsheet, the number of formula within the spreadsheet, the number of simple and complex formula, the number of charts within the spreadsheet, and if there are any circular, references within the spreadsheet. This service will provide the Business Manager user with information describing the complexity of the spreadsheets in spreadsheet file.

As shown, the GUI of FIG. 5E shows the metadata which is collected for each formula within the spreadsheet. As described in the Spreadsheet Risk section, the formula depth, operands, functions, arguments, infix operators, postfix operators, and prefix operators for the associated formula in the spreadsheet. This service will provide the Business Manager user with detail information related to the complexity of the formula.

The services presented by the GUI represented in FIG. 5A FIG. 5B, FIG. 5C, FIG. 5D, and FIG. 5E are supported by an under lying data structure depicted in FIG. 9D where entities of File Version, File Importance, and File Status are represented. Specific entities are represented in FIG. 8I where the File Version entity is depicted.

### Inspection Services

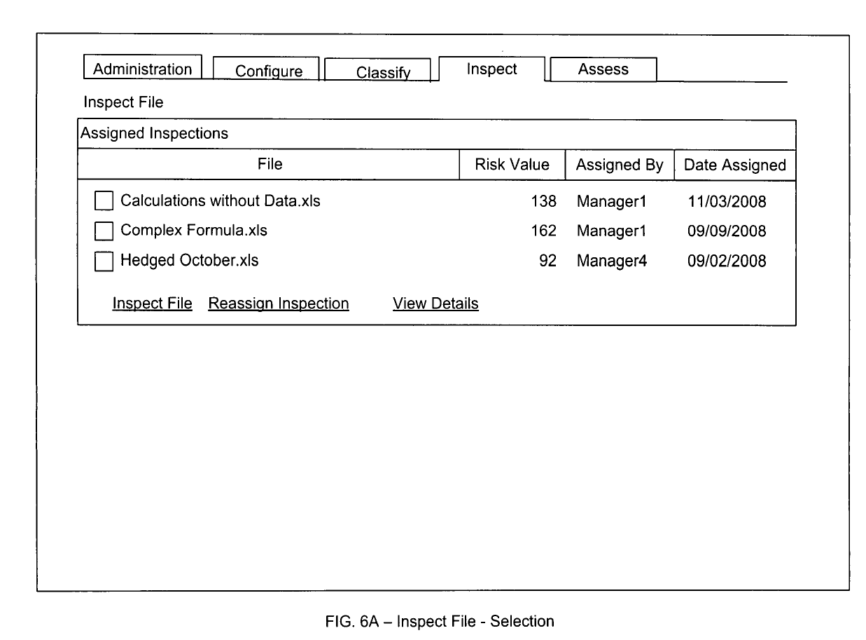

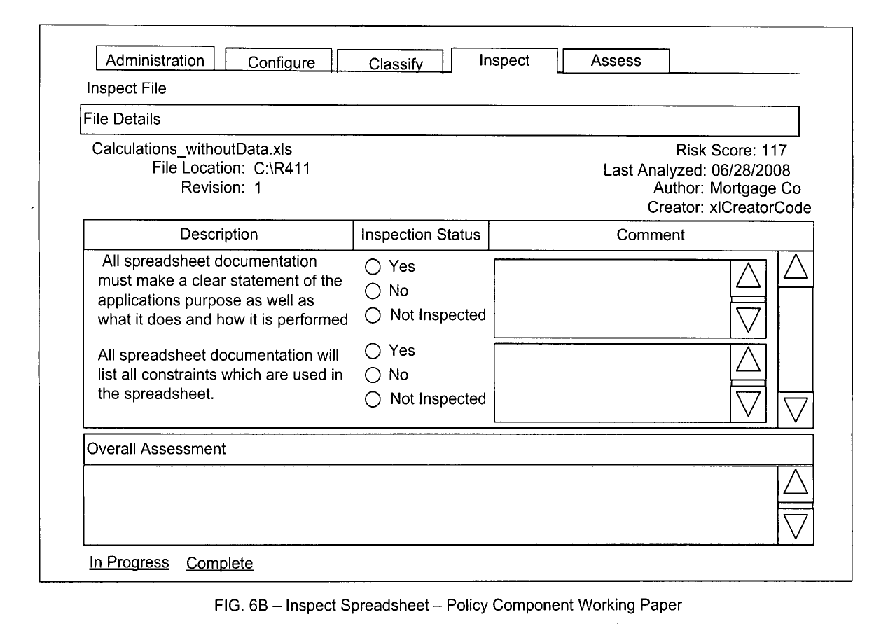

In FIGS. 6A and 6B, there are shown exemplary GUI screens that are served to the Web browsers of users, by the communication servers of the spreadsheet Risk Reconnaissance Network of the present invention. The purpose of these GUIs is to enable users (e.g. Inspectors) to Inspect a Spreadsheet document/file supported on the network, assess compliance with spreadsheet policy, determine accuracy of business logic, make notes, and provide an overall assessment which will be made available to the Business Manager user for the spreadsheet file, as well as the Risk Officer.

As shown, the GUI of FIG. 6A supports services that enable Inspector Users to do the following: (i) review the specifics on each spreadsheet file assigned to the Inspector; (ii) initiate an inspection of a file; (iii) reassign an inspection to another Inspector; or (iv) view the details of the file.

The Reviewing the specifics on each spreadsheet file service (i), will present the Inspector the spreadsheet files which they are responsible for inspecting, as well as specific details including the current Risk Score of the spreadsheet file, the person who assigned the spreadsheet file for review, and the date the file was assigned.

The Inspector is provided the service to initiate an inspection of a spreadsheet file (ii) as further described in FIG. 6B.

The Reassignment of an inspection service (iii) is made available to the Inspector to allow for the Inspector user to have the inspection performed by a user who is better qualified, or have greater availability to perform the inspection.

The service to view the details of the file (iv) is made available to the Inspector to allow for the inspector to gain an understanding of the metadata within the file before performing the inspection.

As shown, the GUI of FIG. 6B shows the electronic working document for the Inspector user. Upon entry to this screen the Inspector will be presented with information related to the spreadsheet file, its location, author, creator, and date and time the spreadsheet file was analyzed. The GUI shown in FIG. 6B further presents the Inspector with each of the areas within the spreadsheet policy which can only be assessed by human judgment. For each spreadsheet policy component which has been Configured in the Spreadsheet Policy Configuration, the Inspector has the opportunity to provide their assessment results as either having passed or not, as well as comments which support their assessment. If all policy components pass the assessment of the Inspector, the spreadsheet is considered to have passed the automated part of the spreadsheet policy compliance.

The final section of the GUI presented in FIG. 6B is an area where the Inspector can provide general comments related to the inspection. This will provide the Inspector user the ability to record all information related to the inspection whether performed for policy compliance, formula accuracy, or other objectives of the person requesting the inspection.

The services presented by the GUI represented in FIG. 6A and FIG. 6B are supported by an under lying data structure depicted in FIG. 9E where entities of File Version, File Inspection, Policy, Policy Rule, Policy Group, Policy Inspection, Policy Rule Inspection, Policy Inspection Status, and Policy Status are represented.

### Assess Services

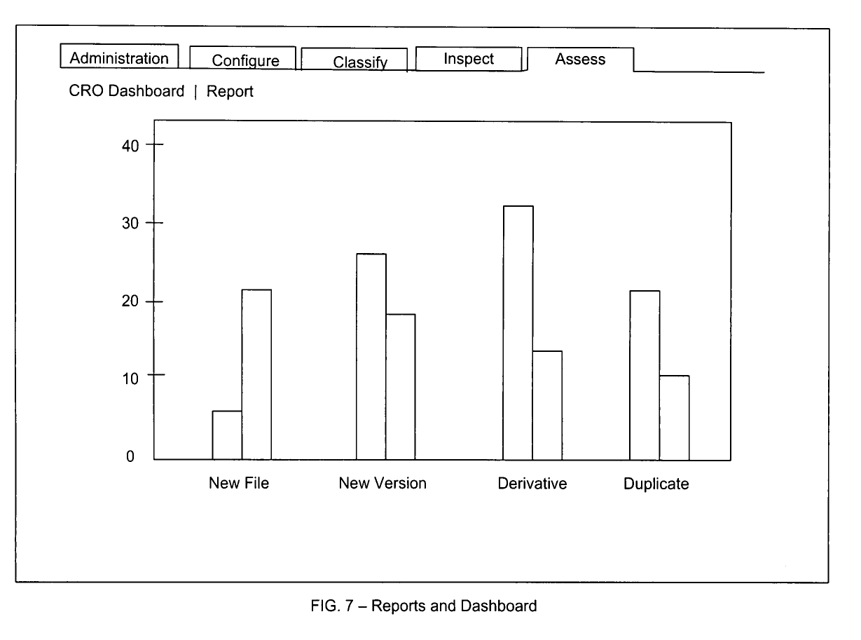

In FIG. 7, there is shown an exemplary GUI screen which is served to the Web browsers of users, by the communication servers of the spreadsheet Risk Reconnaissance Network of the present invention, so as to enable users (e.g. Risk Officer) to Assess a Spreadsheet document/file supported on the network. As shown, the GUI of FIG. 7 supports services that enable users to do the following: (i) determine the risk profile within the organization; (ii) the spreadsheet files which have been inspected and the date of last inspection; (iii) time series of the organizational risk by department.

The services presented by the GUI represented in FIG. 7 are supported by an under lying data structure depicted in FIG. 9F where entities of File, File Type, File Version, File Inspection, Worksheet Data, Worksheet Purpose, Unique Formula, File Importance, File Usage, File Status, Policy, Policy Rule, Policy Inspection, Policy Inspection Status, and Policy Status are represented. Of particular note are detail entities representing by FIG. 8G for Worksheet Data and FIG. 8H representing Unique Formula Count.

### Specification of Database Model Supporting Services Delivered Over the Illustrative Embodiment of the Spreadsheet Risk Reconnaissance Network of the Present Invention

FIG. 8 is a schematic representation of the primary tables provided in the relational database supporting the enterprise-level services within the spreadsheet risk reconnaissance network of the present invention, namely, Users, Organization, Department, Policy, Policy Group, Policy Rule, Worksheet Data, Unique Formula, File, File Version, File Type, File Inspection, File Server, Research Agent, Directory Configuration and Risk Server.

As shown in FIG. 8A, the primary fields in the User table include: Username; First Name; Last Name; Email; Business Phone; Mobile Phone; Address; City; State; Country; Active User; and Data Stamp.

As shown in FIG. 8B, the primary fields in the Organization table include: Organization ID; Organization Name; and Data Stamp.

As shown in FIG. 8C, the primary fields in the Department table include: Department ID; Department Name; and Date Stamp.

As shown in FIG. 8D, the primary fields in the Policy table include: Policy ID; Policy Name; Risk Analysis Threshold; Start Date; End Date; and Date Stamp.

As shown in FIG. 8E, the primary fields in the Policy Group table include: Policy Group ID; Group Name; Node; Parent Node; Depth; Lineage; and Date Stamp.

As shown in FIG. 8F the primary fields in the Policy Rule table include: Policy Rule ID; Policy Rule Name; Policy Rule; Policy Rule Name; Checkbox; Note; Automated; Active; and Date Stamp.

As shown in FIG. 8G, the primary fields in the Worksheet Data Table include: Worksheet Data ID; Worksheet Name; Rows; Columns; Circular Reference; Formula Count; Simple Formula Count; Complex Formula Count; Value Count; Chart Count; and Date Stamp.

As shown in FIG. 8H, the primary fields in the Unique Formula Count Table include: Unique Formula ID; Formula Text; Formula Depth; Operand Count; Function Count; Argument Count; Operator Infix Count; Operator Postfix Count; Operator Prefix Count; and Date Stamp.

As shown in FIG. 8I, the primary fields in the File Version Table include: File Version ID; Modified Date; Path; File Size; Check sum; Password; Encrypted; Version Date; Risk Analysis Value; Risk Analysis Date; Workbook Author; Revision Number; Worksheet Count; Scan Total Time; Cells Scanned; Values Scanned; Formula Scanned; Errors Detected; Activity Assigned To; Activity Assigned By; Confidential; Update User ID; and Date Stamp.

As shown in FIG. 8J, the primary fields in the File Server Table include: File Server ID; Hostname; Host IP; and Date Stamp.

As shown in FIG. 8K, the primary fields in the Research Agent Table include: Research Agent; Research Agent Name; Scan All Configuration Dir; Password; and Date Stamp.

As shown in FIG. 8L, the primary fields in the Directory Configuration Table include: Directory ID; Path; and Date Stamp.

As shown in FIG. 8M, the primary fields in the Risk Server Table include; Risk Server ID; Instance Name; Instance Hostname; Agent Access Key; Escalate Classification; Escalate Inspection; Escalate Policy; and Date Stamp.

FIG. 9 is an entity-relational diagram (ERD) for the spreadsheet risk reconnaissance network of the present invention, showing relationships between entities (i.e. objects) represented within the relational database of FIG. 8.

FIG. 9A is the entity-relational diagram of FIG. 9, highlighting the primary objects (i.e. entities) used when implementing the Collect Metadata service supported by the Research Agents on the within the spreadsheet risk reconnaissance network of the present invention.

FIG. 9B1 is an entity-relational diagram of FIG. 9, highlighting the primary objects (i.e. entities) used when implementing the Administer Research Agents service supported within the spreadsheet risk reconnaissance network of the present invention.

FIG. 9B2 is an entity-relational diagram of FIG. 9, highlighting the primary objects (i.e. entities) used when implementing the Administer Organization and Users services supported within the spreadsheet risk reconnaissance network of the present invention.

FIG. 9C is an entity-relational diagram of FIG. 9, highlighting the primary objects (i.e. entities) used when implementing the Configure Department, Folder and Policy services supported on the within the spreadsheet risk reconnaissance network of the present invention.

FIG. 9D is an entity-relational diagram of FIG. 9, highlighting the primary objects (i.e. entities) used when implementing the Classify (Spreadsheet File) services supported on the within the spreadsheet risk reconnaissance network of the present invention.

FIG. 9E is an entity-relational diagram of FIG. 9, highlighting the primary objects (i.e. entities) used when implementing the Inspect (Spreadsheet File) services supported on the within the spreadsheet risk reconnaissance network of the present invention.

FIG. 9F is an entity-relational diagram of FIG. 9, highlighting the primary objects (i.e. entities) used when producing Risk-Oriented Reports relating to Spreadsheet Files and Policies supported on the within the spreadsheet risk reconnaissance network of the present invention.

### Specification of the Time Sequence of Services Supported by the Spreadsheet Risk Reconnaissance Network of the Present Invention

FIG. 10 shows a time sequence for the various services provided to the different types of users on the risk reconnaissance network of the present invention. As shown, there are three time sequences, namely: the Installation Phase T0; the Initial Setup Phase T1; and the Network Operations Phase T2. Each of these phases will be described in greater detail herein below.

### The Installation Phase T0:

At time sequence T0, and further detailed in FIG. 10B, the organization is at a steady state with no elements of the Risk Reconnaissance Network involved in the operations. At this time the computers where the active production spreadsheets exist are identified, The Research Agents are installed on these computers, the Risk Reconnaissance Network is Configured to for the specific organization, the Risk Reconnaissance Network is Configured for the users who will be using this system and the permissions they should have, the Risk Reconnaissance Network will be Configured to identify the directories used by each department within the organization, and the Spreadsheet Policy for the organization is defined.

### The Initial Setup Phase T1:

At time sequence T1, the Research Agents will scan all folders on all computers that have been Configured at T₀. Relevant parameter settings will be computers and folders that are to be monitored. The Research Agents will find all documents that meet the criteria specified at T₀. Relevant parameter settings here will be the types of files that are to be monitored. The results of the first scan of the designated computers will result in a large number of spreadsheet files. During time sequence T1, the identified spreadsheet files will be classified as to each spreadsheets status, impact, and confidentiality. The result of this classification will be the spreadsheet files which are active in production business processes and should be monitored, the folders which should be monitored for new spreadsheets, as well as a classification of all identified spreadsheet files as to if and how each of the spreadsheet files should be monitored.

### Network Operations Phase T2:

At time sequence T2, the Risk Reconnaissance Network is considered operational and operating in a steady state and will provide monitoring services on a periodic continuous basis. When in steady state, there are several services that operate independently and asynchronously. These services are described as follows:

On a periodic basis, Configured at time sequence T0, the Research Agents will monitor the Configured folders for spreadsheet files which have had their logic modified. The Research Agents will not consider spreadsheet files that have only had values changed (no change to spreadsheet file formulas) as having any change in risk and will not be brought to the attention of the Manager. Conversely, all risk related events that have been identified will be brought to the attention of the Manager giving early warning of the event.

Managers will classify spreadsheet files and provide the business attributes of status, impact, and confidentiality. For new files the attributes will default to blank. For files which have been seen by the Risk Reconnaissance Network, or derived from the files which have been seen prior, the default attributes will be those attributes inherited from the original spreadsheet file.

The Managers will assign specific spreadsheet files to Inspectors for further review. After assignment, the Managers will also monitor the inspections to ensure their inspection needs are being met.

Inspectors will review the spreadsheets assigned to them. Upon completion of each inspection, a report will be automatically sent to the Manager requesting the inspection.

The CRO will monitor the overall risk within the organization, as well as the how this risk is being managed and the actions that are taking place to mitigate this risk.

### Overview Specification of Processes Supported by the Spreadsheet Risk Reconnaissance Network of the Present Invention

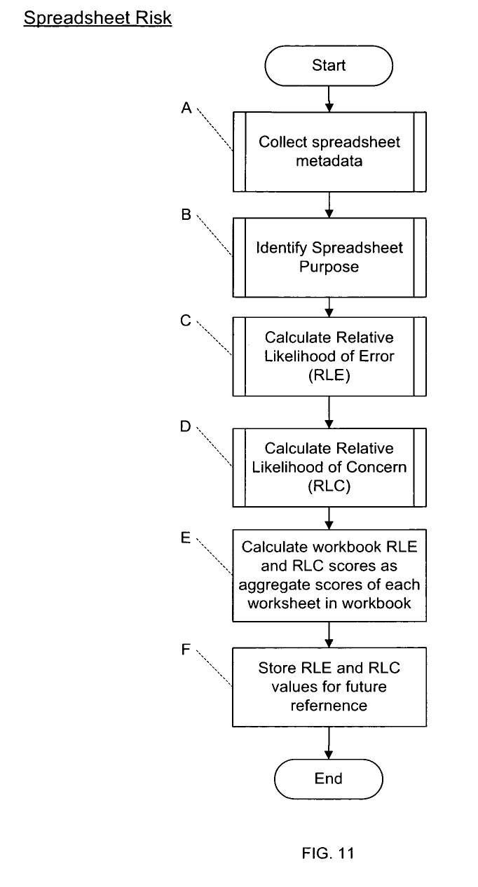

Referring now to FIG. 11, the spreadsheet risk calculation process will be described in an overview manner, indicating where particular operations are performed in the illustrative embodiment of the present invention.

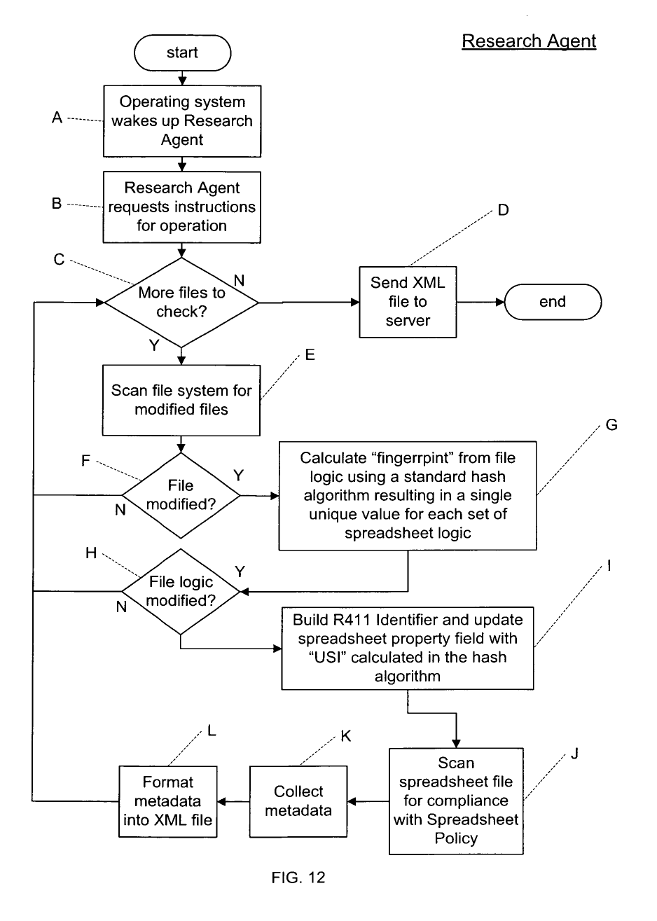

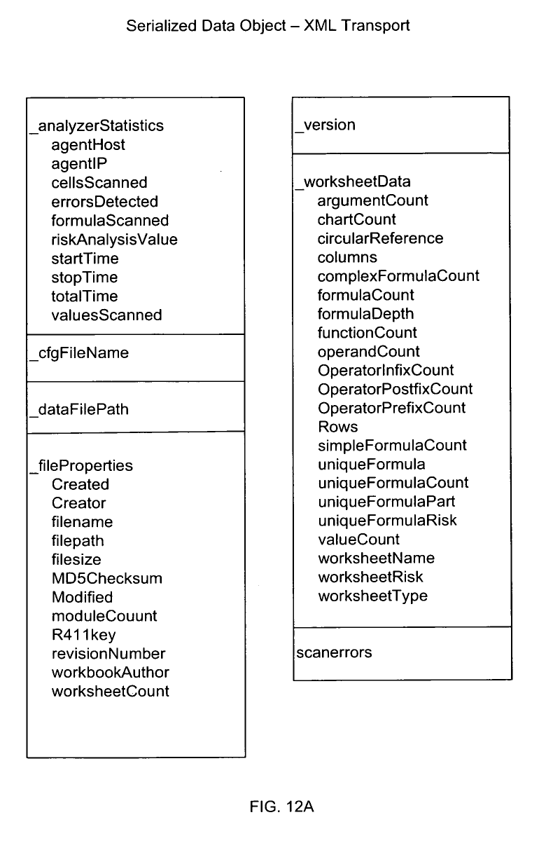

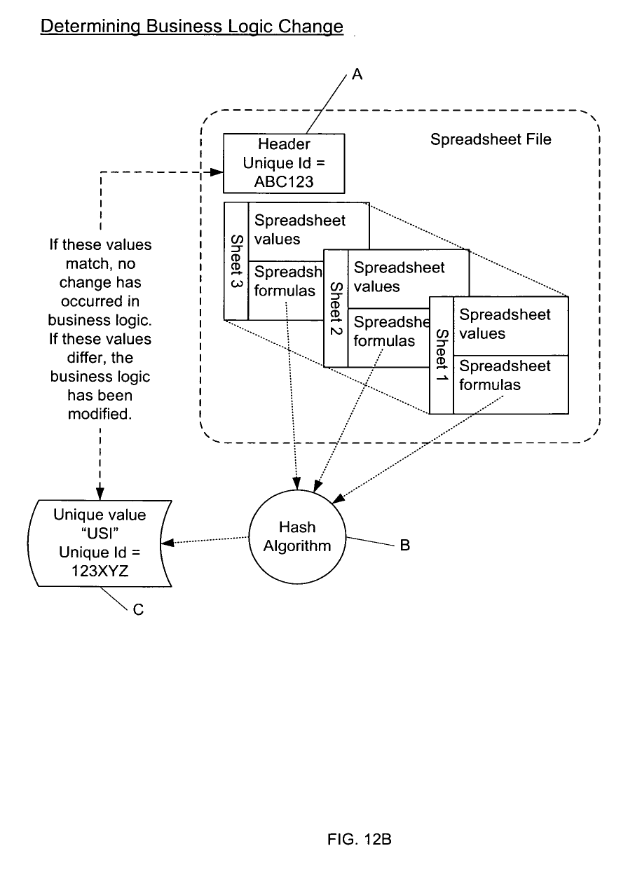

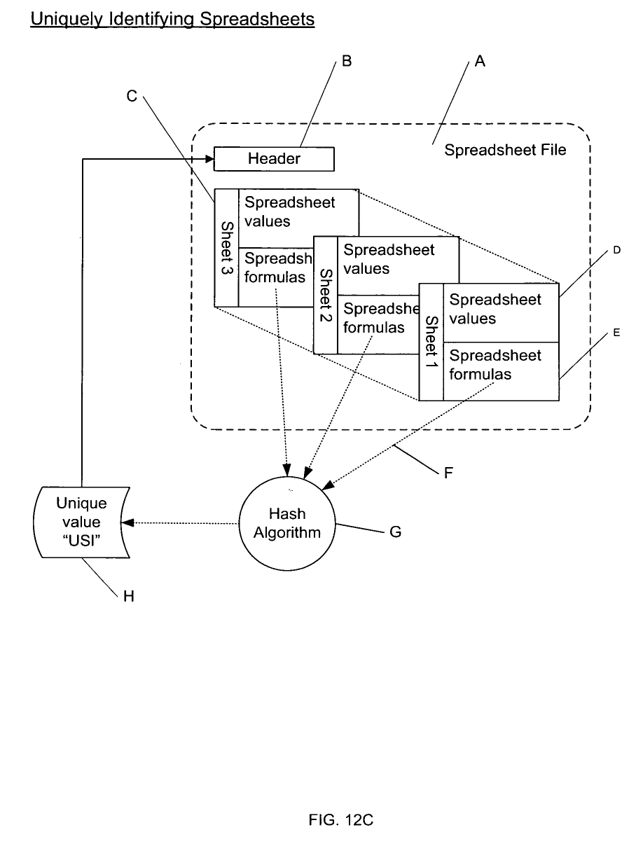

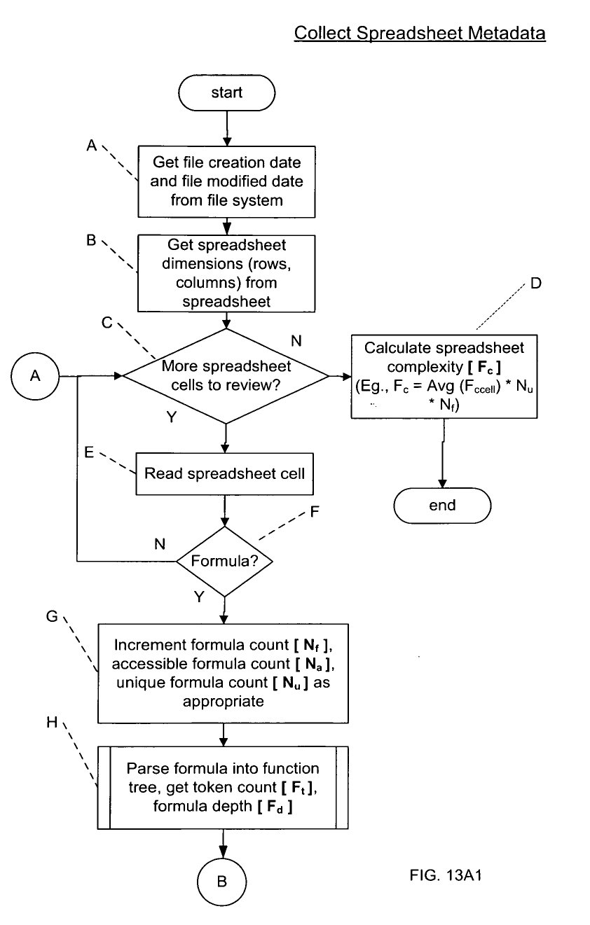

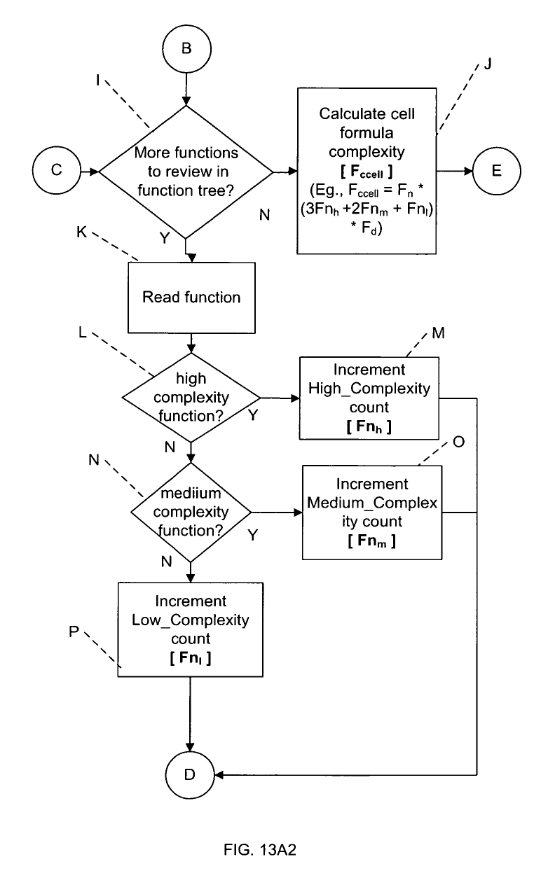

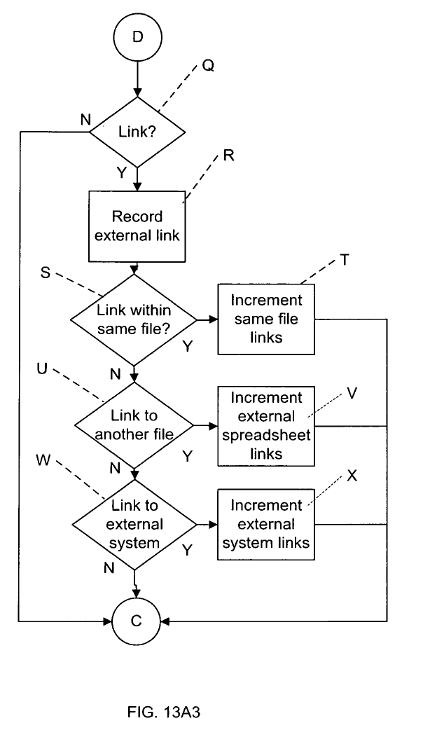

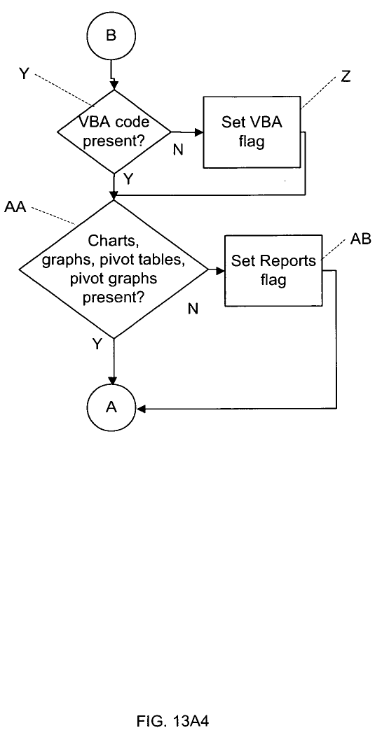

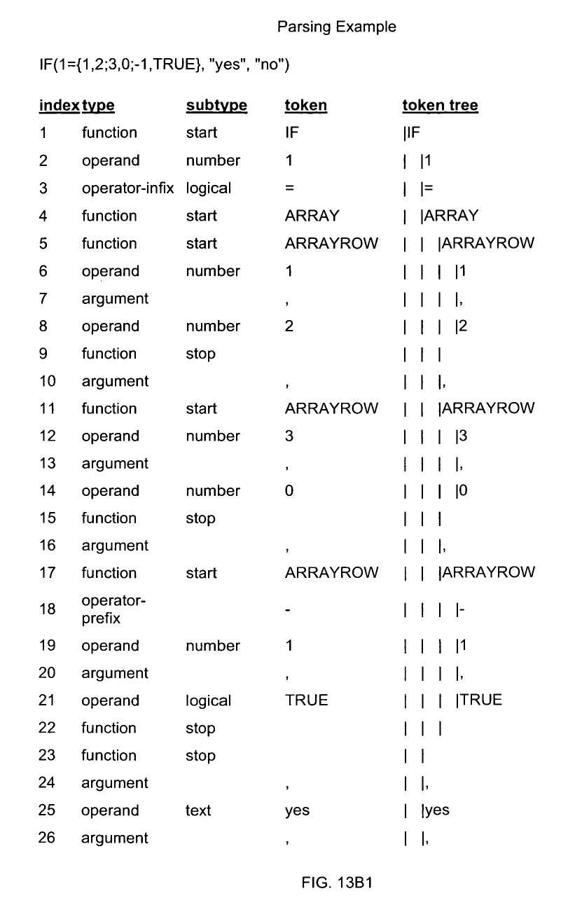

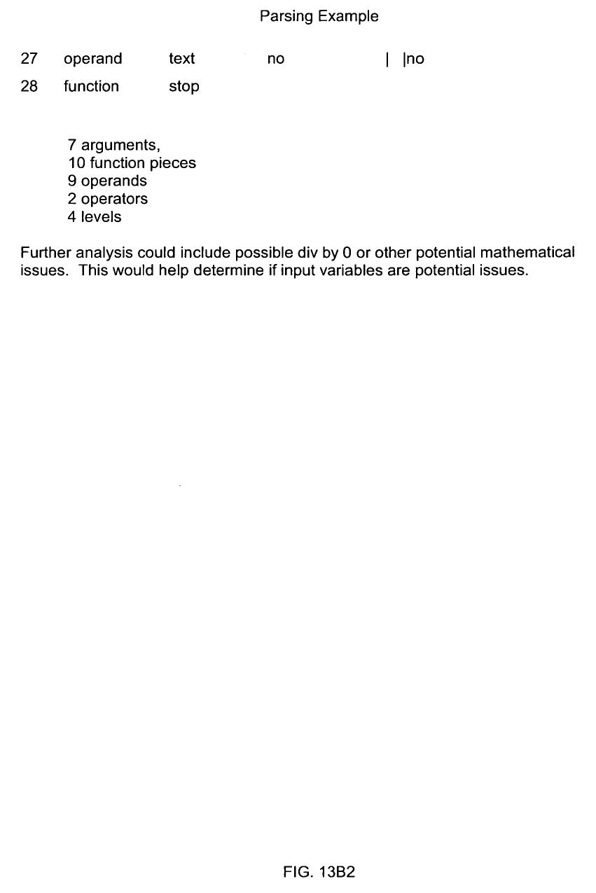

As indicated at Block A in FIG. 11, automated spreadsheet metadata collection operations are performed by the Research Agents on registered file servers within the network. This spreadsheet metadata is then transparently transmitted back to the application servers at the Data Center, using an XML file format in the illustrative embodiment, as illustrated in FIG. 12A.

As indicated at Block B in FIG. 11, the Calculation Engine located on the application servers at the Data Center, performs automated Spreadsheet Purpose Identification operations, as described herein above.

As indicated at Block C in FIG. 11, the Calculation Engine performs the Relative Likelihood of Error (RLE) Calculations as described hereinabove.

As indicated at Block D in FIG. 11, the Calculation Engine performs the Relative Likelihood of Concern (RLC) calculations as described hereinabove.

As indicated at Block E, the Calculation Engine calculates the workbook RLE and the RLC scores as aggregate scores of each worksheet in the workbook.

As indicated at Block F in FIG. 11, the Calculation Engine stores the RLE and RLC values for future reference.

Detailed Specification of Processes Supported by the Spreadsheet Risk Reconnaissance Network of the Present Invention which have No User Interface

### Research Agent

As indicated hereinabove, the Risk Reconnaissance Network of the present invention deploys Research Agents (e.g. executable software modules) on computer file servers containing spreadsheet files that are used in active business processes. Research Agents monitor specified folders (i.e. Directories) on the file serving system, for changes in the programmatic business logic of the spreadsheet files. When particular changes are identified by the Research Agent, specific metadata is automatically collected and sent to the Risk Reconnaissance application server maintained at the Central Data Center shown in FIG. 1 and FIG. 2. In practice, there may be any number (greater than zero) of Research Agents deployed within an Organization. The number of Research Agents to be deployed will typically depend on the volatility of the spreadsheet files within the Organization, the number of spreadsheets locations, and the efficiency of the hardware which is hosting the spreadsheet files. The greater the number of Research Agents deployed, the less time it will take to perform the monitoring function over the Organization's network.

The more detailed operations carried out by each Research Agent of the present invention during spreadsheet metadata collection, are described in greater detail in the flow chart of FIG. 12. Overall, the Research Agent performs the following functions: (i) starts on a periodic basis as defined by system parameters; (ii) obtains instructions as to which services should be performed; (iii) identifies all spreadsheet files which have been modified since the last time the changes were acknowledged by the Business Manager; (iv) determines if changes have been made to the spreadsheet file values, or to the business logic; (v) attaches a non-intrusive identifier to the spreadsheet file to allow for tracking across the file system; (vi) reviews the spreadsheet file for compliance with the aspects of the Spreadsheet Policy which are to be assessed in an automated fashion; (vii) packages metadata related to the spreadsheet file in a manner suitable for transmission; and (viii) transmits the metadata file to the Risk Reconnaissance database server for storage and subsequent processing.

As indicated at Block A of FIG. 12, the operating system of the file server on which the Research Agent is installed, automatically wakes up the Research Agent. At time of installation and Configuration of each Research Agent, the Research Agent is configured to start on a periodic basis. This Configuration information is provided to the scheduling service of the operating system of the file server on which the Research Agent is installed. From this point forward, when the scheduled time occurs, the operating system will start and run the designated Research Agent. This approach ensures that the Research Agent will perform automatically and in the background without manual intervention. It will also allow for scheduling at points in time when the computers which are hosting the Research Agents are operating at low work levels.

As indicated at Block B in FIG. 12, upon initiation, the Research Agent will request from the Risk Reconnaissance Network, the instructions regarding the services it is to perform. The Administrator user will set the instructions to be performed the next time the Research Agent is scheduled to run. Examples of instructions include: (i) the Research Agent monitoring specific Folders or Directories; and the Research Agent being be concerned with particular types of files within particular Directories. This instruction service enables the behavior of the Research Agent to be highly modifiable and perform a variety of actions based on the discretion of the Administrator User.

At Block C, the Research Agent determines whether or not there are more files in the directories assigned to the research agent thats are to be examined.

If there are more files on the server to check for modification, then at Block E the Research Agent scans the file system for modified spreadsheet files.

As indicated at Block F in FIG. 12, the Research Agent determines whether or not spreadsheet files in which logic changes or modifications have been made since the file was last examined.

If a given spreadsheet file under reconnaissance is not modified, then the Research Agent advances to Block C. If a given spreadsheet file has been modified, then the Research Agent advances to Block G.

At Block G In FIG. 12, The Research Agent Then Calculates A Unique spreadsheet identifier (USI) of each spreadsheet file from the file logic employed in the spreadsheet. In the illustrative embodiment, this USI is calculated using a standard hash algorithm resulting in a single unique value for each set of spreadsheet logic. The Research Agent builds a non-intrusive identifier based on the business logic identifier. Once all business logic is represented by this single identifier, this identifier is updated in a non-intrusive manner on the spreadsheet file by assigning it to the user defined Properties field which is part of the spreadsheet file. By attaching the identifier to the spreadsheet file, the Risk Reconnaissance Network is able to track the spreadsheet as it changes from one version to another. As important, this will also allow for the tracking of spreadsheets as they are copied, moved, email, or otherwise transmitted from on folder or file system to another. As spreadsheet files are moved from a controlled environment, to another environment which is known to the Risk Reconnaissance Network but possibly uncontrolled, the spreadsheet file will be tracked to this new location. Also, when the spreadsheet re-enters the controlled environment, the Risk Reconnaissance Network will recognize this event and be able to recognize its point of origin.

At Block H in FIG. 12, the Research Agent determines whether or not the file logic in the modified spreadsheets has been modified. If a given spreadsheet file under reconnaissance has not had its programmed file logic modified, then the Research Agent advances to Block C. If a given spreadsheet file has had its file logic modified, then the Research Agent advances to Block I.

As indicated in FIG. 12B, through the network's use of the USI assignment and processing method of the present invention, it is possible to determine whether or not the change made to a spreadsheet file was made to the spreadsheet file values, or to the spreadsheet file logic.

Here is how the method works. The network automatically tracks the last date and time any particular Research Agent has run, and the file system within the operating system of each network file server automatically provides the network with information as to the date and time each spreadsheet file was last modified. If the file has been modified since the Research Agent has last examined the spreadsheet, then it will be deemed a candidate for determining whether or not its business logic has changed and whether or not a detected business logic change is such that the network should and associated organization should be concerned.

As indicated in FIG. 12B, the candidate is then examined by using a hash algorithm (indicated as item B) to re-generate the unique spreadsheet identifier (USI) indicated as item C. As illustrated, if this regenerated USI (item C) matches the USI stored in the spreadsheet header (item A), then the process determines that there has not been a change in spreadsheet file logic, but that the change has occurred in the cell values of the spreadsheet. In other words, if the two USI values differ, then it ios determined that changes have occurred in the programmatic business logic.

As indicated at Block I in FIG. 12, the Research Agent then calculates the unique spreadsheet identifier (USI) using a hash algorithm, and then updates the spreadsheet property field with the single USI value.

At Block J in FIG. 12, the Research Agent scans the spreadsheet files for compliance with the Spreadsheet Policy set on the network. The Research Agent performs an examination of the spreadsheet file and makes an assessment as to whether the spreadsheet file is compliant with the aspects of the spreadsheet policy which can be assessed in an automated manner. As the result of performing the Spreadsheet Policy Configuration, a resulting set of assessment requirements are created. These requirements will consist of items which are to be assessed in either a manual or automated fashion. All spreadsheet policy components that can be evaluated in an automated fashion will be assessed by the Research Agent at this point. The value of this service is that the Risk Reconnaissance Network will be able to transparently monitor the active production spreadsheet files for compliance with the defined Spreadsheet Policy and alert the Business Manager when spreadsheet files go out of a state of compliance.

As indicated at Block K, when the Research Agent determines that the spreadsheet file has had its programmatic business logic modified in the relevant time period, the Research Agent will then collect and package metadata related to the spreadsheet file in a manner suitable for transmission.

The Research Agent carries out the spreadsheet metadata collection process, indicated at Step K in FIG. 12, by performing a series indicated in FIGS. 13A1 through 13A4.

After collection of spreadsheet metadata is completed, at Block L the Research Agent then converts and formats the collected metadata into an extended markup language (XML) file. An exemplary Serialized Data Object for the XML Transport step is illustrated in FIGS. 12A and 12B.

Thereafter, as indicated at Block D, the Research Agent will transmit the XML metadata file to the Risk Reconnaissance database server for storage, using the file transfer services inherent in the operating system of the server machine, on which the Research Agent executes. By transmitting the metadata to the Risk Reconnaissance database service, the metadata can be combined with Business Manager user, Inspector user, and CRO user provided information to provide a broader perspective on the risk which is contained within the spreadsheet file.

### Spreadsheet Metadata Collection Process

As indicated at Block A in FIGS. 13A1 and 13A2, the Research Agent gets the file creation date and the file modified date from the file server system on which the Research Agent is installed.

At Block B in FIGS. 13A1 and 13A2, the Research Agent gets the spreadsheet dimensions (e.g. rows, columns) from the spreadsheet on the file server.

At Block C in FIGS. 13A1 and 13A2, the Research Agent determines whether or not there are more spreadsheet cells to review.

If there are no more cells to review in the spreadsheet file, then at Block D in FIGS. 13A1 and 13A2, the Research Agent calculates Spreadsheet Complexity [Fc] and then ends the process. As disclosed, Spreadsheet Complexity can be calculated using, for example the following formula:

F_{c}=Avg[F_{ccell}*Nᵤ*Nᵣ]

wherein the formula count is represented by [Nᵣ], the accessible formula count is represented by [Nₐ], and the unique formula count is represented by [Nᵤ].

However, if the Research Agent determines at Block C that there are still more spreadsheet cells to review in a particular spreadsheet document/file on the file server, then at Block E, the Research Agent reads the spreadsheet cell(s).

At Block F, the Research Agent determines whether or not the spreadsheet contains a formula. If the Research Agent determines a formula is detected at Block F, then the Research Agent returns to Block A and determines whether or not more spreadsheet cells remain for review. If no formulas are detected at Block F, then the Research Agent proceeds to Block G and increments the formula count [Nᵣ], the accessible formula count [Nₐ], and the unique formula count [Nᵤ} as appropriate.

As indicated at Block H in FIGS. 13A1 and 13A2, the Research Agent parses the formula into a function tree, gets the token count [F] and the formula depth [F_{d}], and then determines at Block I whether or not there are more function to review in the function tree. If there are no more functions to review in the function tree, then the Research Agent calculates the cell formula complexity [F_{cell}] using, for example, the following formula:

F_{cell}=Fn*[3Fnₕ+2Fnₘ+Fnₗ)*F_{d}

An illustrative function parsing example is set forth in FIGS. 13B1 and 13B2, wherein the function is IF(1={1,2;3,0;−1, TRUE}, “yes”, “no”) and is parsed into 7 arguments, 10 function pieces, 9 operands, 2 operators and 4 levels.

At Block I, the Research Agent determines whether or not there are more functions on the spreadsheet function tree. If there are no more functions to review in the function tree, then at Block J the Research Agent calculates the cell formula complexity [F_{ccell}], (e.g. F_{ccell}=Fₙ*(3Fnₙ+2Fnₘ+Fnₗ]*F_{d}), and then proceeds to Block Y, where the Research Agent determines whether or not VBA code is present in the spreadsheet file. If there is not VBA code present, then at Block Z, the Research Agent sets the VBA flag at Block AA, and then returns to Block C in FIGS. 13A1 and 13A2 as shown. If there is no VBA code present at Block Y, then at Block AA, the Research Agent determines whether or not there are any charts, graphs, pivot tables and/or pivot graphs present in the spreadsheet file under analysis. If there are such charts, graphs, pivot tables, and/or pivot graphs present, then the Research Agent sets the Report Flag at Block AB in FIGS. 13A3 and 13A4, as shown. If there are no such charts, graphs, pivot tables, and/or pivot graphs present, then the Research Agent returns to Block C in FIGS. 13A1 and 13A2, as shown.

At Block K in FIGS. 13A1 and 13A2, the Research Agent reads the function in the function tree of the spreadsheet file under analysis, and then proceeds to Block L where the Research Agent determines whether or not the function has high complexity. If the function does have high complexity, then the Research Agent proceeds to Block M, increments the high complexity count [Fnₕ] and proceeds to Block Q in FIGS. 13A3 and 13A4. If the function does not have high complexity, then the Research Agent proceeds to Block N and determines whether the formula has a medium complexity. If at Block N, the Research Agent determines that the formula has a medium complexity, then it proceeds to Block O, increments the medium complexity count [Fnₘ], and then proceeds to Block Q in FIGS. 13A3 and 13A4. If at Block N, the Research Agent determines that the formula does not have a medium complexity, then it proceeds to Block P, and automatically increments the low complexity count [Fnₗ], and proceeds to Block Q in FIGS. 13A3 and 13A4.

At Block Q in FIGS. 13A3 and 13A4, the Research Agent determines whether or not there is a link in the spreadsheet file, and if not then proceeds to Block I in FIGS. 13A1 and 13A2. If the Research Agent determines that there is a link in the spreadsheet file, then proceed to Block R and records the external link, and then proceed to Block S.

At Block S in FIGS. 13A3 and 13A4, the Research Agent determines whether or not the link references to an object within the same spreadsheet file. If the link resides within the same spreadsheet file, then the Research Agent increments the same file links count at Block T, and proceeds to Block I in FIGS. 13A1 and 13A2. If the Research Agent determines that the link does not make reference within the same spreadsheet file, then it proceeds to Block U to determine whether or not the detected link is referenced to another (different) spreadsheet file. If the link refers to another different spreadsheet file, then the Research Agent increments the external spreadsheet links count at Block V, and proceeds to Block I in FIGS. 13A1 and 13A2. If the Research Agent determines that the link does not link to another different spreadsheet file, then it proceeds to Block W to determine whether or not the detected link is referenced to an external system. If the Research Agent determines that the link references (links) to an external system, then it proceeds to Block X, increments the external system links and proceeds to Block I in FIGS. 13A1 and 13A2. However, if the Research Agent determines at Block W that the link does not link to an external system, then the Research Agent proceeds to Block I in FIGS. 13A1 and 13A2, as shown.

Detailed Specification of Processes Supported by the Risk Calculation and Notification Engine Deployed within the Central Reconnaissance Data Center of the Spreadsheet Risk Reconnaissance Network of the Present Invention

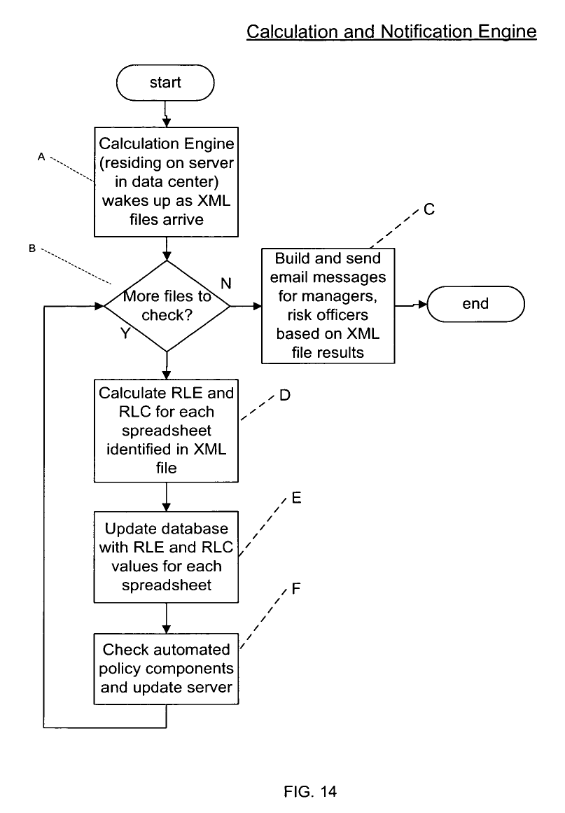

FIG. 14 shows a high-level flow chart describing the primary steps carried out in the Risk Calculation and Notification Engine within the Central Reconnaissance Data Center, during the automated calculation of RLE and RLC for spreadsheet documents being monitored within the spreadsheet risk reconnaissance network of the present invention.

As indicated at Block A in FIG. 14, the Calculation Engine (residing on the Application Server in the Data Center) wakes up as an XML files arrive at the Data Center.

As indicated at Block B, the Calculation Engine determines whether or not there are more XML files (representing spreadsheet files under reconnaissance) to check or analyze. If not, then the Calculation Engine proceeds to Block C and builds and sends email messages based on XML file results, to spreadsheet managers and risk officers to notify them of suspect risk conditions within spreadsheet documents in their Organization, and thereafter terminates the process. If, at Block B, the Calculation Engine determines that there are still more XML files to check, then at Block D the Calculation Engine calculates the RLE and RLC for each spreadsheet identified in the XML file.

At Block E, the Calculation Engine updates the application database with the RLE and RLC values calculated for each spreadsheet (corresponding to the XML files).

Then at Block F, the Calculation Engine checks the automated policy components and updates the application database server, and then returns to Block B to determine whether or not there are more XML files to check.

### Identification of Spreadsheet Purpose (Type) by the Risk Calculation and Notification Engine of the Present Invention

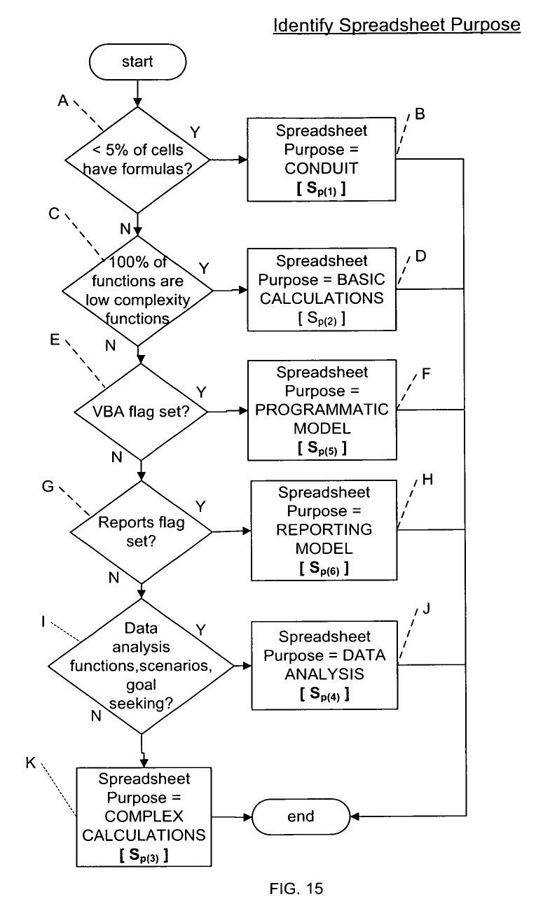

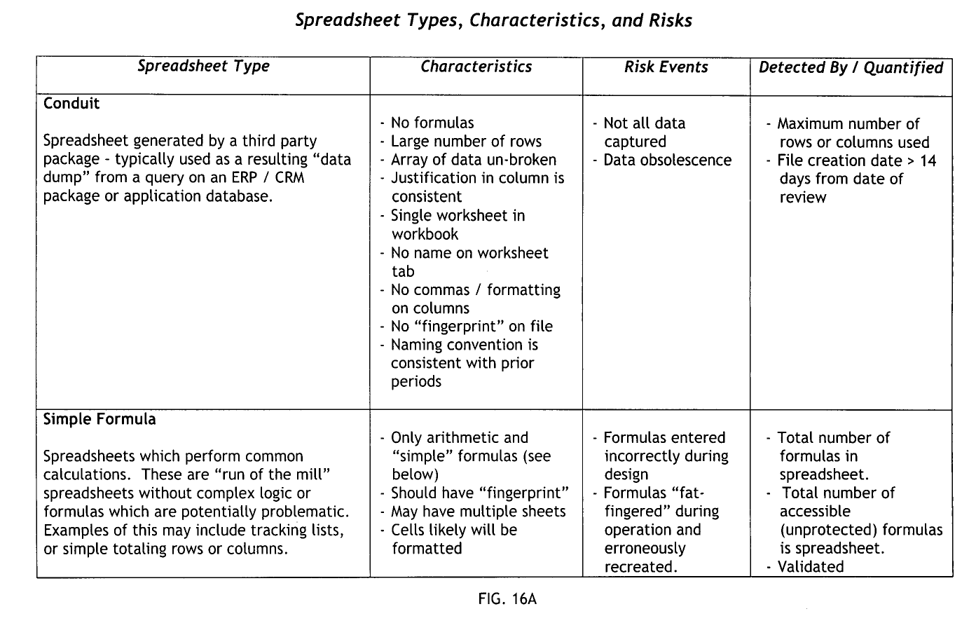

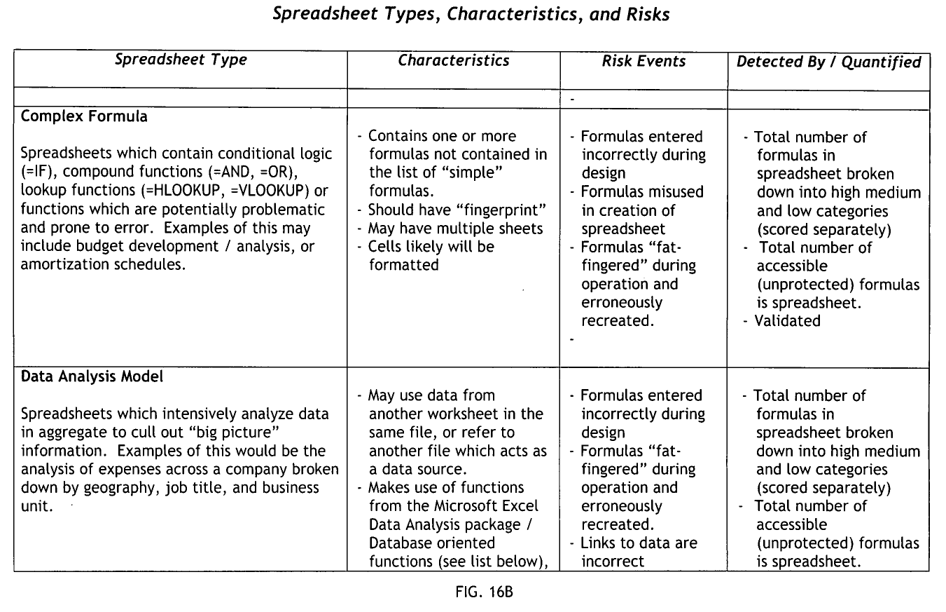

FIG. 15 describes an illustrative embodiment of a process for identifying Spreadsheet Purpose employed at Block B in FIG. 11. At this stage of the process, the Risk Calculation and Notification Engine automatically identifies Spreadsheet Purpose (Type) for all spreadsheet documents being monitored within the spreadsheet risk reconnaissance network of the present invention. This algorithm will be specified in greater detail below.

As indicated at Block A, the Calculation Engine determines whether or not less than about 5% of the cells in a spreadsheet file (determined by analyzing its collected XML file) have formulas. If less than 5% of the cells in the analyzed spreadsheet file (i.e. XML file) have formulas, then the Calculation Engine determines that (i.e. identifies) the Spreadsheet Purpose=CONDUIT with an index notation of [Sₚ₍₁₎], and then terminates the process, as shown. However, if more than 5% of the cells in the analyzed spreadsheet file (i.e. XML file) have formulas, then at Block C the Calculation Engine determines whether or not 100% of the functions in the spreadsheet are low complexity functions.

If at Block C the Calculation Engine determines that all of the functions in the spreadsheet are low complexity functions, then at Block D the Calculation Engine determines that the Spreadsheet Purpose=BASIC CALCULATIONS with an index notation of [Sₚ₍₂₎]. However, if the Calculation Engine determines that there are functions in the spreadsheet that are not low complexity functions, then the Calculation Engine determines at Block E whether or not the VBA flag has been set. If the VBA flag has been set, then the Calculation Engine proceeds to Block F and determines that the Spreadsheet Purpose=PROGRAMMATIC MODEL with an index notation of [Sₚ₍₅₎]. However if the VBA flag has not been set, then the Calculation Engine proceeds to Block G and determines whether or not the Reports Flag has been set. If the Reports Flag has been set, then the Calculation Engine determines that the Spreadsheet Purpose=REPORTING MODEL with an index notation of [Sₚ₍₆₎]. If the Reports Flag has not been set, then the Calculation Engine proceeds to Block K and identifies the Spreadsheet Purpose as COMPLEX CALCULATIONS with an index notation of [Sₚ₍₃₎], and then terminates the process.

Formulas considered to be “simple” or not problematic: =SUM, =AVERAGE, =MIN, =MAX, =TODAY.

Formulas categories (and all functions within these categories) having the relative potential for error:

Categories with high potential for error: Financial, Math & Trig, Statistical, Engineering;

Categories with medium potential for error: Lookup & Reference, Database; and

Categories with low potential for error: Date & Time, Text, Informational;

Formulas from within the MS Excel Database category: =DAVERAGE, =DCOUNT, =DCOUNTA, =DGET, =DMAX, =DMIN, =DPRODUCT, =DSTDEV, =DSTDEVP, =DSUN, =DVAR, =DVARP

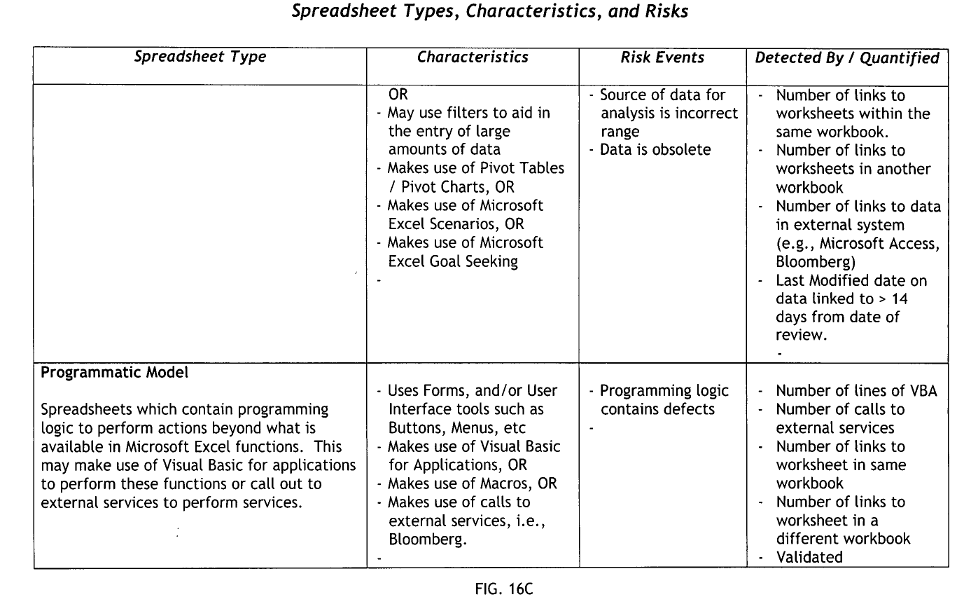

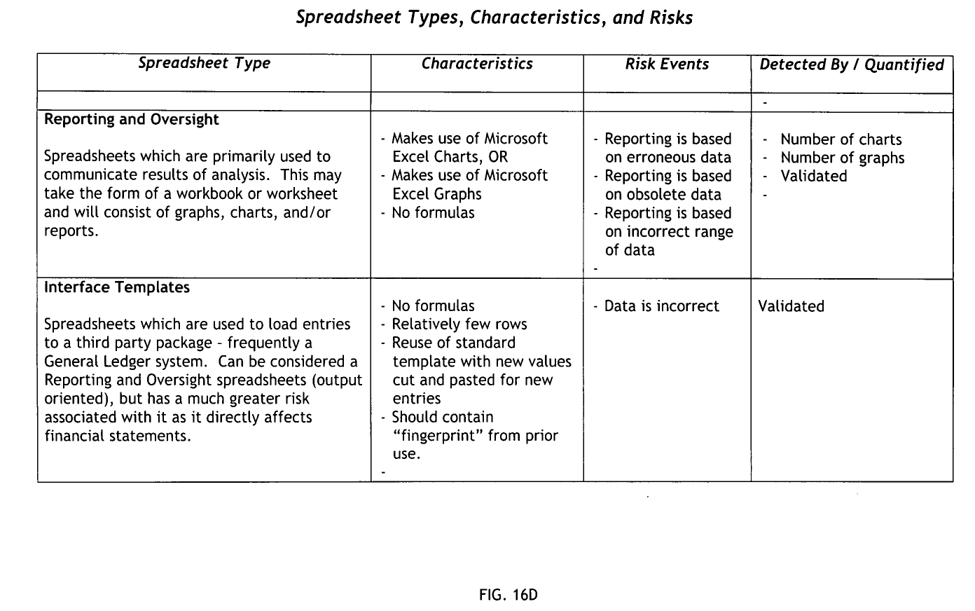

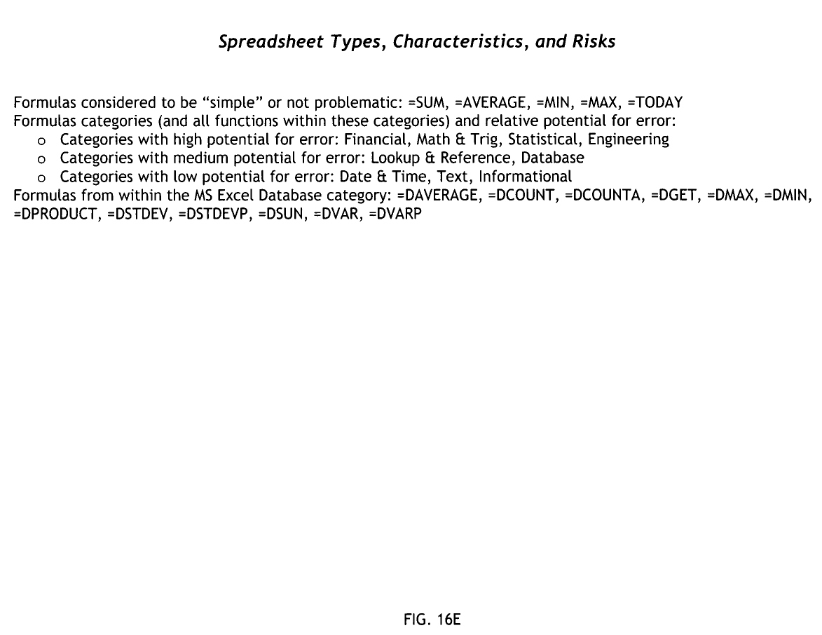

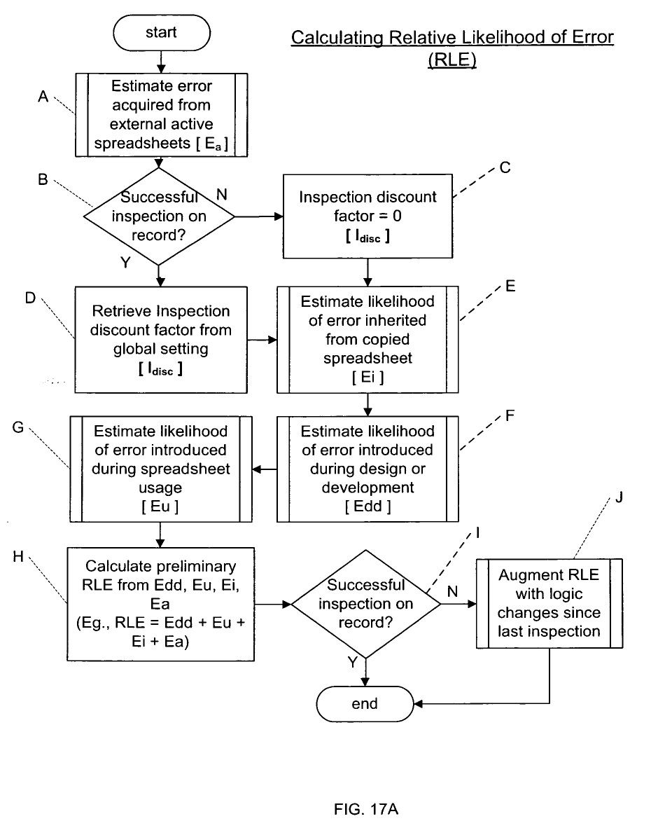

FIGS. 16A through 16E, taken together, show a table describing the types of Spreadsheet Purpose supported by the illustrative embodiment of the spreadsheet risk reconnaissance network of the present invention.

### Calculation of Relative Likelihood of Error (RLE) by the Risk Calculation and Notification Engine of the Present Invention

FIGS. 17A through 17D, taken together, show a high-level flow chart describing the primary steps carried out when the Risk Calculation and Notification Engine within the Central Reconnaissance Data Center, calculates the Relative Likelihood of Error (RLE) for spreadsheet documents being monitored within the spreadsheet risk reconnaissance network of the present invention.

As indicated at Block A in FIG. 17A, the Calculation Engine estimates the error acquired from external active spreadsheets [Eₐ].

As indicated at Block B, the Calculation Engine determines whether or not there is a successful inspection on record. If there is a successful inspection on record, then the Calculation Engine proceeds to Block D and retrieves the Inspection Discount Factor [I_{disc}] from the global setting. And thereafter, the Engine estimates the likelihood of error inherited from the copied spreadsheet [Eᵢ].

If at Block B the Calculation Engine determines that there is no successful inspection on record, then the Engine sets the Inspection Discount Factor [I_{disc}]=0, and then advances to Block E, as shown.

At Block E, the Engine estimates the likelihood of error inherited from the copied spreadsheet [Eᵢ]

At Block F, the Engine estimates the likelihood of error introduced during design or development [E_{dd}].

At Block G, the Engine estimates the likelihood of error introduced during spreadsheet usage [Eᵤ].

At Block H, the Engine calculates the preliminary RLE from the E_{dd}, Eᵤ, Eᵢ and Eₐ (e.g. RLE=E_{dd}+Eᵤ+Eᵢ+Eₐ).

At Block I in FIG. 17A, the Engine determines whether or not there is a successful inspection on record, and if not, terminates the process. If the Engine determines there is a successful inspection on record, then it augments the RLE with detected logic changes that have been detected since the last spreadsheet inspection. Thereafter, the Engine terminates the process.

In FIGS. 17B, 17C, 17D and 17E, methods are described for computing the four error estimate components E_{dd}, Eᵤ, Eᵢ and Eₐ for the calculation of RLE. Each of these methods will now be described in detail below.

### Method of Estimating Likelihood of Error Acquired in or by the Linkage to Another Active Spreadsheet

As indicated at Block A in FIG. 17B1, the Calculation Engine determines whether or not there are more external links to review, and if not, then the Engine terminates the process. However, if there are more external links to review, then the Engine proceeds to Block B and gets the RLE score of externally linked spreadsheets. Then, at Block C in FIG. 17B1, the Engine adds the acquired/collected RE score to the likelihood of error introduced or acquired from external active spreadsheets [Eₐ], and then returns to Block A, as shown.

Method of Estimating Likelihood of Error Inherited from or by Copying from Another Spreadsheet

As indicated at Block A in FIG. 17B2, the Calculation Engine identifies (i.e. determines) the source of the Spreadsheet (i.e. spreadsheet lineage) Sₗ.

At Block B, the Calculation Engine gets the RLE score of the copied spreadsheet.

At Block C, the Calculation Engine assigns the RLE score of the copied spreadsheet to Eᵢ so as to arrive at the estimated likelihood of error inherited when copying from another spreadsheet, and then terminates the process.

### Method of Estimating Likelihood of Error Introduced During the Design or Development of a Spreadsheet

As indicated at Block A in FIG. 17C1, the Calculation Engine identifies the Spreadsheet Purpose factors for N_{f}, Nᵤ, and F_{c} selected from the table [F_{nf(sp(x))}, F_{nu(Sp(x))}, F_{fc(Sp(x))}].

At Block B, the Calculation Engine multiplies N_{f}, Nᵤ, and F_{c} by their corresponding Spreadsheet Purpose factors.

At Block C, the Calculation Engine calculates E_{dd} from N_{f}, Nᵤ, and F_{c} using, for example, the formula: E_{dd}=((0.25N_{f}+Nᵤ)*F_{c}).

At Block D, the Calculation Engine multiples E_{dd} by the inspection factor discount [I_{dis}], to arrive at the estimated likelihood of error introduced during spreadsheet design or development E_{dd}.

### Method of Estimating Likelihood of Error Introduced During Spreadsheet Usage

As indicated at Block A in FIG. 17C2, the Calculation Engine identifies (i.e. determines)

Spreadsheet Purpose factor for Nₐ, F_{c} from the table [F_{na(Sp(x)}, F_{fc(Sp(x))}].

At Block B, the Calculation Engine multiplies Nₐ, F_{c} by their corresponding Spreadsheet Purpose factors.

At Block C, the Calculation Engine calculates error estimate Eᵤ from Nₐ, F_{c} according to the formula: Eᵤ=Eₐ*F_{c}.

At Block D, the Calculation Engine multiples Eᵤ by the inspection factor discount [I_{dis}], to arrive at the estimated likelihood of error introduced during spreadsheet usage Eᵤ.

Method of Augmenting RLE with Logic Changes Since the Last Spreadsheet Inspection

As indicated at Block A in FIG. 17D, the Calculation Engine identifies the number of observed changes to the spreadsheet logic [Cₙ] in the given spreadsheet under inspection.

At Block B, the Calculation Engine calculates the logic changes based on the number of accessible formula [Fₐ] and the number of observed changes [L_{c}] using the formula, for example, L_{c}=0.05*Cₙ*L_{c}.

At Block C, the Calculation Engine calculates the augment RLE by adding L_{c} to the last computed value of RLE for the spreadsheet.

### Calculation of Relative Likelihood of Concern (RLC) by the Risk Calculation and Notification Engine of the Present Invention

FIG. 18 is a high-level flow chart describing the primary steps carried out when the Risk Calculation and Notification Engine within the Central Reconnaissance Data Center, calculates the Relative Likelihood of Concern (RLC) for spreadsheet documents being monitored within the spreadsheet risk reconnaissance network of the present invention.

As indicated at Block A in FIG. 18, the Calculation Engine assigns a default criticality value (e.g. 1.0) to the criticality factor.

At Block B, the Calculation Engine determines whether or not a criticality value (e.g. critical key, important, or low impact) has been assigned to the spreadsheet by the Manager user. If a criticality value has been assigned, the Calculation Engine determines the criticality factor based on the assigned criticality value (e.g. where “critical” is assigned a criticality factor of 5.0; where “key” is assigned a criticality factor of 2.5; where “important” is assigned a criticality factor of 1.5 and where “low impact” is assigned a criticality factor of 0.5).

If a criticality value has been assigned, then at Block D the Calculation Engine calculates the Relative Likelihood of Concern (RLC) based on the previously calculated Relative Likelihood of Error (RLE) and the determined Criticality Factor, using a formula, such as, RLC=RLE*Criticality Factor.

### Detailed Specification of Spreadsheet Classification Processes Carried Out by Risk Officers Using the Spreadsheet Risk Reconnaissance Network of the Present Invention

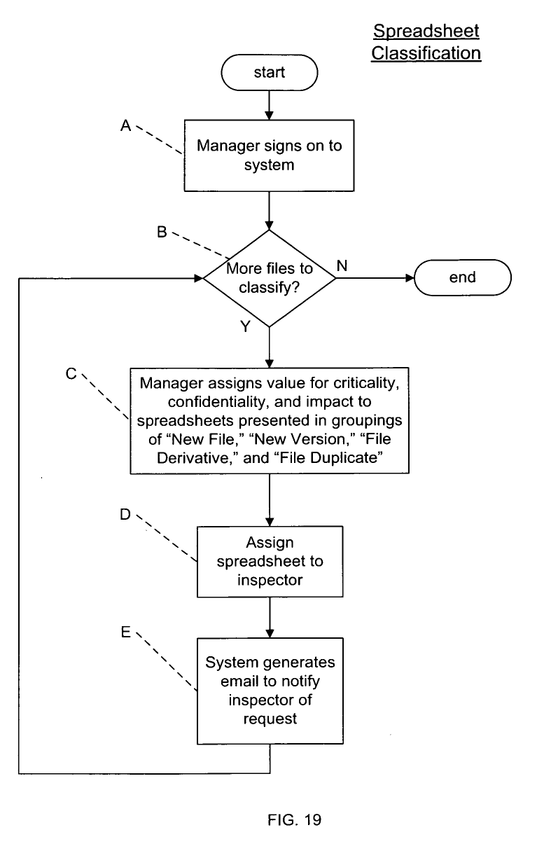

FIG. 19 is a high-level flow chart describing the primary steps carried out when a risk officer uses Spreadsheet Classification services supported on the spreadsheet risk reconnaissance network of the present invention.

As indicated at Block A, Spreadsheet Manager who is assigned to a group of spreadsheet directories in an Organization, logs-on to the system/network.

As indicated at Block B, the Spreadsheet Manager determines whether or not there are more spreadsheet files to classify. If there are no more files to classify, the manager ends the process.

If there are more spreadsheet files to classify, then at Block C the Manager assign value for criticality, confidentiality and impact to spreadsheets, presented to groupings of “New File,” “New Version,” “File Derivative” and “File Duplicate.”

At Block D, the Manager assigns the spreadsheet to an inspector.

At Block E, the system generates email to notify inspector of the request.

### Detailed Specification of Spreadsheet Inspection Processes Carried Out by Spreadsheet Inspectors Using the Spreadsheet Risk Reconnaissance Network of the Present Invention

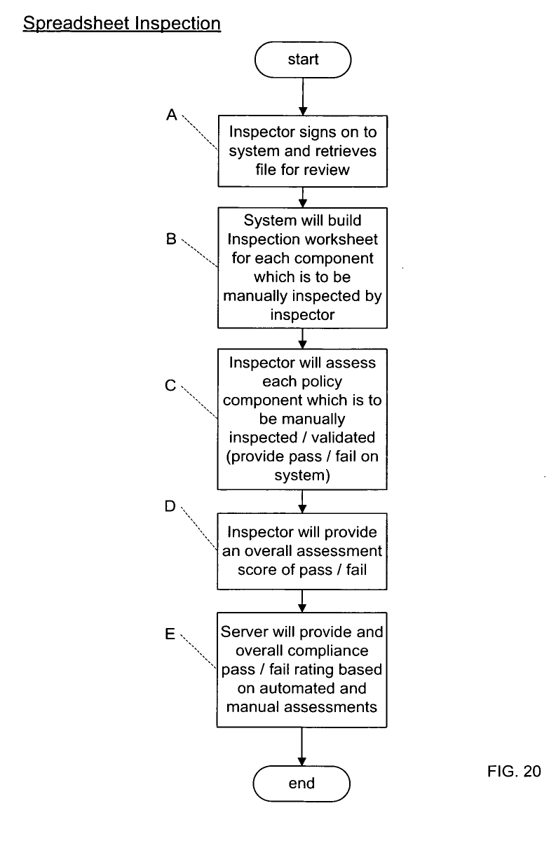

FIG. 20 is a high-level flow chart describing the primary steps carried out when a spreadsheet inspector uses Spreadsheet Inspection services supported on the spreadsheet risk reconnaissance network of the present invention.

At Block A, the spreadsheet inspector logs-on to the system/network, and selects the inspection from the list of inspections to be performed.

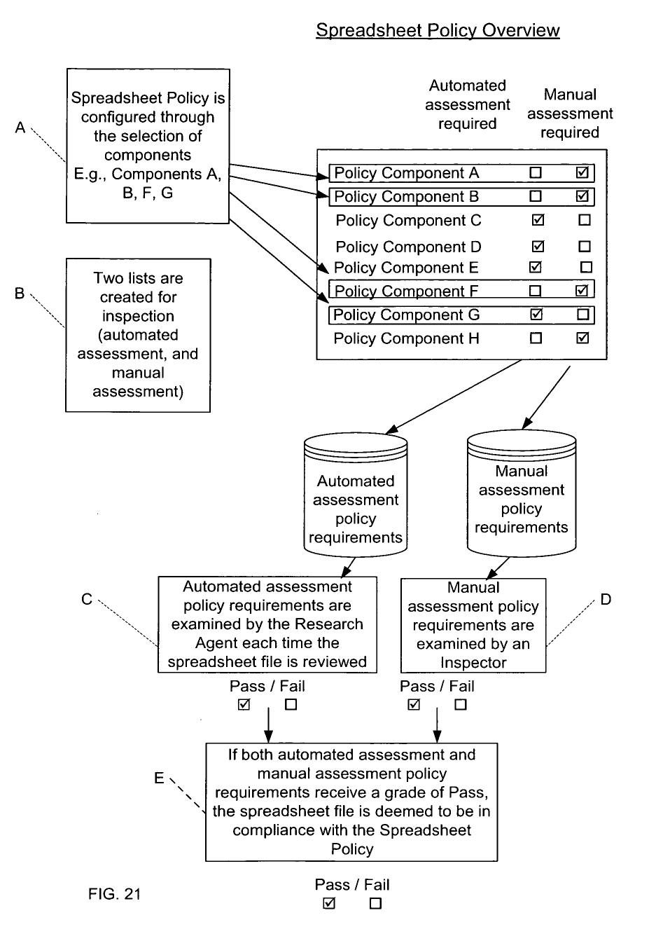

As indicated at Block B, in response to the selection at Block A, the system/network automatically builds an inspection worksheet for each component that is to be manually inspected by the inspector. The inspection worksheet will consist of all policy compliance components (see FIG. 21 for additional detail) which require human judgment to assess the degree to which an item passes compliance, as well as general notes to allow for inspection items which are not related to the specific compliance items.

At Block C, upon receiving the system generated inspection worksheet, the inspector will open the spreadsheet to be inspected, via a provided hyperlink, and apply their professional judgment in assessing whether or not the spreadsheet successfully passes each set of criteria established in spreadsheet policy. For each policy component being assessed, the inspector will evaluate the spreadsheet and provide a “pass” grade if it meets the criteria established in the policy, and a “fail” grade if it does not meet the established criteria. Comments are also provided allowing for additional information to be collected as to why the policy component passes or fails. For non-compliance related inspections, the inspector will provide the same pass/fail assessment to the areas being requested for inspection that are outside of compliance.

As indicated at Block D, the inspector will provide an overall assessment score of pass or fail. Upon completion of inspecting each of the manual inspection components, the inspector will assign a “pass” or “fail” grade to the manual inspection of the spreadsheet as whole. By default, if each item being inspected does not receive a passing grade, the grade for “manual inspection” will be “fail”.

As indicated at Block E, the application server at the data center will provide an overall compliance pass/fail rating based on automated and manual assessments.

Determination of whether or not a spreadsheet file is in compliance with the spreadsheet policy is a performed in multiple areas, at different points in time. As described in FIG. 21, there are several areas to be discussed.

Organizations looking to mitigate risk carried within their spreadsheets either have or will create an organizational Spreadsheet Policy, to which individuals within the organization are made to adhere. The network of the present invention facilitates the implementation of this policy through a number of pre-Configured policy components, any number of which can be identified as being part of the organization's spreadsheet policy. Each policy component will be tested in either an automated or manual manner. For example, a policy component such as “all spreadsheets must be password protected” can be tested in an automated fashion; while a component such as “all critical calculations must be well documented in the application guide” sill be tested in a manual manner. The Spreadsheet Policy process works as follows.

Within the risk reconnaissance network of the present invention, a number of possible spreadsheet policy components are available for selection. For each policy component, it will be noted whether it can be assessed in an automated or a manual fashion.

The automated assessments will be performed solely by looking at the technical environment and making an assessment of compliance with the policy component. For example, a policy component may be that the spreadsheet document can only be accessed by those people with a need and a right to access the spreadsheet document. The automated assessment would then perform a check of who is authorized to access the document and compare this with who from a technical perspective does have the ability/required permissions to access the spreadsheet file.

Manual assessments will be performed by Inspector-type users who will use their professional judgment to assess whether the policy component has been met. For example, a policy component may state that all spreadsheets should have supporting business requirements.

As indicated at Block A in FIG. 21, at the point of Configuration, the Administrator-User Configures Spreadsheet Policy through the selection of policy components which will apply to the Organization. This will provide the organization with a customized policy specific to their organization. In the example depicted, the Configuration dictates that policy components A, B, F, and G have been selected. As noted, some of these are configured to be manually tested, while others can be tested through automation processes.

As indicated at Block B, the system takes the selected components which are identified as being part of the organizations spreadsheet policy, and identifies those items which can be tested manually, and those which can be tested via automation. In other words, the system behaves as if it creates two lists of components for assessment: the first list contains policy components pertaining to the Organization's spreadsheet policy which will be assessed in an automated manner; and the second list contains policy components pertaining to the Organization's spreadsheet policy and which will be assessed in a manual manner.

As indicated at Block C in FIG. 21, the Research Agent will automatically examine each spreadsheet file which has had its business logic modified or changed. In doing so, Research Agent automatically (i) assesses each spreadsheet component identified for testing in an automated manner, e.g. “all spreadsheets must be password protected,” and compares it with the spreadsheet file under examination. If all spreadsheet policy components examined by the Research Agent are in compliance, then the spreadsheet file is assigned a passing status during the automated compliance test. If any of the policy components assessed are found to be non-compliant, the spreadsheet file is assigned a fail status during the automated compliance test.

Each of these policy component tests will be pre-programmed for execution when required. In the example above, if the automated test to be performed is to determine that only people who have a need and a right to the spreadsheet file have access, the Risk Reconnaissance platform would query the network operating system to determine who is authorized to access this spreadsheet file, and compare these results with a list of people who have been authorized by management. If no one has technical access that has not been authorized by management, then the policy component will be deemed to be in compliance for this policy component. If this is not the case, then the spreadsheet file will be deemed to be non-compliant for this policy component. The result of this review is to assign a “pass” or “fail” grade to each applicable component of the tested spreadsheet policy, each time any change is made to the logic of the spreadsheet.

As indicated at Block D in FIG. 21, the inspector is alerted when a spreadsheet has changed and an inspection is required. When this occurs, the inspector performs the inspection on the spreadsheet, and assesses a “pass” or “fail” grade collectively to the manually-inspected policy components. If all spreadsheet policy components examined by the Inspector are in compliance, then the spreadsheet file manual compliance test is assigned a passing status. If any of the policy components are found to be non-compliant, then the manual compliance test is assigned a fail status.

As indicated at Block E, once a manual and automated review of all policy components has taken place, the spreadsheet can receive an overall assessment of “pass” or “fail” in regards to compliance with the organizations spreadsheet policy. If all policy components have been found to be in compliance (receive a “pass” grade), then the spreadsheet is deemed to be in compliance with the spreadsheet policy. If either of the manual or automated compliance statuses are found to be non-compliant, then the spreadsheet file is determined to be out of compliance with corporate policy.

Modifications that Come to Mind

In the illustrative embodiments described above, the spreadsheet risk reconnaissance network of the present invention has been described in great technical detail. However, in alternative embodiments, the network can be modified in numerous ways without departing from the scope and spirit of the present invention.

For example, as an alternative means to uniquely identify spreadsheets is to generate a unique key (similar to a Global Unique Identifier in traditional Windows programming) and store this both as the USI on the spreadsheet header and in the database. This would allow for the database to store the spreadsheet file USI as well as other identifying information on the database. All uses of this USI would then perform a retrieval of the stored information from the database as opposed to the file header.

Another alternative means for executing the file logic comparison would be to store the data locally on the file server in temporary cache. This would be the primary access location for information. The Windows infrastructure would then dynamically updated the database in the background.

Another alternative embodiment of the present invention is to provide such a spreadsheet risk reconnaissance network, wherein the research agent no only collects spreadsheet metadata, but also analyzes the metadata associated with each spreadsheet document to automatically (i) identify Spreadsheet Purpose (i.e. Type) from the collected metadata, and (ii) calculate the Relative Likelihood of Error (RLE) and the Relative Likelihood of Concern (RLC) associated with each and every particular spreadsheet document file under management by the system. In such an alternative embodiment, the Calculation Engine can be located on or in each research agent, for performing automated Spreadsheet Purpose Identification operations, as well as Relative Likelihood of Error (RLE) Calculations, indicated in FIG. 11.

In accordance with the principles of the present invention, it is also understood that current definitions of spreadsheet files (i.e. documents) will eventually evolve into definitions reflecting different forms of this document type, while retaining the essential characteristics thereof, namely a file structure which stores data, as well as programmed logic which acts upon the stored data. Thus, the principles of the present invention are also applicable to on-line types of spreadsheets (e.g. Google Docs) as well as spreadsheets services being embedded in other interactive file types.

Several modifications to the illustrative embodiments have been described above. It is understood, however, that various other modifications to the illustrative embodiment of the present invention will readily occur to persons with ordinary skill in the art. All such modifications and variations are deemed to be within the scope and spirit of the present invention as defined by the accompanying Claims to Invention.

1. A method of inspecting spreadsheet files managed within a spreadsheet risk reconnaissance network, said method comprising the steps of:
(a) a spreadsheet inspector logging-on to said network, and selecting a spreadsheet inspection from the list of spreadsheet inspections to be performed;
(b) in response to the selection during step (a), said network automatically generating an inspection worksheet for each policy component which is to be manually inspected by the inspector;
wherein said inspection worksheet includes all policy compliance components which require human judgment to assess the degree to which an item passes compliance, as well as general notes to allow for inspection items which are not related to the specific compliance items;
(c) upon receiving said network-generated inspection worksheet, said spreadsheet inspector opening the spreadsheet file to be inspected, via a provided hyperlink, and applying human judgment in assessing whether or not the spreadsheet file successfully passes each set of criteria established in said spreadsheet policy;
(d) for each policy component being assessed, said spreadsheet inspector evaluating the spreadsheet file and providing a passing grade if the spreadsheet file meets the criteria established in the policy component, and a failing grade if the spreadsheet file does not meet the established criteria in the policy component; and
(e) providing an overall assessment score of passing or failing to each spreadsheet file under assessment, based on automated and/or manual assessments.

2. The method of claim 1, wherein said network includes one or more communication servers for serving GUI screens to Web browsers of users.

3. The method of claim 2, wherein GUI screens enable spreadsheet inspector users (e.g. Inspectors) to perform one or more of the following functions including: inspecting a spreadsheet file,
(i) assessing compliance with spreadsheet policy,
(ii) determining accuracy of business logic,
(iii) making notes, and
(iv) providing an overall assessment which will be made available to the business manager user for the spreadsheet file, as well as the risk officer.

4. The method of claim 1, wherein said GUI screen supports services that enable Inspector Users to do one or more of the following:
(i) reviewing the specifics on each spreadsheet file assigned to the Inspector;
(ii) initiating an inspection of a file;
(iii) reassigning an inspection to another Inspector to allow for the Inspector user to have the inspection performed by a user who is better qualified, or have greater availability to perform the inspection; and
(iv) viewing the details of the file for the inspector to gain an understanding of the metadata within the file before performing the inspection.

5. The method of claim 1, wherein said GUI screen presents the Inspector with information related to the spreadsheet file under inspection, including its location, author, creator, and date and time the spreadsheet file was analyzed.

6. The method of claim 1, wherein said GUI screen further presents the Inspector with each of the areas within the spreadsheet policy which can only be assessed by human judgment.

7. The method of claim 1, wherein for each spreadsheet policy component which has been configured in said spreadsheet policy configuration, the Inspector has the opportunity to provide assessment results as either having passed or not, as well as comments which support their assessment.

8. The method of claim 1, wherein during step (c) is a performed in multiple areas, at different points in time.

9. The method of claim 1, wherein during step (c), when manual assessments are performed by Inspector-type users, the use their human judgment to assess whether the policy component has been met.

10. The method of claim 1, wherein during step (c), a number of possible spreadsheet policy components are available for selection, and wherein each policy component is indicated as being assessable in either an automated or a manual fashion.

11. The method of claim 1, wherein during step (c), the automated assessments are performed solely by looking at the technical environment and making an assessment of compliance with the policy component.

12. The method of claim 1, wherein during step (c), when said policy component is that the spreadsheet file can only be accessed by those people with a need and a right to access the spreadsheet file, said automated assessment performs a check of who is authorized to access the file and compares this with who, from a technical perspective, has the ability to access the spreadsheet document.

13. The method of claim 1, wherein said GUI screens support services that enable users to do one or more of the following:
(i) determining the risk profile within the organization;
(ii) determining the spreadsheet files which have been inspected and the date of last inspection;
(iii) determining time series of the organizational risk by department.
